(19) United States
(12) Patent Application Publication
(10) Pub. No.: US 2026/0093446 A1
(43) Pub. Date: Apr. 2, 2026

(54) INTERACTIONS WITH USER INTERFACES

(71) Applicant: Apple Inc., Cupertino, CA (US)

(72) Inventors: Jesse CHAND, Lodi, NJ (US); Jonathan R. DASCOLA, San Francisco, CA (US); Marinos BERNITSAS, Mountain View, CA (US); Adam L. AMADIO, San Francisco, CA (US); Danvin RUANGCHAN, San Jose, CA (US)

(21) Appl. No.: 19/277,278

(22) Filed: Jul. 22, 2025

Related U.S. Application Data
(60) Provisional application No. 63/700,557, filed on Sep. 27, 2024.
(60) Provisional application No. 63/713,542, filed on Oct. 29, 2024.

(51) Int. Cl. G06F 3/16; G06F 3/01; G06F 3/04845; G06F 3/0485

(52) U.S. Cl. CPC G06F 3/167; G06F 3/013; G06F 3/04845; G06F 3/0485

(57) ABSTRACT

Techniques for interacting with user interfaces using user inputs are described.

### CROSS-REFERENCE TO RELATED APPLICATIONS

This application claims priority to U.S. patent application Ser. No. 63/713,542, entitled “INTERACTIONS WITH USER INTERFACES,” filed on Oct. 29, 2024, and claims priority to U.S. patent application Ser. No. 63/700,557, entitled “INTERACTIONS WITH USER INTERFACES,” filed on Sep. 27, 2024, which are each hereby incorporated by reference in their entirety.

### TECHNICAL FIELD

The present disclosure relates generally to computer systems that are optionally in communication with one or more display generation components, one or more input devices, and one or more audio output devices, and that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touchscreen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with user interfaces, such as in environments that include at least some virtual elements (e.g., applications, augmented reality environments, mixed reality environments, and virtual reality environments), are cumbersome, inefficient, and limited. For example, systems that display text that is difficult to read, systems that do not sufficiently manage audio and/or video output, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted display (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with user interfaces, such as in a three-dimensional environment. Such methods and interfaces may complement or replace conventional methods for interacting with user interfaces, such as in a three-dimensional environment. Such methods and interfaces reduce the number, extent, and/or the nature of the inputs from a user and produce a more efficient human-machine interface. Such methods and interfaces also make it easier for the user to view text and/or other information and to consume media. For battery-operated computing devices, such methods and interfaces conserve power and increase the time between battery charges.

In accordance with some embodiments, a method is described. The method comprises: at a computer system that is in communication with one or more display generation components and one or more input devices: detecting, via the one or more input devices, a request to display text associated with content; and in response to detecting the request to display text associated with content: displaying, via the one or more display generation components, text overlaid on the content; and displaying, via the one or more display generation components, a portion of the content near the text with a blur effect that gradually reduces in intensity as distance from the text increases, wherein a shape of the blur effect is based on a shape of the text.

In accordance with some embodiments, non-transitory computer-readable storage medium is described. The a non-transitory computer-readable storage medium stores one or more programs configured to be executed by one or more processors of a computer system that is in communication with one or more display generation components and one or more input devices, the one or more programs including instructions for: detecting, via the one or more input devices, a request to display text associated with content; and in response to detecting the request to display text associated with content: displaying, via the one or more display generation components, text overlaid on the content; and displaying, via the one or more display generation components, a portion of the content near the text with a blur effect that gradually reduces in intensity as distance from the text increases, wherein a shape of the blur effect is based on a shape of the text.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: detecting, via the one or more input devices, a request to display text associated with content; and in response to detecting the request to display text associated with content: displaying, via the one or more display generation components, text overlaid on the content; and displaying, via the one or more display generation components, a portion of the content near the text with a blur effect that gradually reduces in intensity as distance from the text increases, wherein a shape of the blur effect is based on a shape of the text.

In accordance with some embodiments, computer system is described. The computer system is configured to communicate with one or more display generation components and one or more input devices. The computer system comprises: one or more processors; and memory storing one or more programs configured to be executed by the one or more processors, the one or more programs including instructions for: detecting, via the one or more input devices, a request to display text associated with content; and in response to detecting the request to display text associated with content: displaying, via the one or more display generation components, text overlaid on the content; and displaying, via the one or more display generation components, a portion of the content near the text with a blur effect that gradually reduces in intensity as distance from the text increases, wherein a shape of the blur effect is based on a shape of the text.

In accordance with some embodiments, a computer system is described. The computer system is configured to communicate with one or more display generation components and one or more input devices. The computer system comprises: means for detecting, via the one or more input devices, a request to display text associated with content; and means, responsive to detecting the request to display text associated with content, for: displaying, via the one or more display generation components, text overlaid on the content; and displaying, via the one or more display generation components, a portion of the content near the text with a blur effect that gradually reduces in intensity as distance from the text increases, wherein a shape of the blur effect is based on a shape of the text.

In accordance with some embodiments, a computer program product is described. The computer program product comprises one or more programs configured to be executed by one or more processors of a computer system that is in communication with one or more display generation components and one or more input devices, the one or more programs including instructions for: detecting, via the one or more input devices, a request to display text associated with content; and in response to detecting the request to display text associated with content: displaying, via the one or more display generation components, text overlaid on the content; and displaying, via the one or more display generation components, a portion of the content near the text with a blur effect that gradually reduces in intensity as distance from the text increases, wherein a shape of the blur effect is based on a shape of the text.

In accordance with some embodiments, a method is described. The method comprises: at a computer system that is in communication with one or more display generation components, one or more input devices, and one or more audio output devices: concurrently displaying, via the one or more display generation components, a first user interface object in a user interface and outputting, via the one or more audio output devices, first audio that corresponds to the first user interface object; while concurrently displaying the first user interface object in the user interface and outputting the first audio, detecting, via the one or more input devices, a request to move the first user interface object; and in response to detecting the request to move the first user interface object: moving the first user interface object in accordance with the request; and in accordance with a determination that a first set of one or more criteria is met, reducing a prominence of the first audio while continuing to display the first user interface object in the user interface.

In accordance with some embodiments, a non-transitory computer-readable storage medium is described. The non-transitory computer-readable storage medium stores one or more programs configured to be executed by one or more processors of a computer system that is in communication with one or more display generation components, one or more input devices, and one or more audio output devices, the one or more programs including instructions for: concurrently displaying, via the one or more display generation components, a first user interface object in a user interface and outputting, via the one or more audio output devices, first audio that corresponds to the first user interface object; while concurrently displaying the first user interface object in the user interface and outputting the first audio, detecting, via the one or more input devices, a request to move the first user interface object; and in response to detecting the request to move the first user interface object: moving the first user interface object in accordance with the request; and in accordance with a determination that a first set of one or more criteria is met, reducing a prominence of the first audio while continuing to display the first user interface object in the user interface.

In accordance with some embodiments, a transitory computer-readable storage medium is described. The transitory computer-readable storage medium stores one or more programs configured to be executed by one or more processors of a computer system that is in communication with one or more display generation components, one or more input devices, and one or more audio output devices, the one or more programs including instructions for: concurrently displaying, via the one or more display generation components, a first user interface object in a user interface and outputting, via the one or more audio output devices, first audio that corresponds to the first user interface object; while concurrently displaying the first user interface object in the user interface and outputting the first audio, detecting, via the one or more input devices, a request to move the first user interface object; and in response to detecting the request to move the first user interface object: moving the first user interface object in accordance with the request; and in accordance with a determination that a first set of one or more criteria is met, reducing a prominence of the first audio while continuing to display the first user interface object in the user interface.

In accordance with some embodiments, a computer system is described. The computer system is configured to communicate with one or more display generation components, one or more input devices, and one or more audio output devices. The computer system comprises: one or more processors; and memory storing one or more programs configured to be executed by the one or more processors, the one or more programs including instructions for: concurrently displaying, via the one or more display generation components, a first user interface object in a user interface and outputting, via the one or more audio output devices, first audio that corresponds to the first user interface object; while concurrently displaying the first user interface object in the user interface and outputting the first audio, detecting, via the one or more input devices, a request to move the first user interface object; and in response to detecting the request to move the first user interface object: moving the first user interface object in accordance with the request; and in accordance with a determination that a first set of one or more criteria is met, reducing a prominence of the first audio while continuing to display the first user interface object in the user interface.

In accordance with some embodiments, a computer system is described. The computer system is configured to communicate with one or more display generation components, one or more input devices, and one or more audio output devices. The computer system comprises: means for concurrently displaying, via the one or more display generation components, a first user interface object in a user interface and outputting, via the one or more audio output devices, first audio that corresponds to the first user interface object; means, while concurrently displaying the first user interface object in the user interface and outputting the first audio, for detecting, via the one or more input devices, a request to move the first user interface object; and means, responsive to detecting the request to move the first user interface object, for: moving the first user interface object in accordance with the request; and in accordance with a determination that a first set of one or more criteria is met, reducing a prominence of the first audio while continuing to display the first user interface object in the user interface.

In accordance with some embodiments, a computer program product is described. The computer program product comprises one or more programs configured to be executed by one or more processors of a computer system that is in communication with one or more display generation components, one or more input devices, and one or more audio output devices, the one or more programs including instructions for: concurrently displaying, via the one or more display generation components, a first user interface object in a user interface and outputting, via the one or more audio output devices, first audio that corresponds to the first user interface object; while concurrently displaying the first user interface object in the user interface and outputting the first audio, detecting, via the one or more input devices, a request to move the first user interface object; and in response to detecting the request to move the first user interface object: moving the first user interface object in accordance with the request; and in accordance with a determination that a first set of one or more criteria is met, reducing a prominence of the first audio while continuing to display the first user interface object in the user interface.

In accordance with some embodiments, a method is described. The method comprises: at a computer system that is in communication with one or more display generation components and one or more input devices: displaying, via the one or more display generation components, one or more user interface objects of a plurality of user interface objects; while displaying the one or more user interface objects, detecting, via the one or more input devices, a request to navigate the plurality of user interface objects; in response to detecting the request to navigate the plurality of user interface objects, navigating the plurality of user interface objects to display, via the one or more display generation components, a respective user interface object, wherein displaying the respective user interface object includes: in accordance with a determination that the respective user interface object corresponds to a plurality of different content items: automatically switching between display of content items in the plurality of different content items as part of the respective user interface object; and concurrently displaying, via the one or more display generation components: a representation of a respective content item of the plurality of different content items, and one or more options to select a different content item of the plurality of different content items to display; detecting, via the one or more input devices, selection of a respective option of the one or more options of the respective user interface object that corresponds to the plurality of different content items; and in response to detecting selection of the respective option of the one or more options, switching from displaying the representation of the respective content item of the plurality of different content items to displaying a representation of a different content item of the plurality of different content items.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, one or more user interface objects of a plurality of user interface objects; while displaying the one or more user interface objects, detecting, via the one or more input devices, a request to navigate the plurality of user interface objects; in response to detecting the request to navigate the plurality of user interface objects, navigating the plurality of user interface objects to display, via the one or more display generation components, a respective user interface object, wherein displaying the respective user interface object includes: in accordance with a determination that the respective user interface object corresponds to a plurality of different content items: automatically switching between display of content items in the plurality of different content items as part of the respective user interface object; and concurrently displaying, via the one or more display generation components: a representation of a respective content item of the plurality of different content items, and one or more options to select a different content item of the plurality of different content items to display; detecting, via the one or more input devices, selection of a respective option of the one or more options of the respective user interface object that corresponds to the plurality of different content items; and in response to detecting selection of the respective option of the one or more options, switching from displaying the representation of the respective content item of the plurality of different content items to displaying a representation of a different content item of the plurality of different content items.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, one or more user interface objects of a plurality of user interface objects; while displaying the one or more user interface objects, detecting, via the one or more input devices, a request to navigate the plurality of user interface objects; in response to detecting the request to navigate the plurality of user interface objects, navigating the plurality of user interface objects to display, via the one or more display generation components, a respective user interface object, wherein displaying the respective user interface object includes: in accordance with a determination that the respective user interface object corresponds to a plurality of different content items: automatically switching between display of content items in the plurality of different content items as part of the respective user interface object; and concurrently displaying, via the one or more display generation components: a representation of a respective content item of the plurality of different content items, and one or more options to select a different content item of the plurality of different content items to display; detecting, via the one or more input devices, selection of a respective option of the one or more options of the respective user interface object that corresponds to the plurality of different content items; and in response to detecting selection of the respective option of the one or more options, switching from displaying the representation of the respective content item of the plurality of different content items to displaying a representation of a different content item of the plurality of different content items.

In accordance with some embodiments, a computer system is described. The computer system is configured to communicate with one or more display generation components and one or more input devices. The computer system comprises: one or more processors; and memory storing one or more programs configured to be executed by the one or more processors, the one or more programs including instructions for: displaying, via the one or more display generation components, one or more user interface objects of a plurality of user interface objects; while displaying the one or more user interface objects, detecting, via the one or more input devices, a request to navigate the plurality of user interface objects; in response to detecting the request to navigate the plurality of user interface objects, navigating the plurality of user interface objects to display, via the one or more display generation components, a respective user interface object, wherein displaying the respective user interface object includes: in accordance with a determination that the respective user interface object corresponds to a plurality of different content items: automatically switching between display of content items in the plurality of different content items as part of the respective user interface object; and concurrently displaying, via the one or more display generation components: a representation of a respective content item of the plurality of different content items, and one or more options to select a different content item of the plurality of different content items to display; detecting, via the one or more input devices, selection of a respective option of the one or more options of the respective user interface object that corresponds to the plurality of different content items; and in response to detecting selection of the respective option of the one or more options, switching from displaying the representation of the respective content item of the plurality of different content items to displaying a representation of a different content item of the plurality of different content items.

In accordance with some embodiments, a computer system is described. The computer system is configured to communicate with one or more display generation components and one or more input devices. The computer system comprises: means for displaying, via the one or more display generation components, one or more user interface objects of a plurality of user interface objects; means, while displaying the one or more user interface objects, for detecting, via the one or more input devices, a request to navigate the plurality of user interface objects; means, responsive to detecting the request to navigate the plurality of user interface objects, for navigating the plurality of user interface objects to display, via the one or more display generation components, a respective user interface object, wherein displaying the respective user interface object includes: in accordance with a determination that the respective user interface object corresponds to a plurality of different content items: automatically switching between display of content items in the plurality of different content items as part of the respective user interface object; and concurrently displaying, via the one or more display generation components: a representation of a respective content item of the plurality of different content items, and one or more options to select a different content item of the plurality of different content items to display; means for detecting, via the one or more input devices, selection of a respective option of the one or more options of the respective user interface object that corresponds to the plurality of different content items; and means, responsive to detecting selection of the respective option of the one or more options, for switching from displaying the representation of the respective content item of the plurality of different content items to displaying a representation of a different content item of the plurality of different content items.

In some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, one or more user interface objects of a plurality of user interface objects; while displaying the one or more user interface objects, detecting, via the one or more input devices, a request to navigate the plurality of user interface objects; in response to detecting the request to navigate the plurality of user interface objects, navigating the plurality of user interface objects to display, via the one or more display generation components, a respective user interface object, wherein displaying the respective user interface object includes: in accordance with a determination that the respective user interface object corresponds to a plurality of different content items: automatically switching between display of content items in the plurality of different content items as part of the respective user interface object; and concurrently displaying, via the one or more display generation components: a representation of a respective content item of the plurality of different content items, and one or more options to select a different content item of the plurality of different content items to display; detecting, via the one or more input devices, selection of a respective option of the one or more options of the respective user interface object that corresponds to the plurality of different content items; and in response to detecting selection of the respective option of the one or more options, switching from displaying the representation of the respective content item of the plurality of different content items to displaying a representation of a different content item of the plurality of different content items.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7U illustrate example techniques for user interface interactions, in accordance with some embodiments.

FIG. 8 is a flow diagram of methods of applying a blur effect, in accordance with some embodiments.

FIG. 9 is a flow diagram of methods of managing audio output, in accordance with some embodiments.

FIGS. 10A-10V illustrate example techniques for automatically switching between display of representations of different content items, in accordance with some embodiments.

FIGS. 11A-11B are a flow diagram of methods of automatically switching between display of representations of different content items, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system detects a user input and, in response, displays text overlaid on content. The text and/or content is optionally part of a three-dimensional environment (e.g., a virtual or mixed reality environment). The computer system conditionally applies a blur effect to a portion of the content near the text, such that the blur effect gradually reduces in intensity as distance from the text increases, thereby improving the legibility of the text.

In some embodiments, a computer system concurrently displays a first user interface object and outputs first audio that corresponds to the first user interface object. In response to receiving a request, the computer system moves the first user interface object and conditionally (e.g., in accordance with a first set of one or more criteria being met) reduces a prominence of the first audio while continuing to display the first user interface object.

In some embodiments, a computer system receives a navigation request and, in response, navigates a plurality of user interface objects to display a respective user interface object. When the respective user interface object includes a plurality of different content items, the computer system automatically switches between display of the different content items and concurrently displays a representation of a respective content item of the plurality of different content items and one or more options to select a different content item of the plurality of different content items to display. In response to detecting selection of a respective option of the one or more options, the computer system switches from displaying the representation of the respective content item of the plurality of different content items to displaying a representation of a different content item of the plurality of different content items.

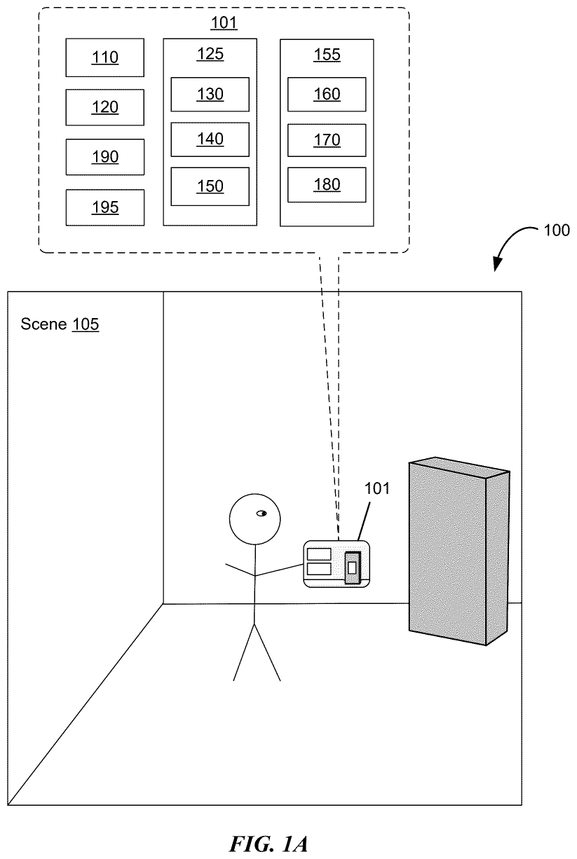

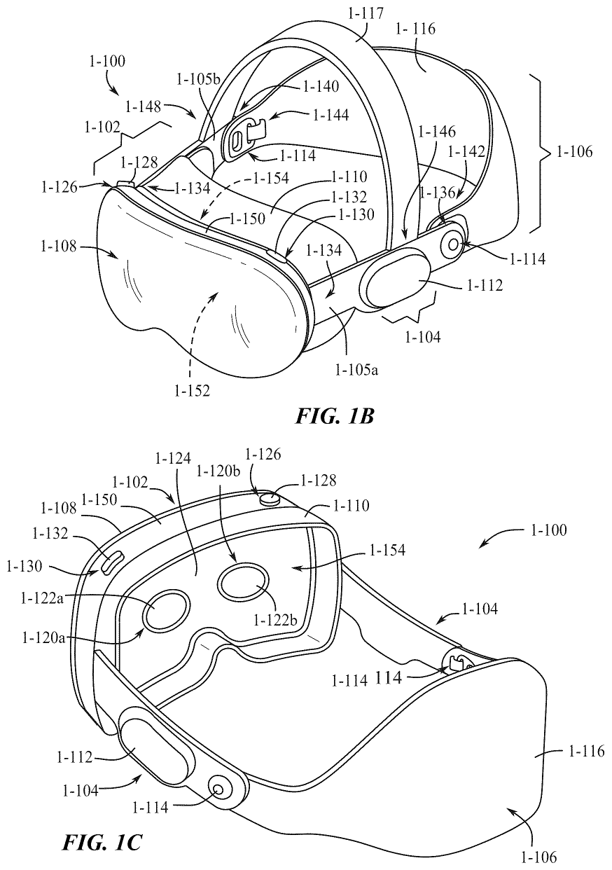

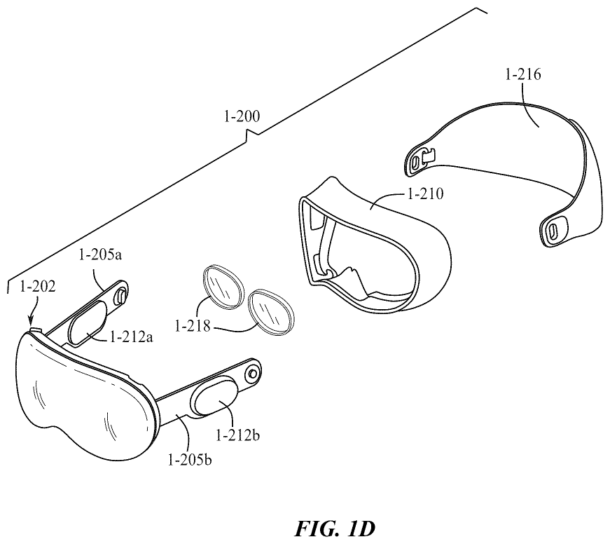

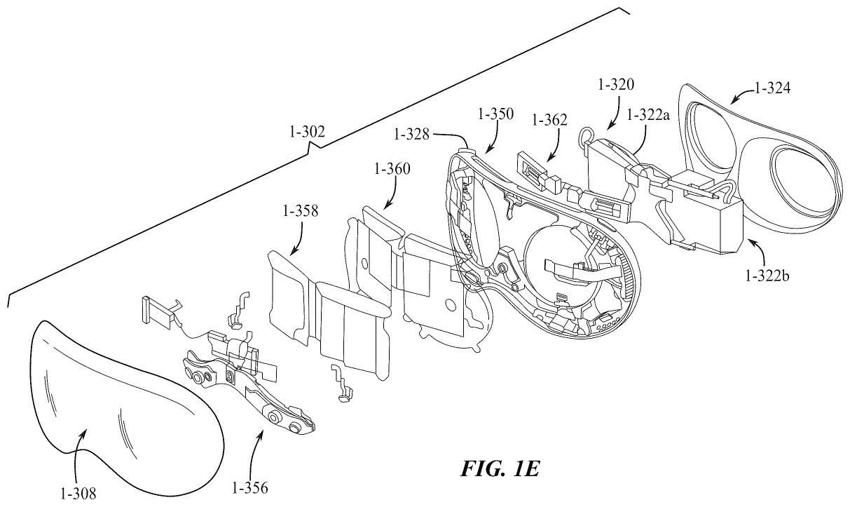

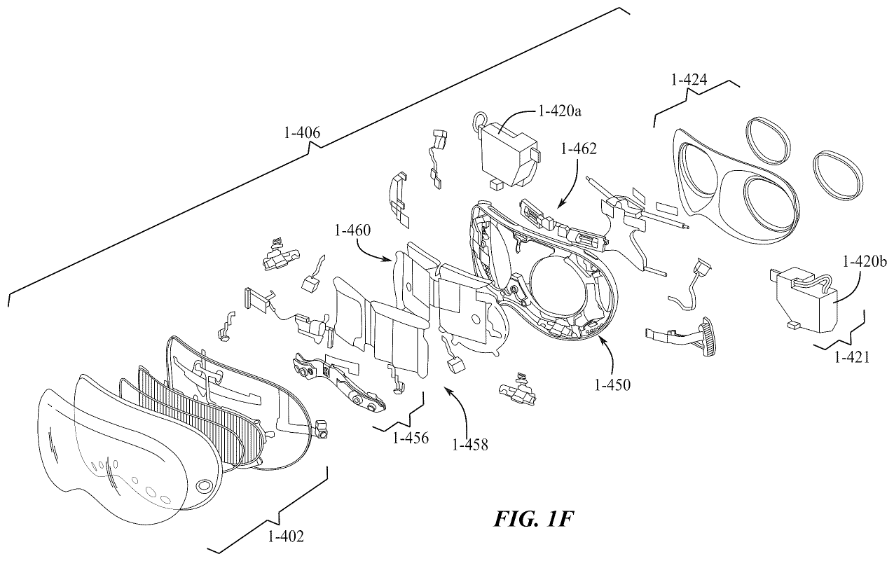

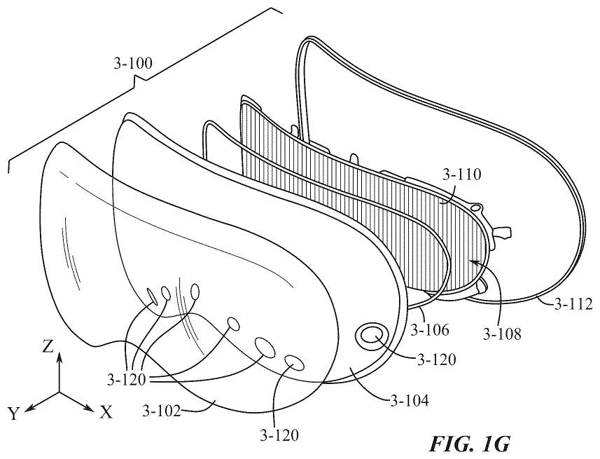

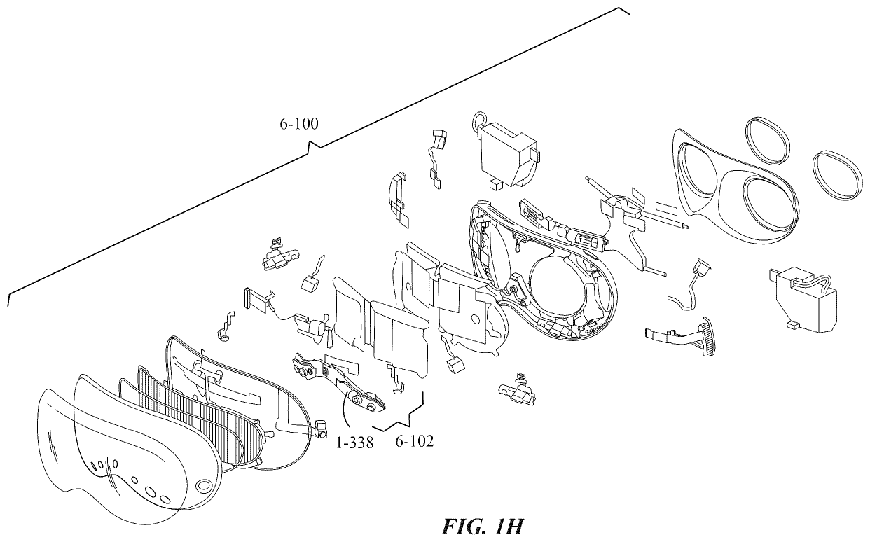

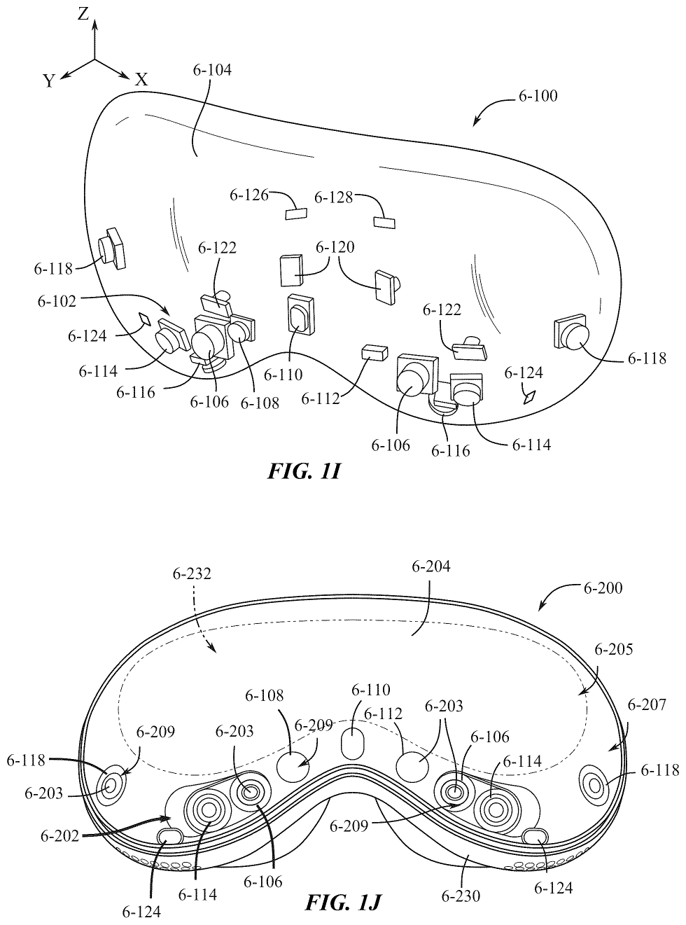

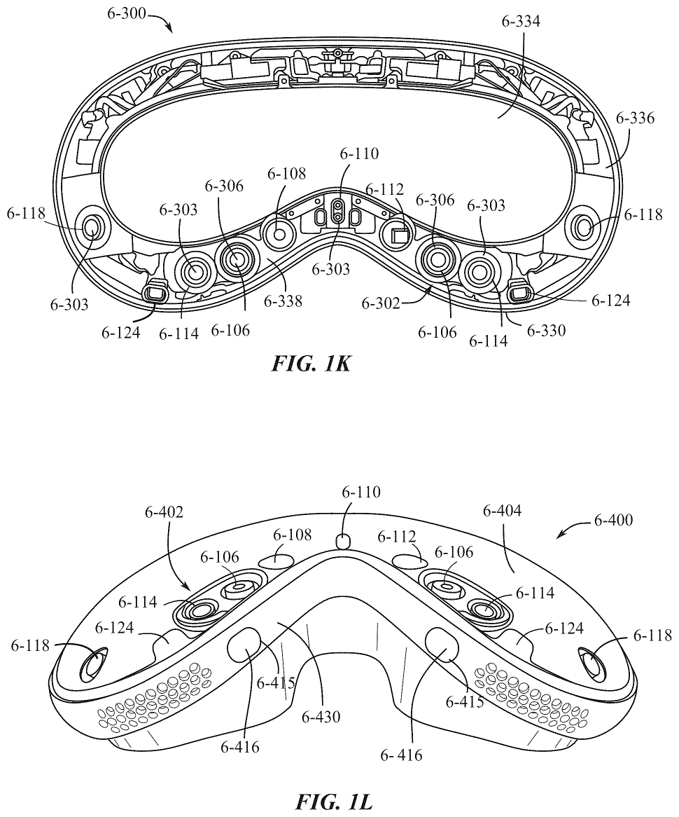

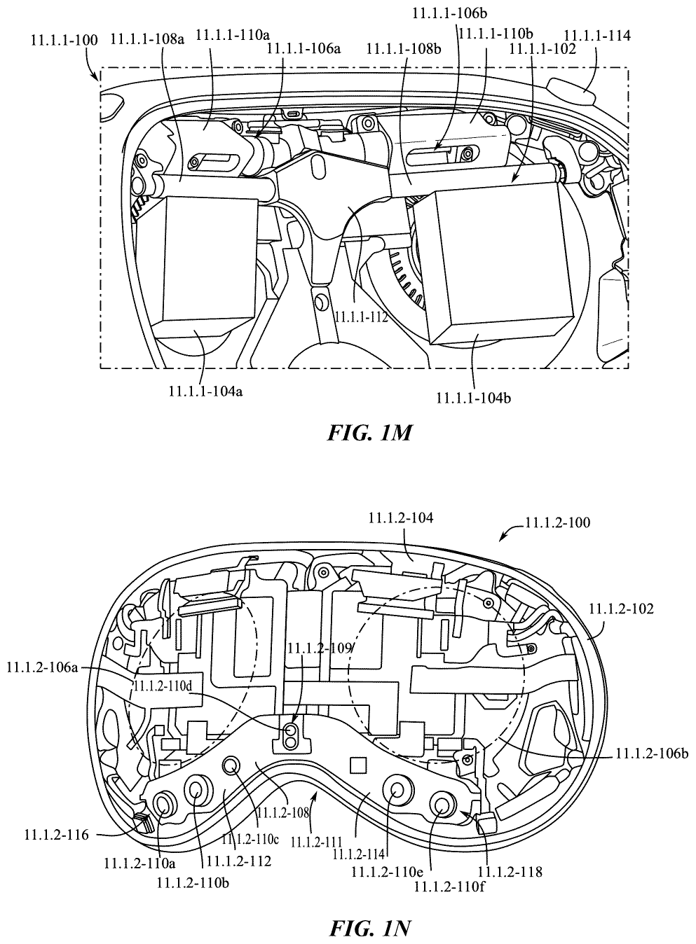

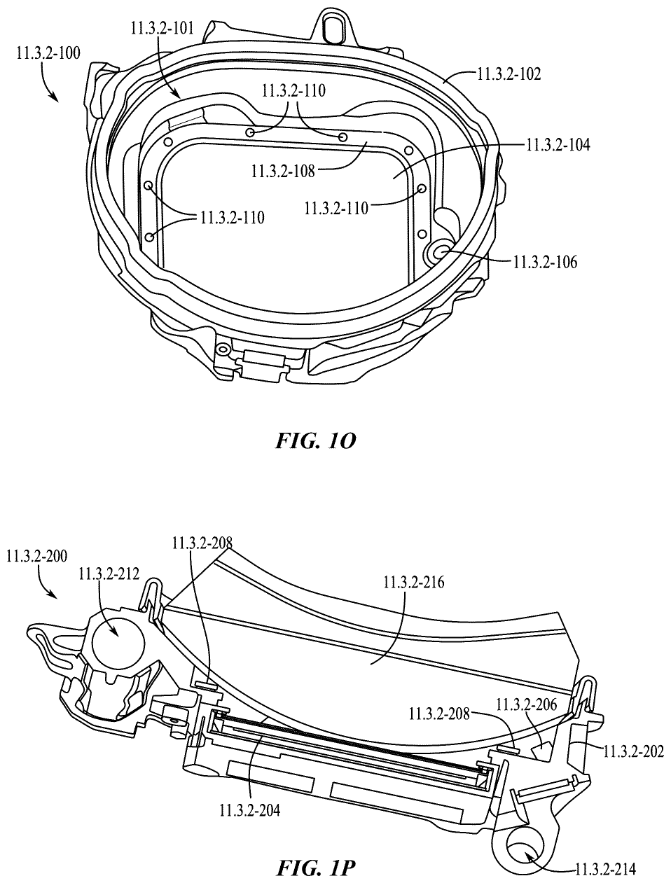

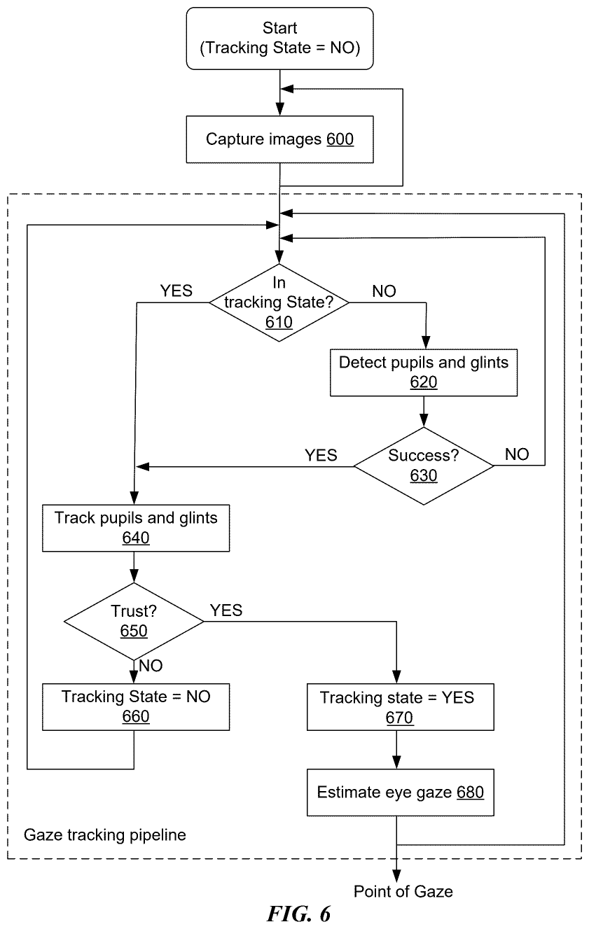

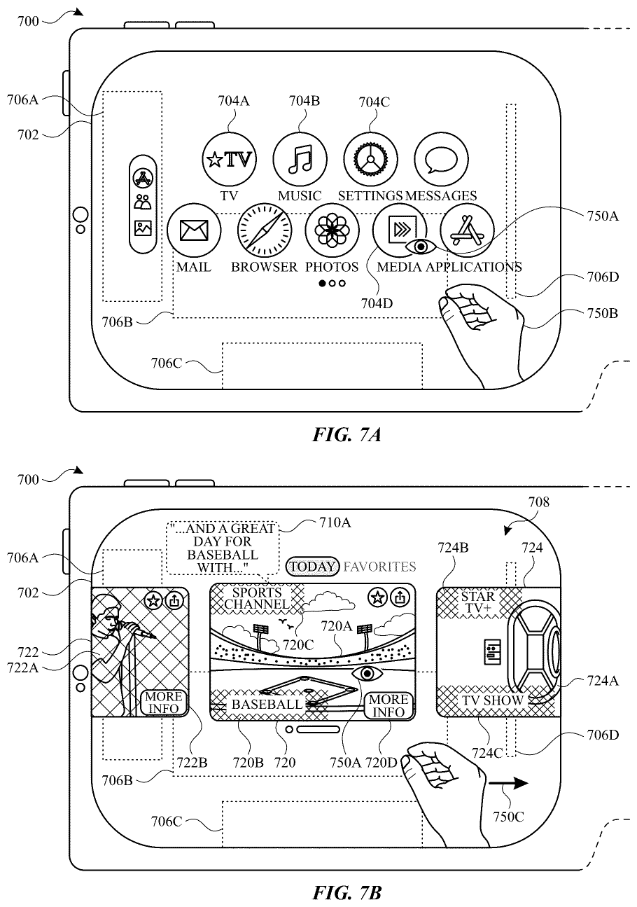

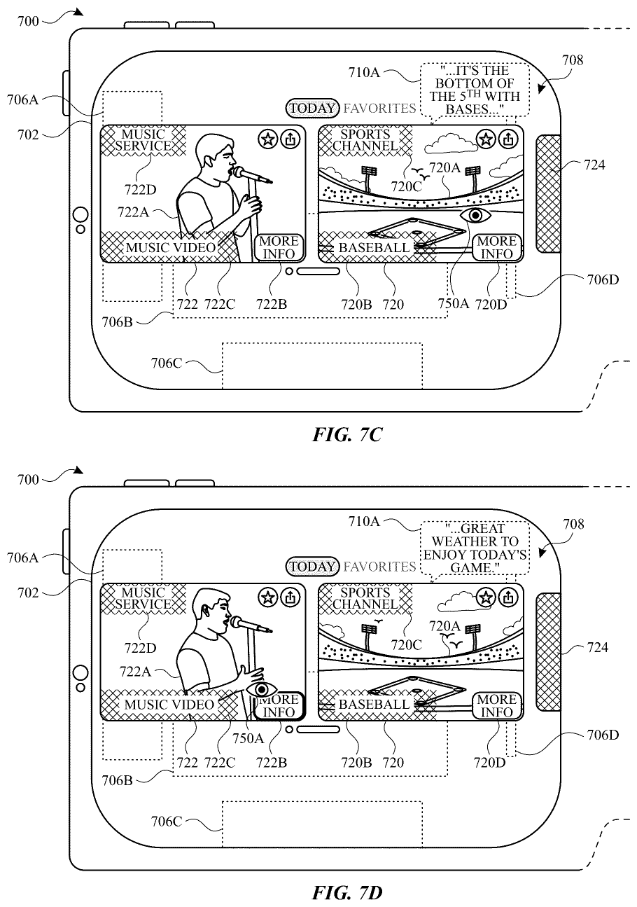

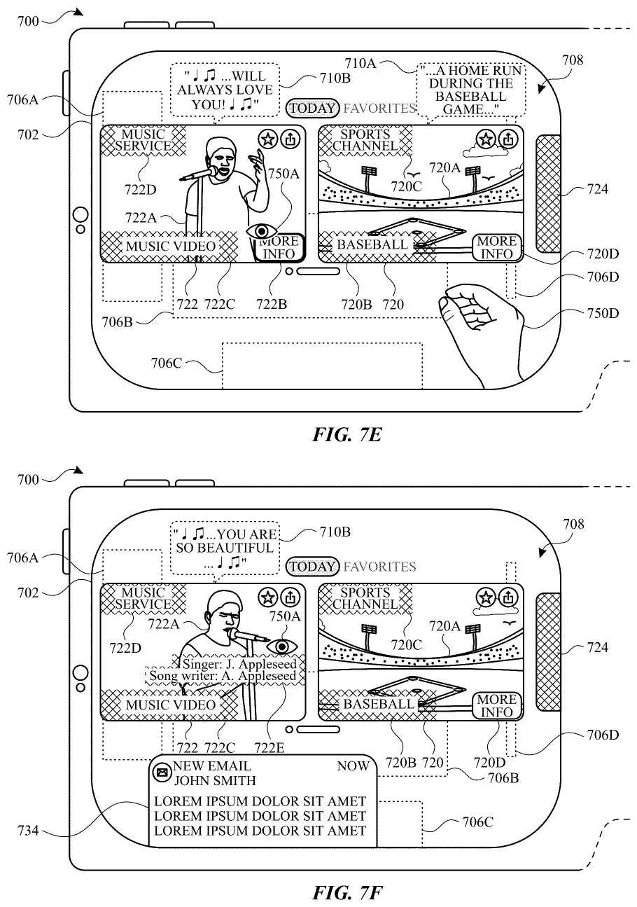

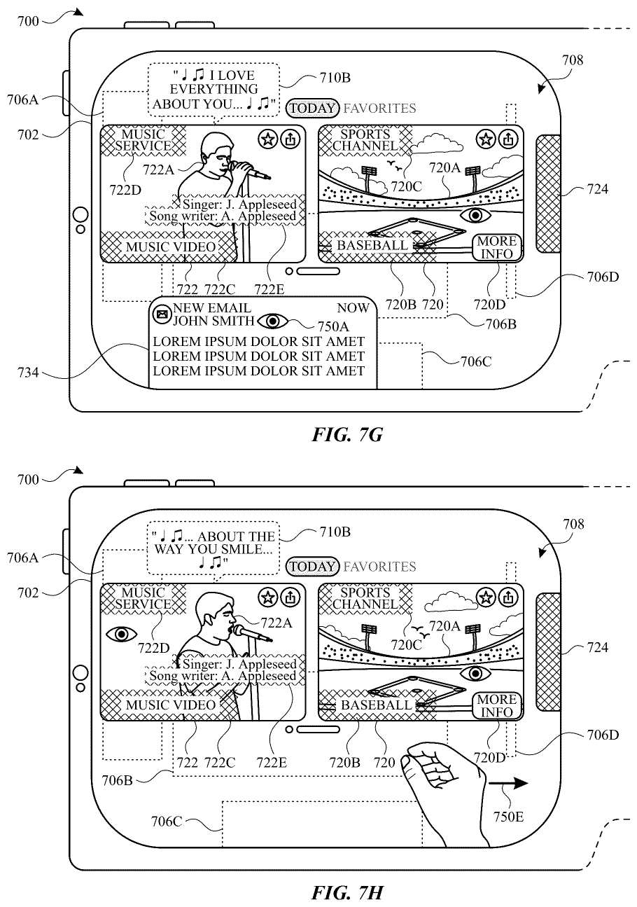

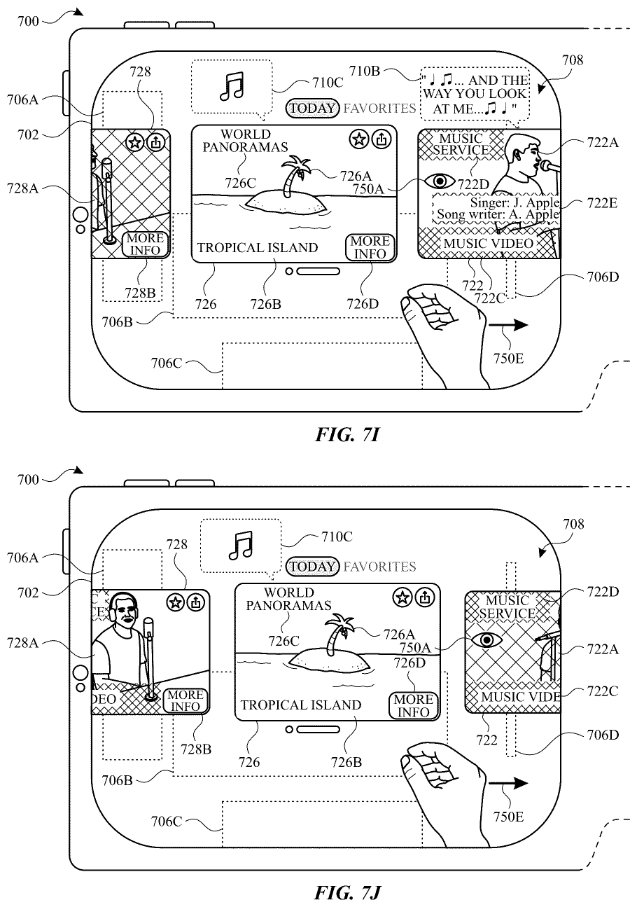

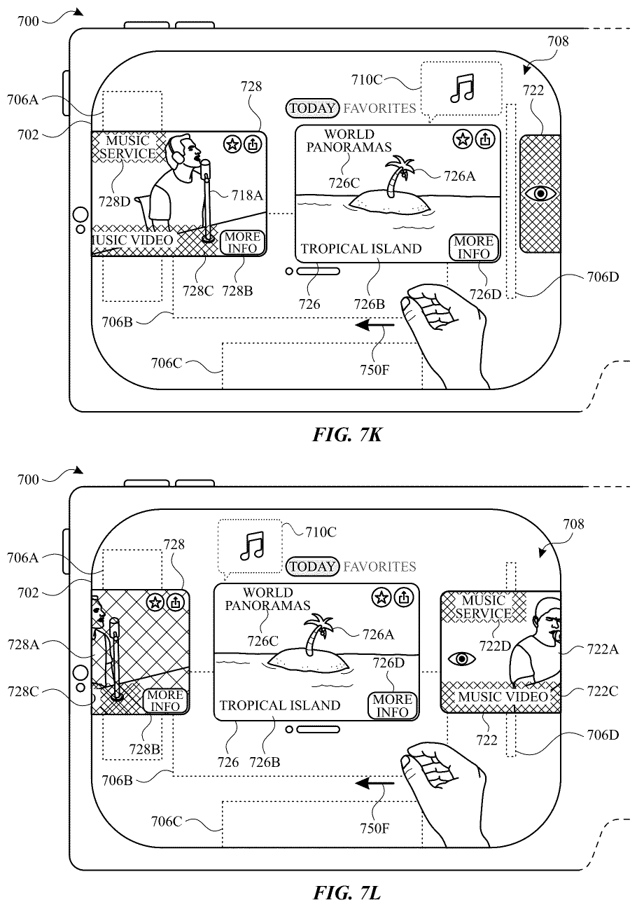

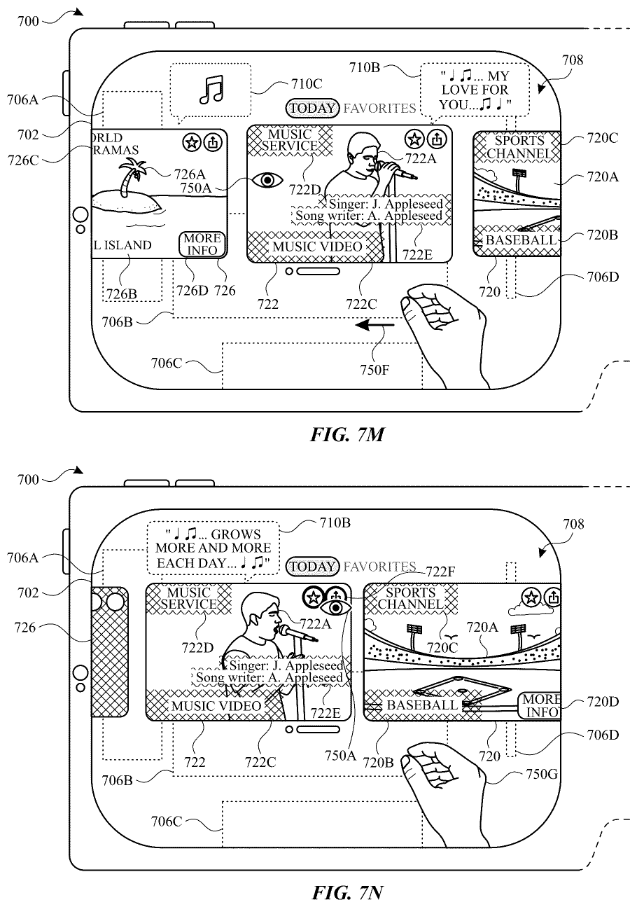

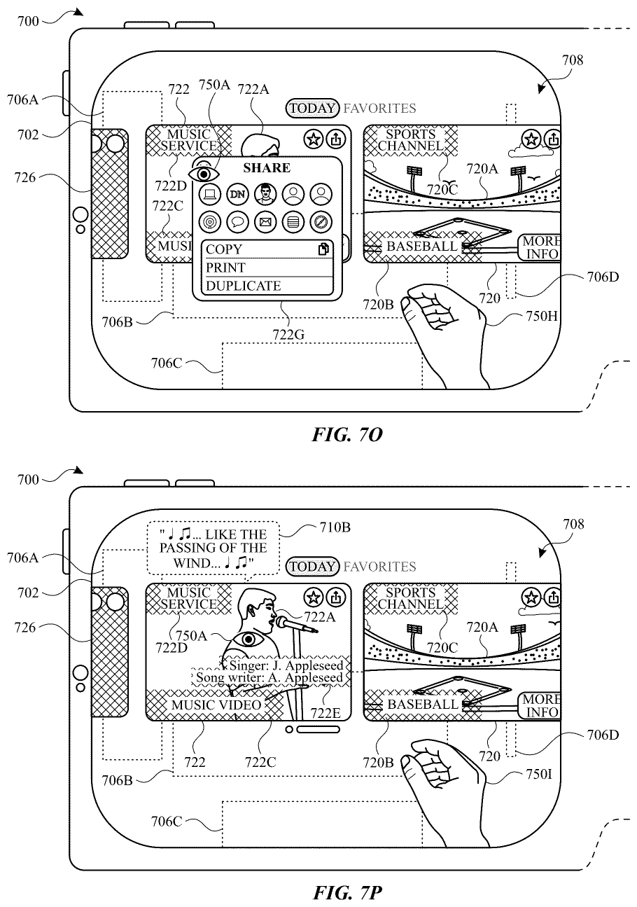

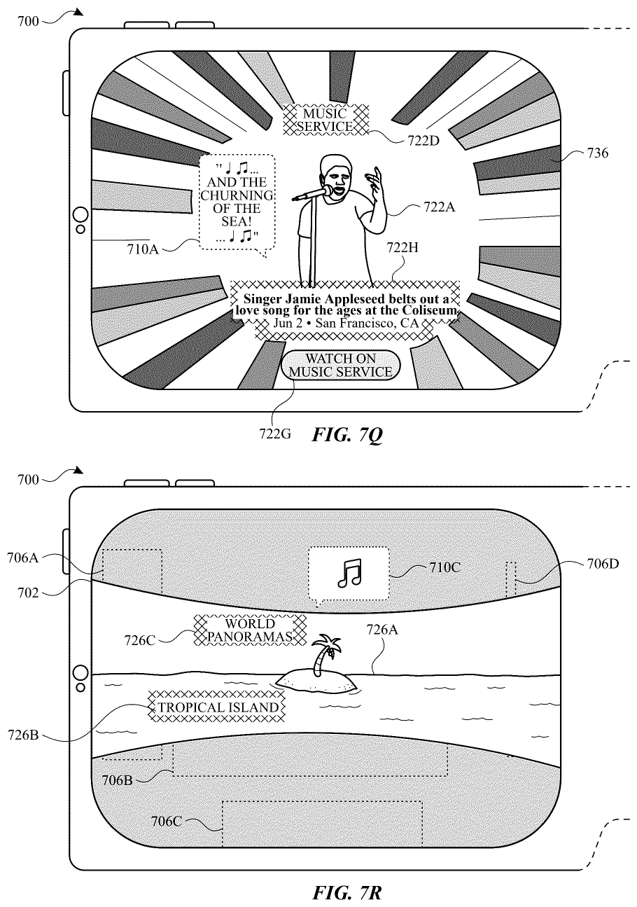

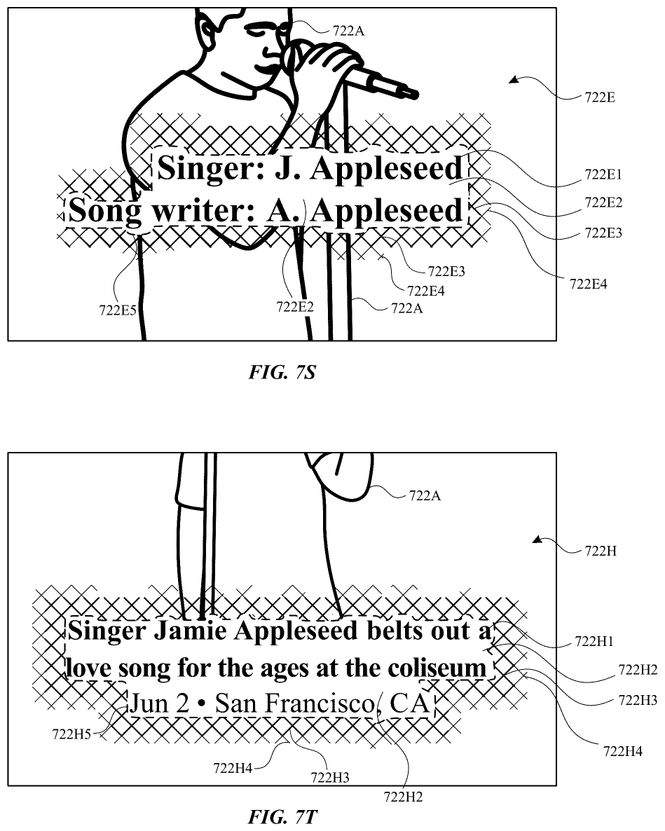

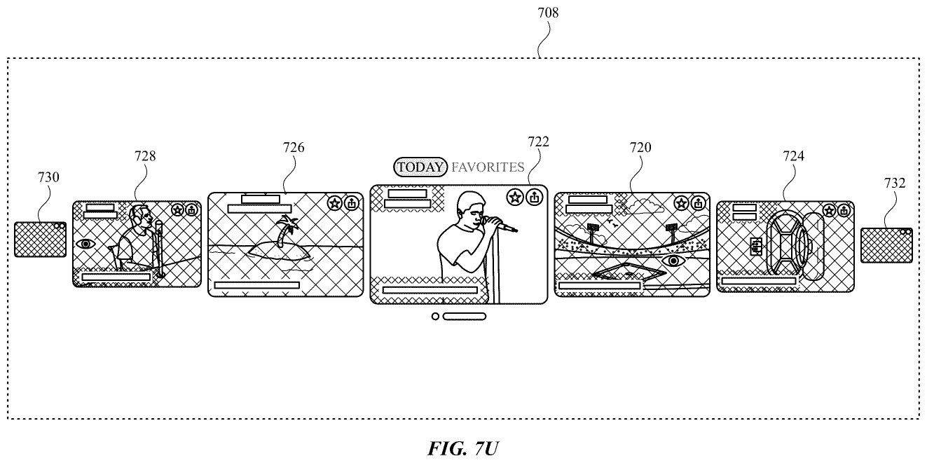

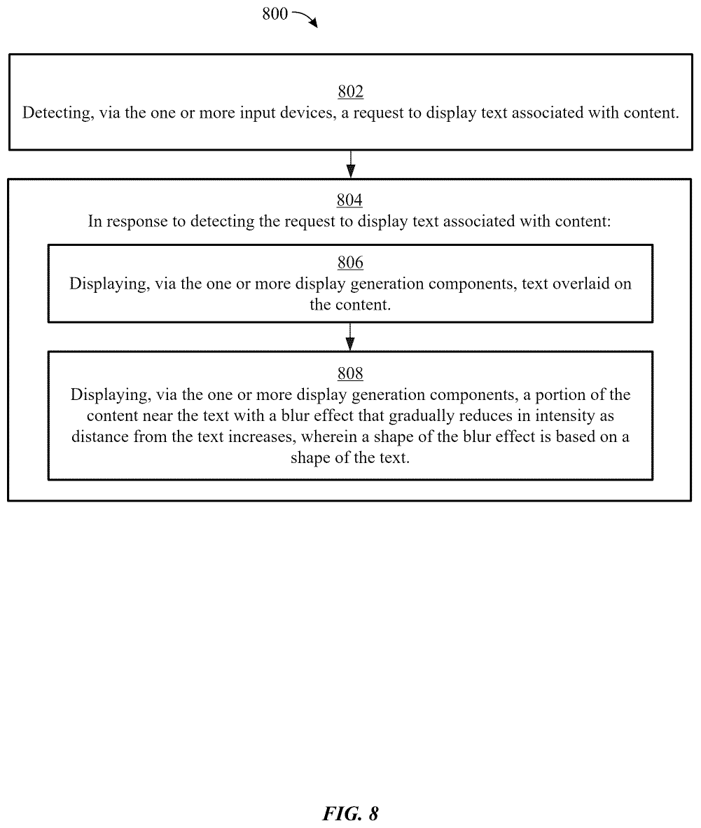

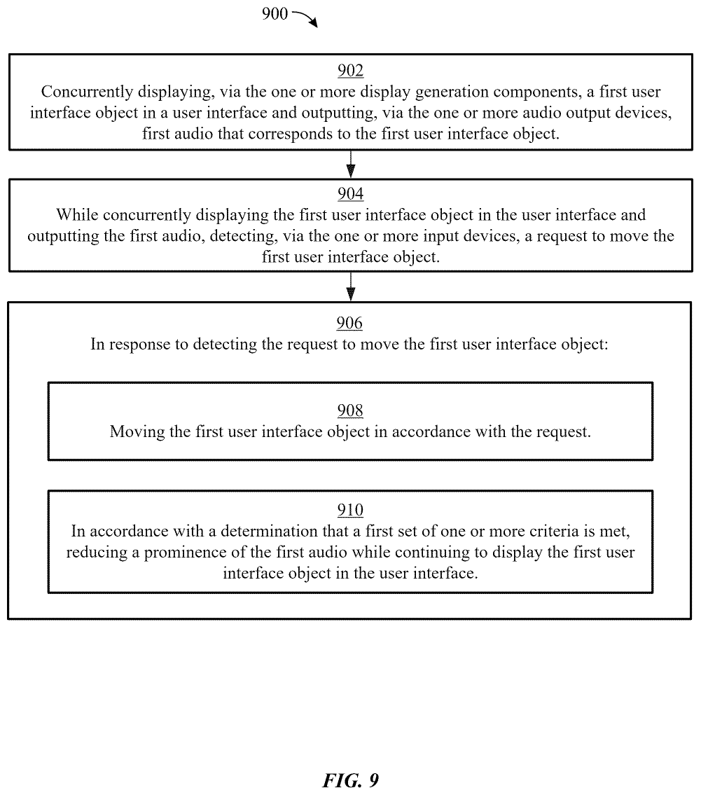

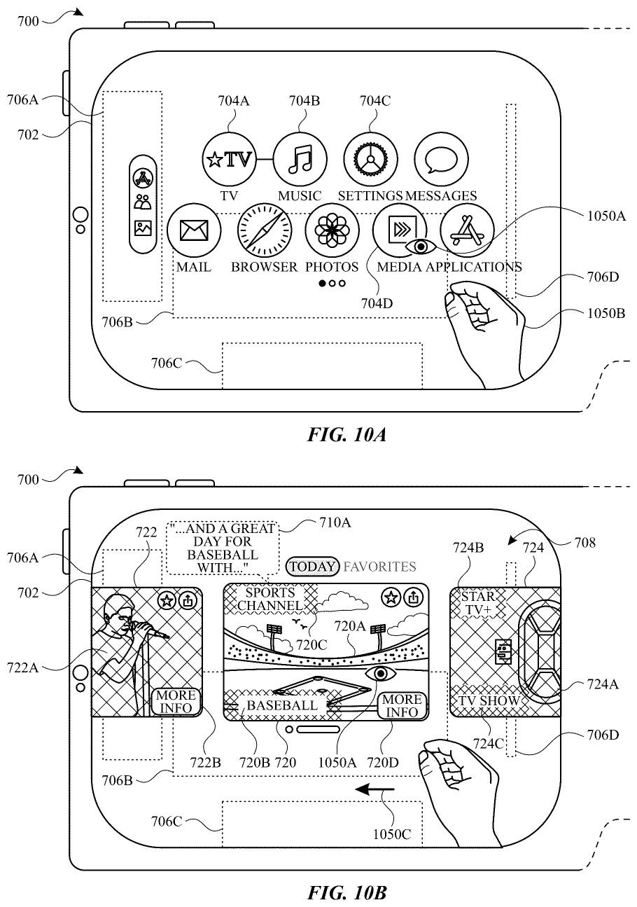

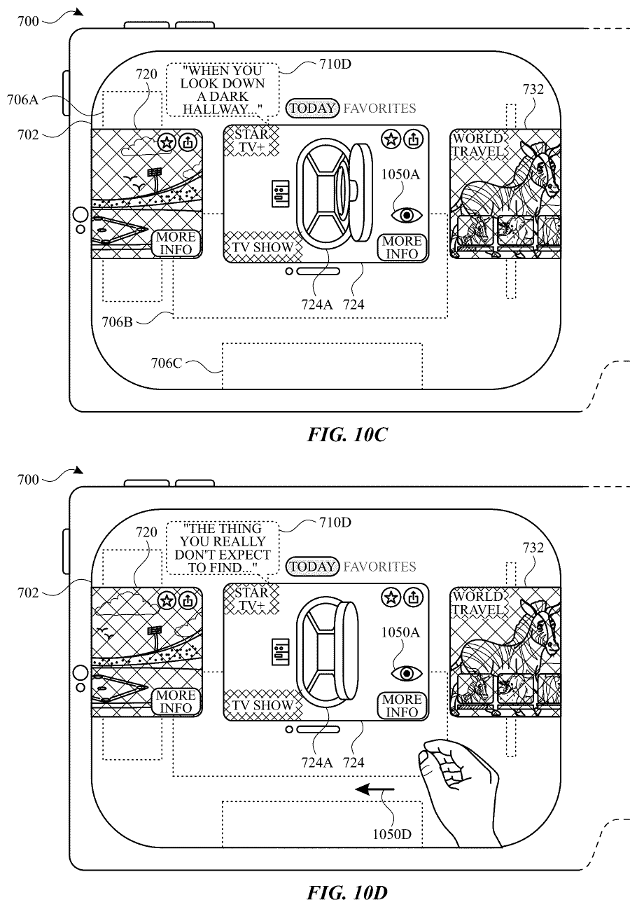

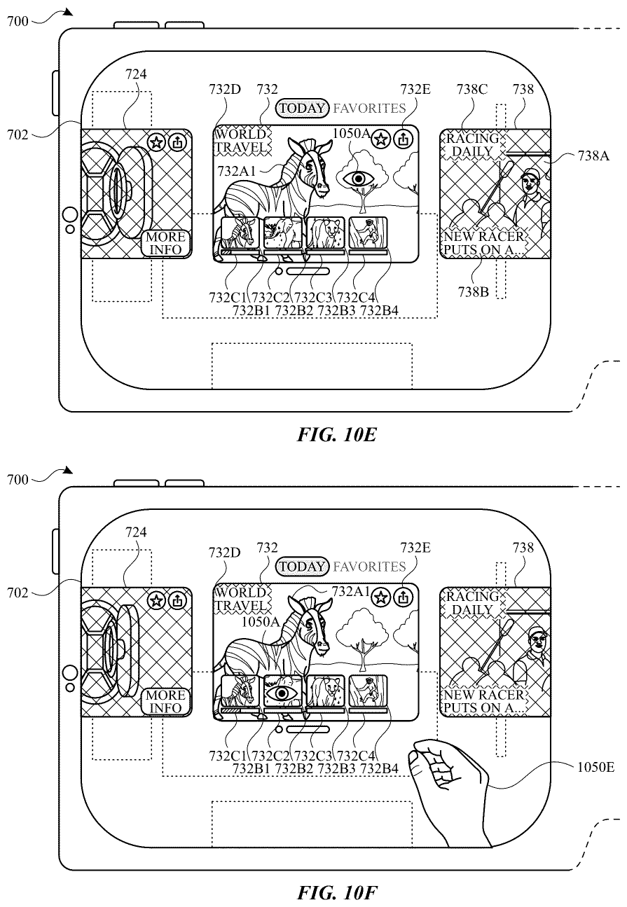

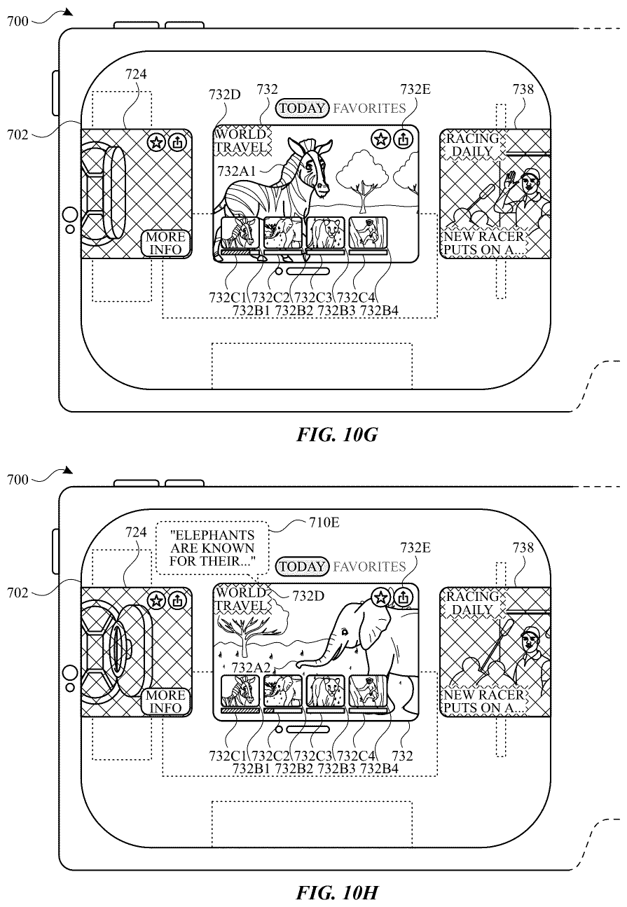

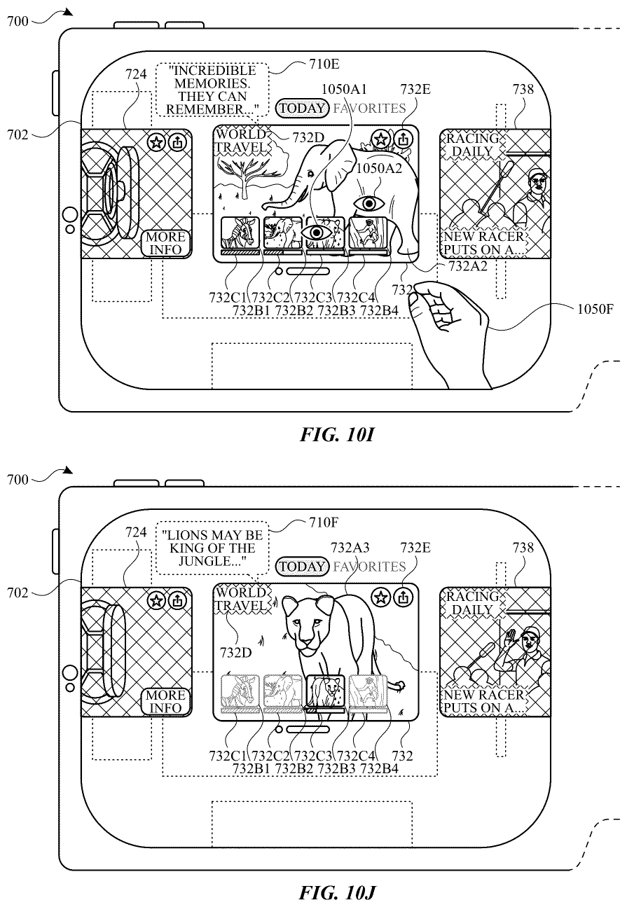

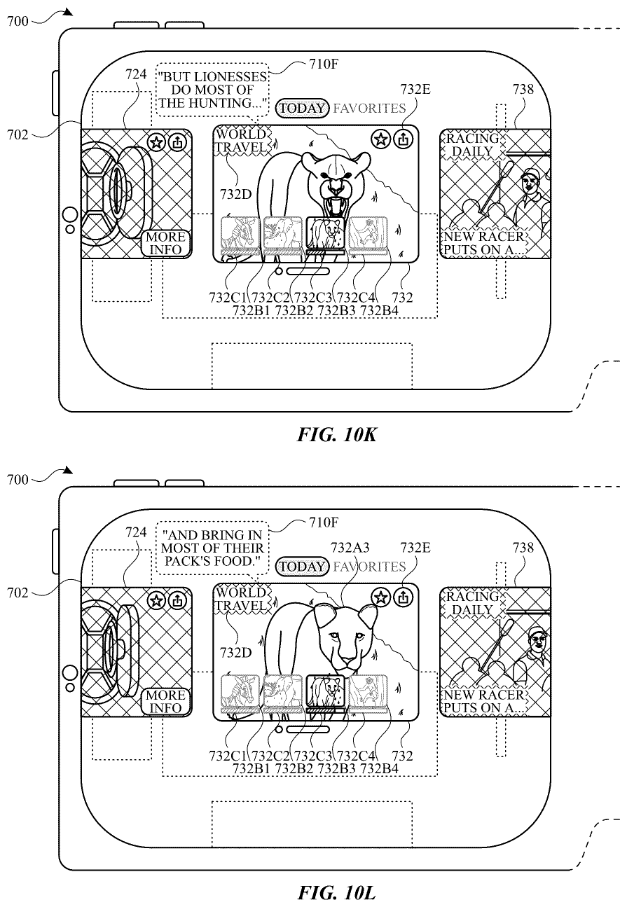

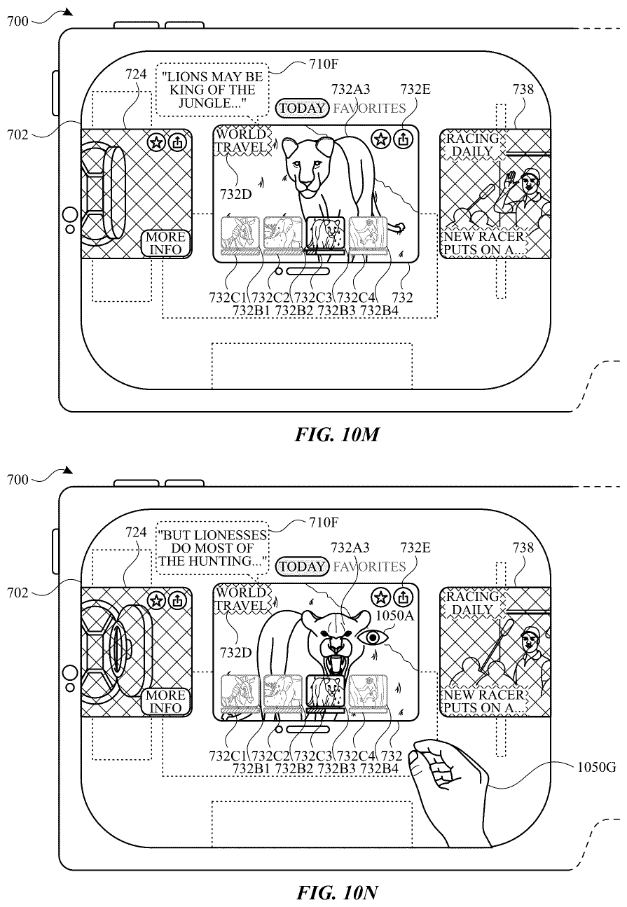

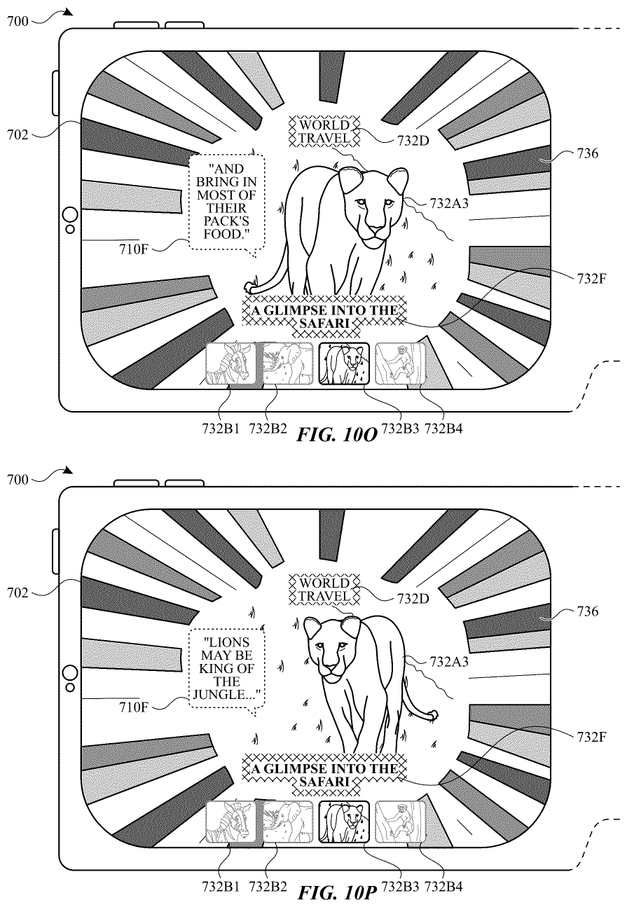

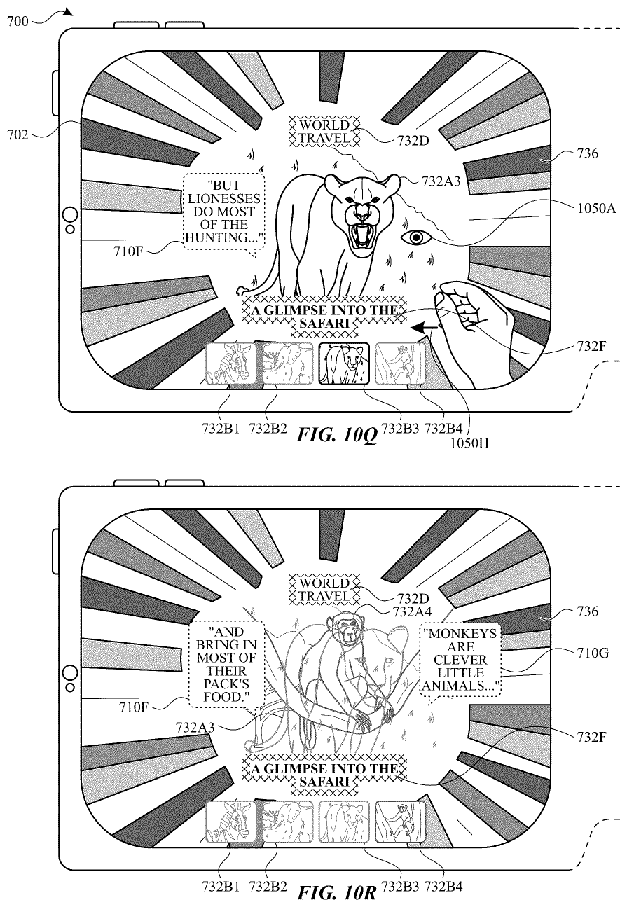

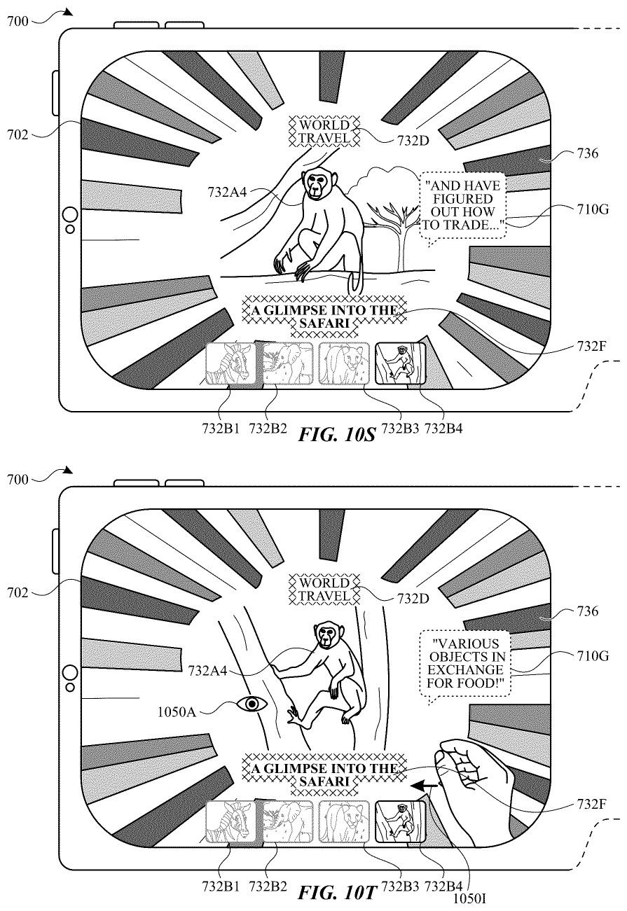

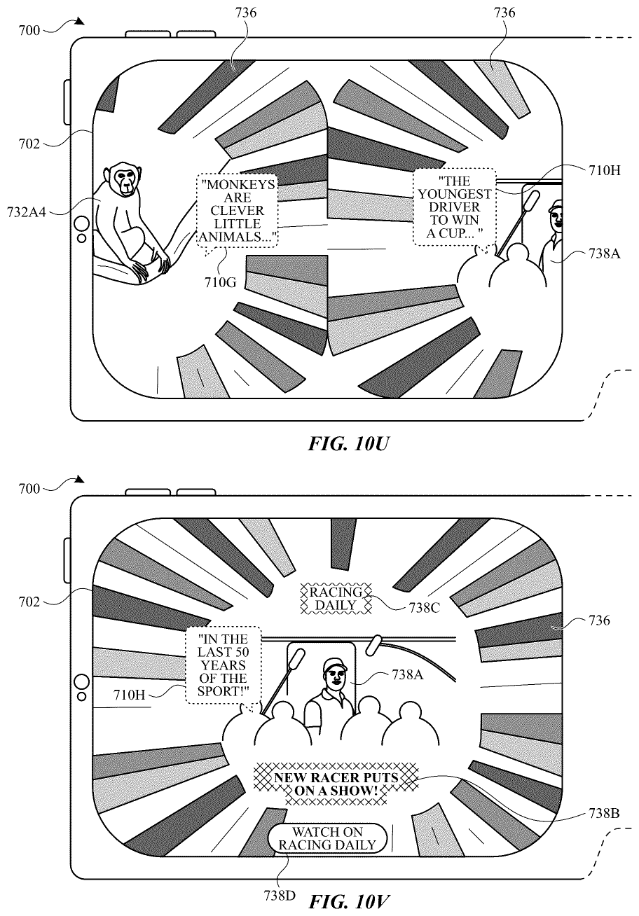

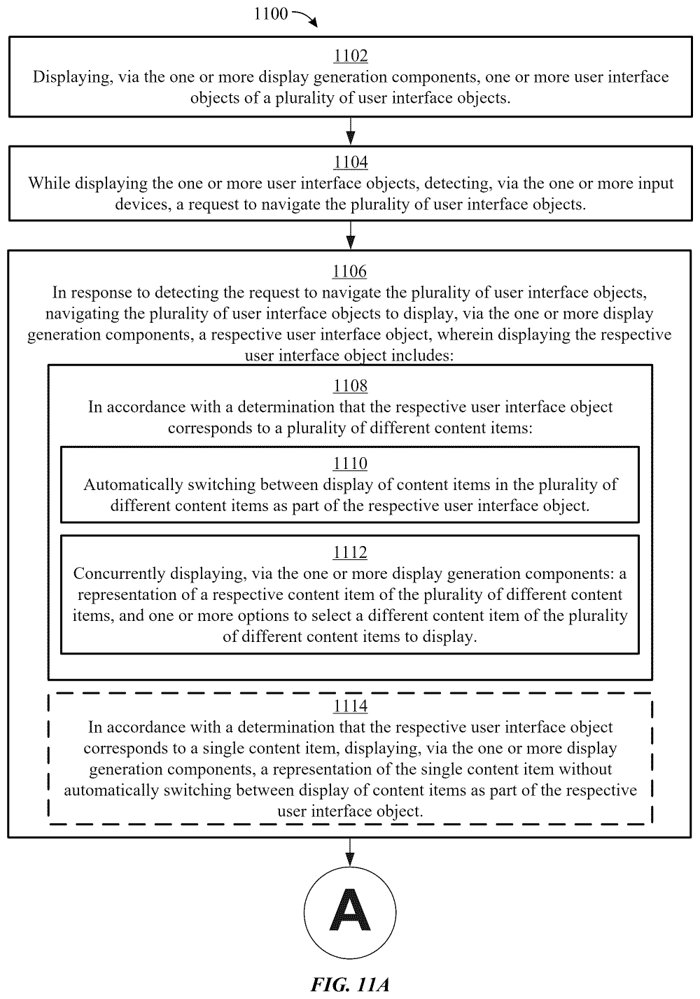

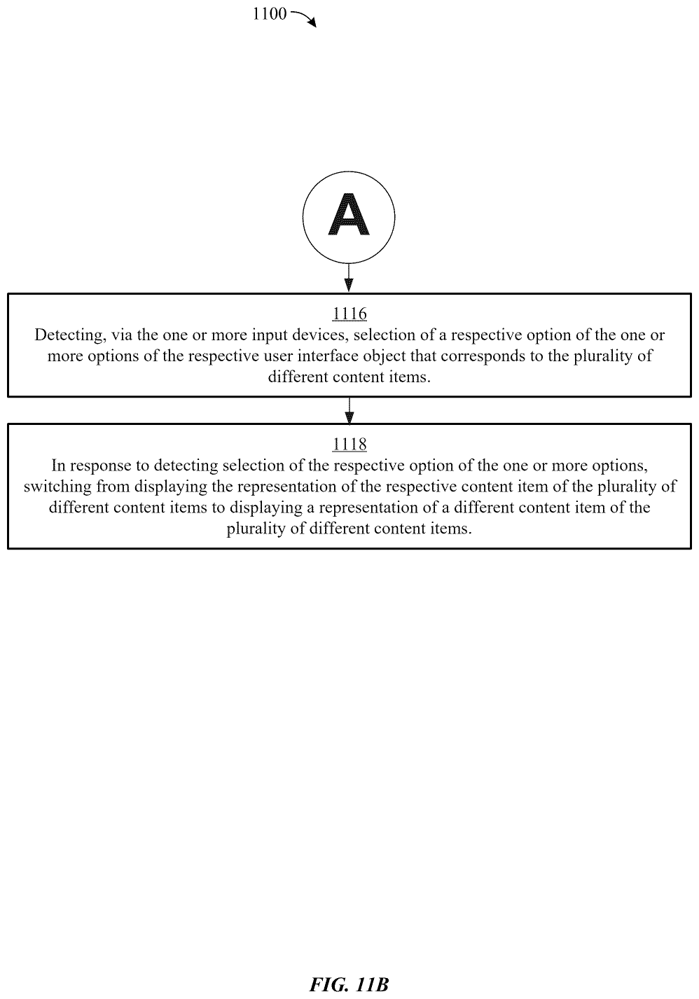

FIGS. 1A-6 provide a description of example computer systems for providing XR experiences to users. FIGS. 7A-7U illustrate example techniques for user interface interactions, in accordance with some embodiments. FIG. 8 is a flow diagram of methods of applying a blur effect, in accordance with some embodiments. FIG. 9 is a flow diagram of methods of managing audio output, in accordance with some embodiments. The user interfaces in FIGS. 7A-7U are used to illustrate the processes in FIGS. 8 and 9. FIGS. 10A-10V illustrate example techniques for automatically switching between display of representations of different content items, in accordance with some embodiments. FIGS. 11A-11B are a flow diagram of methods of automatically switching between display of representations of different content items, in accordance with some embodiments. The user interfaces in FIGS. 10A-10V are used to illustrate the processes in FIGS. 11A-11B.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted display (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head-mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head-mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head-mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, or 50 cm) of the point of reference in one or more dimensions (e.g., up/down, left/right, and/or forward/backward relative to the position of the point of reference).

In some embodiments, spatial media includes spatial visual media and/or spatial audio. In some embodiments, a spatial capture is a capture of spatial media. In some embodiments, spatial visual media (also referred to as stereoscopic media) (e.g., a spatial image and/or a spatial video) is media that includes two different images or sets of images, representing two perspectives of the same or overlapping fields-of-view, for concurrent display. A first image representing a first perspective is presented to a first eye of the viewer and a second image representing a second perspective, different from the first perspective, is concurrently presented to a second eye of the viewer. The first image and the second image have the same or overlapping fields-of-view. In some embodiments, a computer system displays the first image via a first display that is positioned for viewing by the first eye of the viewer and concurrently displays the second image via a second display, different from the first display, that is position for viewing by the second eye of the viewer. In some embodiments, the first image and the second image, when viewed together, create a depth effect and provide the viewer with depth perception for the contents of the images. In some embodiments, a first video representing a first perspective is presented to a first eye of the viewer and a second video representing a second perspective, different from the first perspective, is concurrently presented to a second eye of the viewer. The first video and the second video have the same or overlapping fields-of-view. In some embodiments, the first video and the second video, when viewed together, create a depth effect and provide the viewer with depth perception for the contents of the videos. In some embodiments, spatial audio experiences in headphones are produced by manipulating sounds in the headphone's two audio channels (e.g., left and right) so that they resemble directional sounds arriving in the ear-canal. For example, the headphones can reproduce a spatial audio signal that simulates a soundscape around the listener (also referred to as the user). An effective spatial sound reproduction can render sounds such that the listener perceives the sound as coming from a location within the soundscape external to the listener's head, just as the listener would experience the sound if encountered in the real world.

The geometry of the listener's ear, and in particular the outer ear (pinna), has a significant effect on the sound that arrives from a sound source to a listener's eardrum. The spatial audio sound experience is possible by taking into account the effect of the listener's pinna, the listener's head, and/or the listener's torso to the sound that enters to the listener's ear-canal. The geometry of the user's ear is optionally determined by using a three-dimensional scanning device that produces a three-dimensional model of at least a portion of the visible parts of the user's ear. This geometry is optionally used to produce a filter for producing the spatial audio experience. In some embodiments, spatial audio is audio that has been filtered such that a listener of the audio perceives the audio as coming from one or more directions and/or locations in three-dimensional space (e.g., from above, below, and/or in front of the listener).

An example of such a filter is a Head-Related Transfer Function (HRTF) filter. These filters are used to provide an effect that is similar to how a human ear, head, and torso filter sounds. When the geometry of the ears of a listener is known, a personalized filter (e.g., a personalized HRTF filter) can be produced so that the sound experienced by that listener through headphones (e.g., in-ear headphones, on-ear headphones, and/or over-ear headphones) is more realistic. In some embodiments, two filters are produced—one filter per ear—so that each ear of the listener has a corresponding personalized filter (e.g., personalized HRTF filter), as the ears of the listener may be of different geometry.

In some embodiments, a HRTF filter includes some (or all) acoustic information required to describe how sound reflects or diffracts around a listener's head before entering the listener's auditory system. In some embodiments, a personalized HRTF filter can be selected from a database of previously determined HRTFs for users having similar anatomical characteristics. In some embodiments, a personalized HRTF filter can be generated by numerical modeling based on the geometry of the listener's ear. One or more processors of the computer system optionally apply the personalized HRTF filter for the listener to an audio input signal to generate a spatial input signal for playback by headphones that are connected (e.g., wirelessly or by wire) to the computer system.

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touchscreen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

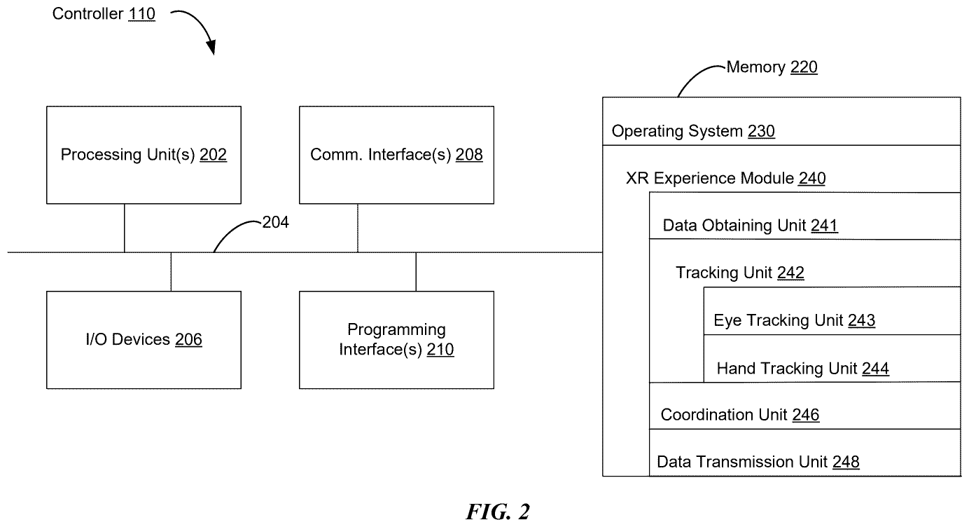

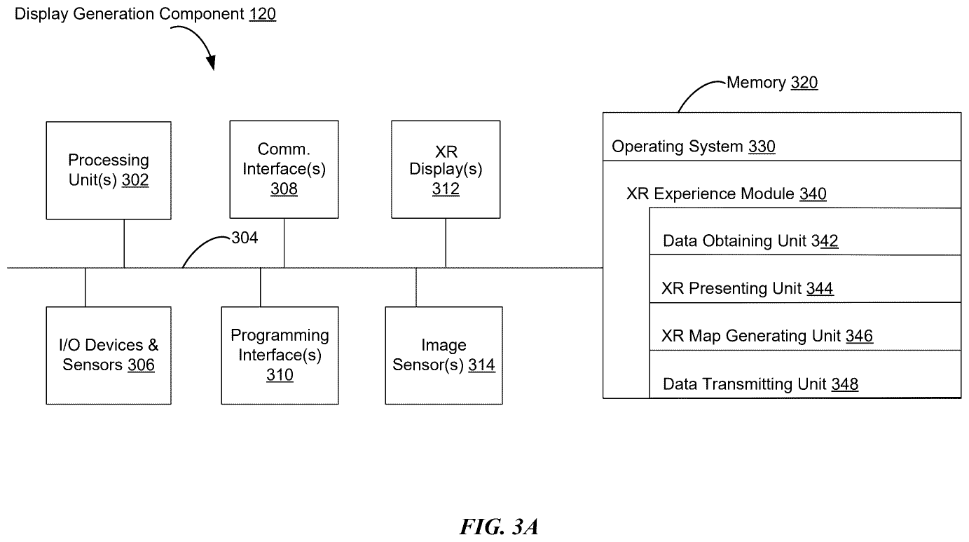

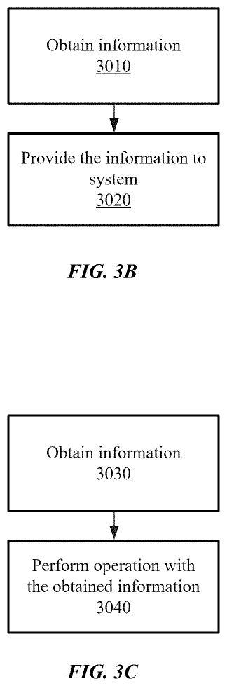

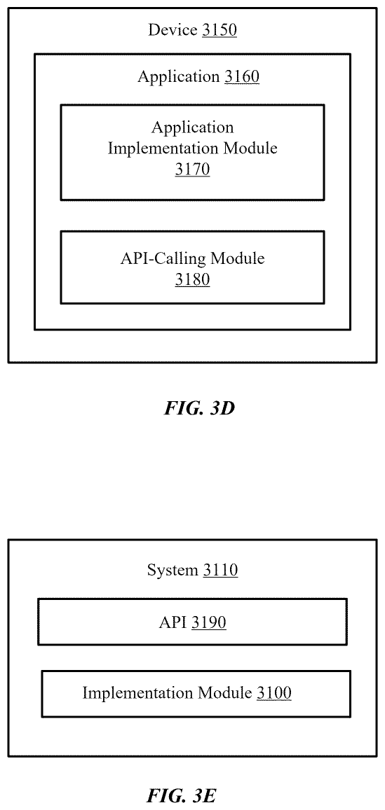

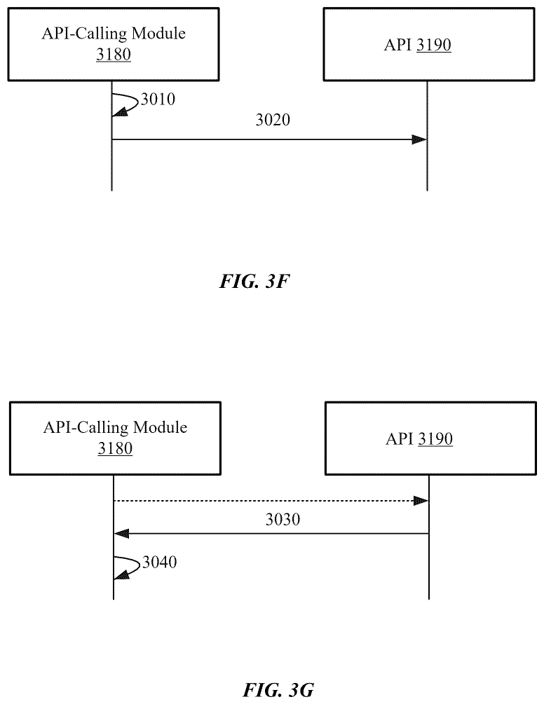

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user's head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward-facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-302 of an HMD. The display unit 1-302 can include a front display assembly 1-308, a frame/housing assembly 1-350, and a curtain assembly 1-324. The display unit 1-302 can also include a sensor assembly 1-356, logic board assembly 1-358, and cooling assembly 1-360 disposed between the frame assembly 1-350 and the front display assembly 1-308. In at least one example, the display unit 1-302 can also include a rear-facing display assembly 1-320 including first and second rear-facing display screens 1-322a, 1-322b disposed between the frame 1-350 and the curtain assembly 1-324.

In at least one example, the display unit 1-302 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-302 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the display assembly 1-108 of the HMD 1-100 shown in FIG. 1B or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1I. Terms such as “vertical,” “up,” “down,” and similar terms refer to orientations or directions as indicated by the Z-axis shown in FIG. 1I. Terms such as “frontward,” “rearward,” “forward,” “backward,” and similar terms refer to orientations or directions as indicated by the Y-axis shown in FIG. 1I.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward-facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward-facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin.

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

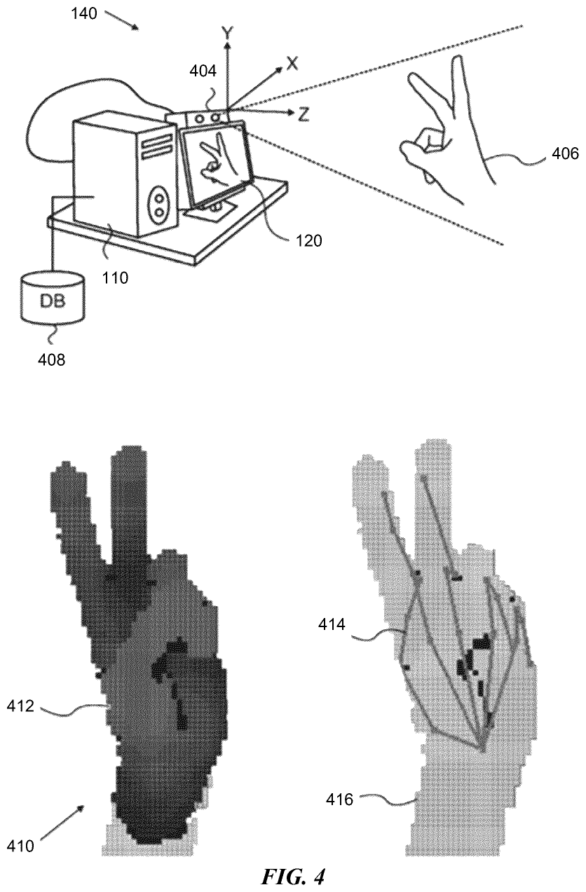

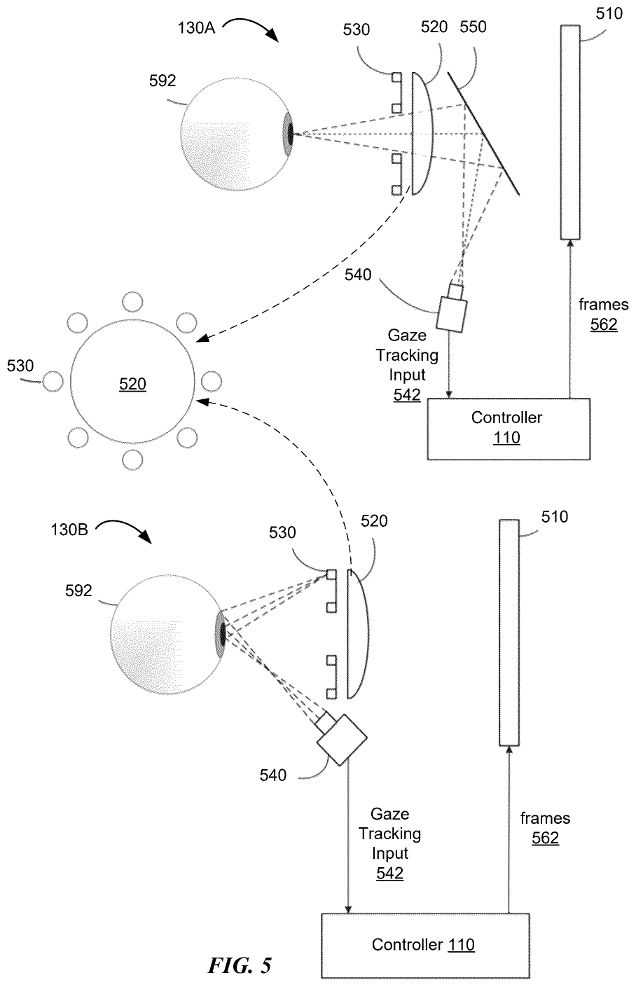

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800, 900, and/or 1100 (FIGS. 8, 9, and/or 11A-11B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105 or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture.

For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, e.g., the measured z distance from the image sensors 404, with the shade of gray growing darker with increasing depth. The controller 110 processes these depth values in order to identify and segment a component of the image (e.g., a group of neighboring pixels) having characteristics of a human hand. These characteristics, may include, for example, overall size, shape, and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device and is optionally used in conjunction with a head-mounted display generation component. In some embodiments, the eye tracking device 130 is not a head-mounted device and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)) mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head-mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

### User Interfaces and Associated Processes

Attention is now directed towards embodiments of user interfaces (“UI”) and associated processes that may be implemented on a computer system, such as a portable multifunction device or a head-mounted device, that is optionally in communication with one or more display generation components, one or more input devices, and/or one or more audio output devices.

FIGS. 7A-7U illustrate example techniques for user interface interactions, in accordance with some embodiments. FIG. 8 is a flow diagram of an exemplary method 800 for applying a blur effect, in accordance with some embodiments. FIG. 9 is a flow diagram of an exemplary method 900 for managing audio output, in accordance with some embodiments. The user interfaces in FIGS. 7A-7U are used to illustrate the processes described below, including the processes in FIG. 8. Throughout the description of FIGS. 7A-7U, some elements of the illustrated example techniques are referred to using descriptors (e.g., “sports” descriptor used as part of “sports media object 720”, “concert” descriptor used as part of “concert media object 722”, “television” descriptor used as part of “television media object 724”, and “panorama” descriptor used as part of “panorama media object 726”). These descriptors are merely for illustration and for the reader to more easily differentiate between the elements. Other terms can be used in place of the descriptors. For example, “first,” “second,” “third”, or other terms can optionally be used in place of the descriptors to differentiate between the different elements. More generally, it should be understood that in any situation where a specific descriptor is used before a user interface element (and in particular a user interface element that is followed by a reference number), that specific descriptor is merely one example of a general class of user interface elements with similar properties.

At FIG. 7A, computer system 700 displays an extended reality environment that includes representations 706A-706D of physical objects of the physical environment and virtual objects, such as selectable user interface objects 704A-704D. Display 702 of computer system 700 optionally has a transparent or translucent display through which a person may directly view the physical environment. Computer system 700 optionally presents virtual objects on the transparent or translucent display, so that a person, using the system, perceives the virtual objects superimposed over the physical environment. Alternatively, computer system 700 has an opaque display 702 and one or more imaging sensors capture images or video of the physical environment, which are representations of the physical environment, for display. As described above, computer system 700 optionally includes at least two displays, one display for each eye of the user to provide the user with a stereoscopic view of the extended reality environment.

At FIG. 7A, selectable user interface object 704A corresponds to a TV application, selectable user interface object 704B corresponds to a music application, selectable user interface object 704C corresponds to a system settings application, and selectable user interface object 704D corresponds to a media application. In response to detecting activation of a respective selectable user interface object 704A-704D, computer system 700 displays a user interface of the application corresponding to the activated respective selectable user interface object 704A-704D. At FIG. 7A, computer system 700 detects a selection gesture directed toward selectable user interface object 704D (e.g., detects gaze 750A of a user of computer system 700 directed at selectable user interface object 704D and pinch air gesture 750B) and, in response, computer system 700 displays user interface 708, as shown in FIG. 7B.

At FIG. 7B, user interface 708 includes a plurality of media objects (e.g., 720-724) that are part of a set of scrollable objects (e.g., 720-732, as shown in FIG. 7U). In some embodiments, the set of scrollable objects is an ordered set and the objects of the set of scrollable objects maintain their order while being scrolled. At FIG. 7B, computer system 700 is displaying sports media object 720 at a center position of user interface 708 and/or within a central area of user interface 708. Concert media object 722 is positioned to the left of sports media object 720. Concert media object 722 is smaller than sports media object 720, is further away from a viewpoint of the user of computer system 700 (e.g., in the extended reality environment) as compared to sports media object 720, and is dimmed and/or blurred as compared to sports media object 720. Thus, concert media object 722 is visually less prominent than sports media object 720. In some embodiments, computer system 700 displays objects of the set of scrollable objects with varying levels of visual prominence based on a location and/or size of the object. Similarly, television media object 724 is positioned to the right of sports media object 720. Television media object 724 is smaller than sports media object 720 and/or is further away from a viewpoint of the user of computer system 700 (e.g., in the extended reality environment) as compared to sports media object 720. As shown in FIG. 7B, television media object 724 is not dimmed or blurred as compared to sports media object 720 because of the position (e.g., within user interface 708 and/or being near a central area of user interface 708) and/or a size of television media object 724.

At FIG. 7B, sports media object 720 is at a central area of user interface 708 and gaze 750A of the user is directed to sports media object 720 and, as a result, computer system 700 displays visual content 720A and outputs audio 710A of a media of sports media object 720. The media of sports media object 720 includes audio and video of a baseball game. Audio 710A and visual content 720A correspond to each other and to sports media object 720. In some embodiments, visual content 720A includes stereoscopic content (e.g., content with a three-dimensional effect that is generated using different images for different eyes that produces a stereoscopic depth effect). In some embodiments, audio 710A is spatial audio that the user perceives as coming from a location of sports media object 720. Throughout FIGS. 7A-7U, audio (e.g., 710A-710C) is visually illustrated for ease of understanding, but the audio is optionally not visually included in the user interfaces of computer system 700.

Sports media object 720 also includes text. Text 720B is overlaid on visual content 720A and is displayed with a blur effect applied to visual content 720A to make text 720B more legible. In some embodiments, the blur effect is a feathered blur effect that reduces in intensity as a distance from text 720B increases, as described in further detail with respect to FIGS. 7S and 7T. In some embodiments, a shape and/or size of the blur effect of text 720B is based on a shape and/or size of text 720B, as described in further detail with respect to FIGS. 7S and 7T. In some embodiments, computer system 700 determines that the blur effect should be applied for text 720B and 720C because visual content 720A is stereoscopic content and/or the respective text does not have a platter (e.g., an opaque platter and/or other object) positioned between (e.g., from a viewpoint of a user) the respective text and the visual content of Sports media object 720. Thus, computer system 700 applies the blur effect for text that would otherwise be difficult to read or may cause unnecessary eye strain to read, such as text 720B-720C and computer system 700 does not apply the blur effect for text that is not difficult to read (e.g., because a platter is behind the text), such as text 720D. In some embodiments, playback of the media of sports media object 720 is looped and restarts when an end of the playback is reached.

At FIG. 7B, television media object 724 includes stereoscopic content 724A (e.g., a video and/or an image) and, accordingly, texts 724B-724C are overlaid on content 724A with a blur effect applied to content 724A to make text 724B-724C more legible. Computer system 700 is not outputting audio corresponding to television media object 724 (e.g., because of a position and/or size of television media object 724). At FIG. 7B, concert media object 722 includes stereoscopic visual content 722A (e.g., a video and/or an image). Because text 722B includes a platter positioned between the text and visual content 724A (from a viewpoint of a user of the computer system 700), computer system 700 does not apply a blur effect for text 722B. Computer system 700 is not outputting audio corresponding to concert media object 722 (e.g., because of a position and/or size of concert media object 722).

At FIG. 7B, computer system 700 detects a navigation gesture directed towards user interface 708 (e.g., detects gaze 750A of the user directed to user interface 708 (e.g., directed at sports media object 720) and detects air pinch and right drag gesture 750C). In response to detecting the navigation gesture directed towards user interface 708 (e.g., detecting gaze 750A and/or air pinch and right drag gesture 750C), computer system 700 scrolls the set of scrollable objects within user interface 708 to the right, as shown in FIG. 7C. As the objects of the set of scrollable objects scroll, computer system 700 resizes the objects. As described in greater detail with respective to FIG. 7U, as objects get closer to the central area of user interface 708, the objects get bigger and as objects get further from the central area of user interface 708, the objects get smaller. At FIG. 7C, concert media object 722 has gotten bigger in size based on moving closer to (or into) the central area of user interface 708 and television media object 724 has reduced in size based on moving further from the central area of user interface 708. Computer system 700 has reduced a visual prominence of television media object 724 based on the location and/or size of television media object 724. For example, computer system 700 has paused, dimmed, and/or blurred television media object 724 based on the location and/or size of television media object 724 at FIG. 7C. In some embodiments, as objects get closer to the central area of user interface 708, the objects get less dimmed and/or less blurred, and as objects get further from the central area of user interface 708, the objects get more dimmed and/or more blurred. In some embodiments, as objects get bigger, the objects get less dimmed and/or less blurred, and as objects get smaller, the objects get more dimmed and/or more blurred. For example, television media object 724 at FIG. 7C is more dimmed and/or blurred than concert media object 722 at FIG. 7B because television media object 724 at FIG. 7C is further from the central area than concert media object 722 at FIG. 7B and/or because television media object 724 at FIG. 7C is smaller than concert media object 722 at FIG. 7B.

At FIG. 7C, computer system 700 increases a visual prominence of concert media object 722 based on the location of concert media object 722 and/or a size of concert media object 722. For example, computer system 700 has reduced the dimming and/or blurring of concert media object 722. Computer system 700 scrolling the set of scrollable objects within user interface 708 to the right has also caused display of text 722C and 722D of concert media object 722. Concert media object 722 includes stereoscopic content 722A (e.g., a video and/or an image) and, accordingly, texts 722C-722D are overlaid on content 722A with a blur effect applied to content 722A to make text 722D-722D more legible.

At FIG. 7C, because gaze 750A of the user remains directed at sports media object 720, computer system 700 continues to output audio 710A of sports media object 720 and computer system 700 does not output audio of concert media object 722. Visual content 720A (e.g., the video) of media of sports media object 720 continues to play. At FIG. 7C, based on a position (e.g., more than a threshold amount of concert media object 722 being within the central area of user interface 708) and/or size (e.g., concert media object 722 being larger than a threshold size) of concert media object 722, visual content 722A (e.g., video) of concert media object 722 begins to play.

At FIG. 7D, gaze 750A of the user is directed at concert media object 722. However, because gaze 750A of the user is directed at concert media object 722 for less than a threshold duration of time (e.g., less than 0.05, 0.1, 0.3, 0.5, and/or 0.8 seconds), computer system 700 continues to output audio 710A of sports media object 720 without reducing a prominence of audio 710A.

At FIG. 7E, gaze 750A of the user continues to be directed at concert media object 722 and, in particular, at text 722B. Because gaze 750A of the user is directed at concert media object 722 for more than the threshold duration of time (e.g., more than 0.05, 0.1, 0.3, 0.5, and/or 0.8 seconds), computer system 700 reduces the prominence of audio 710A of sports media object 720 and (optionally, concurrently or not concurrently) increases the prominence of audio 710B of concert media object 722. For example, computer system 700 performs a cross fade between audio 710A and audio 710B by reducing the volume of audio 710A over time and increasing the volume of audio 710B over time. In some examples, computer system 700 reduces the prominence of audio 710A by pausing audio 710A. At FIG. 7E, computer system 700 detects an input (e.g., a selection input) directed towards text 722B (e.g., detects gaze 750A of the user directed to text 722B and detects air pinch gesture 750D). In response to detecting the input (e.g., a selection input) directed towards text 722B (e.g., detecting gaze 750A and/or air pinch gesture 750D), computer system 700 expands and/or replaces text 722B with text 722E. Because text 722E is overlaid on stereoscopic content 722A, a blur effect is applied to make text 722E more legible.

At FIG. 7F, computer system 700 has finished reducing the prominence of audio 710A, and continues to output audio 710B. Throughout FIGS. 7D-7F, visual content 720A (e.g., video) of sports media object 720 and visual content 722A (e.g., video) of concert media object 722 continue play based on the positions and/or sizes of sports media object 720 and concert media object 722. At FIG. 7F, computer system 700 displays notification 734, corresponding to a received email, of a mail application. Notification 734 does not have any corresponding audio (e.g., no audio alert is associated with notification 734). Notification 734 is a user interface element of an application (e.g., a system notification application and/or an email application) that is different from the application (e.g., a media viewer application) of user interface 708.

At FIG. 7G, computer system 700 detects that gaze 750A of the user is directed to notification 734 (e.g., for less than or for more than the threshold duration of time). At FIG. 7G, computer system 700 does not reduce the prominence of audio 710B in response to detecting gaze 760A directed to notification 734. In some embodiments, computer system 700 does not reduce the prominence of audio 710B because gaze 750A is directed at a user interface that does not have corresponding audio and/or because gaze 750A is directed at a user interface of an application different from the application (e.g., a media viewer application) of user interface 708. Accordingly, computer system 700 continues to output audio 710B of concert media object 722, as shown in FIGS. 7G and 7H.

At FIG. 7H, computer system 700 detects a navigation gesture directed towards user interface 708 (e.g., detects gaze 750A of the user directed to user interface 708 (e.g., directed at concert media object 722) and detects air pinch and right drag gesture 750E). In response to detecting navigation gesture directed towards user interface 708 (e.g., in response to detecting gaze 750A and/or air pinch and right drag gesture 750E), computer system 700 scrolls the set of scrollable objects within user interface 708 to the right, as shown in FIGS. 7I-7K. As the objects of the set of scrollable objects scroll, computer system 700 resizes the objects. As described in greater detail with respective to FIG. 7U, as objects get closer to the central area of user interface 708, the objects get bigger and as objects get further from the central area of user interface 708, the objects get smaller.

At FIG. 7I, concert media object 722 has gotten smaller in size based on moving further from (and/or out of) the central area of user interface 708, panorama media object 726 has scrolled onto the display and increased in size based on moving closer to the central area of user interface 708, and music media object 728 has partially scrolled onto the display with reduced visual prominence (e.g., is paused, dimmed, and/or blurred). At FIG. 7I, computer system 700 has begun to reduce a prominence of audio 710B of concert media object 722 based on the location and/or size of concert media object 722. For example, computer system 700 has begun to reduce the volume of audio 710B of concert media object 722 based on the location and/or size of concert media object 722 at FIG. 7I. For example, computer system 700 has begun to reduce the volume of audio 710B of concert media object 722 because of the distance of concert media object 722 to the central area of user interface 708 and/or because concert media object 722 has sufficiently reduced in size. In some embodiments, computer system 700 reduces the prominence of audio of a media object (e.g., concert media object 722) when a size of the media object has been reduced in size to less than a threshold size (e.g., the same as or different from the threshold size used for reducing the prominence of the visual content, reduced in size by 20%, 35%, 40%, or 45% as compared to when the object is within the central area of user interface 708). In particular, computer system 700 begins to cross fade between audio 710B of concert media object 722 and audio 710C of panorama media object 726 by reducing the volume of audio 710B and increasing the volume of audio 710C. However, at FIG. 7I, computer system 700 has not reduced a visual prominence of concert media object 722 based on the location and/or size of concert media object 722. For example, computer system 700 has not paused, dimmed, and/or blurred concert media object 722 based on the location and/or size of concert media object 722 at FIG. 7I. For example, computer system 700 has not paused, dimmed, and/or blurred concert media object 722 because of the proximity of concert media object 722 to the central area of user interface 708 and/or because concert media object 722 has not sufficiently reduced in size. In some embodiments, computer system 700 reduces the prominence of the visual content of a media object (e.g., concert media object 722) when a size of the media object has been reduced in size to less than a threshold size (e.g., the same as or different from the threshold size used for reducing the prominence of the audio, reduced in size by 50%, 70%, 75%, or 80% as compared to when the object is within the central area of user interface 708).

At FIG. 7J, as computer system 700 continues to detect the navigation gesture directed towards user interface 708 (e.g., continues to detect air pinch and right drag gesture 750E), concert media object 722 has gotten smaller in size based on moving further from the central area of user interface 708 and music media object 728 has increased in size based on moving closer to the central area of user interface 708. At FIG. 7J, computer system 700 has finished reducing a prominence of audio 710B of concert media object 722 (e.g., audio 710B is no longer being output) based on the location and/or size of concert media object 722. In particular, computer system 700 has finished cross fading between audio 710B of concert media object 722 and audio 710C of panorama media object 726. At FIG. 7J, computer system 700 has also reduced a visual prominence of concert media object 722 based on the location and/or size of concert media object 722. For example, computer system 700 has paused, dimmed, and/or blurred concert media object 722 based on the location and/or size of concert media object 722 at FIG. 7J. For example, computer system 700 has paused, dimmed, and/or blurred concert media object 722 because of the distance of concert media object 722 to the central area of user interface 708 and/or because of the reduced size of concert media object 722. At FIG. 7J, computer system 700 has increased a visual prominence of music media object 728 based on the location and/or size of music media object 728 (e.g., while maintaining a reduced prominence (e.g., paused) of audio for music media object 728). For example, computer system 700 has increased a visual prominence of music media object 728 based the proximity of music media object 728 to the central area of user interface 708 and/or the increased size of music media object 728.

At FIG. 7K, the set of scrollable media objects have finished scrolling to the right based on the navigation gesture directed towards user interface 708 (e.g., based on air pinch and right drag gesture 750E) and concert media object 722 has gotten smaller in size (as compared to FIG. 7J) based on moving further from the central area of user interface 708 and music media object 728 has increased in size (as compared to FIG. 7J) based on moving closer to the central area of user interface 708. At FIG. 7K, computer system 700 has further reduced the visual prominence of concert media object 722 based on the location and/or size of concert media object 722. For example, as FIG. 7K, computer system 700 has further dimmed and/or further blurred concert media object 722 (as compared to FIG. 7J) based on the location and/or size of concert media object 722. For example, computer system 700 has further dimmed and/or further blurred concert media object 722 because of the increased distance of concert media object 722 to the central area of user interface 708 and/or because of the further reduced size of concert media object 722. At FIG. 7K, computer system 700 music media object 729 has further increased in size in response to the navigation gesture directed towards user interface 708 (e.g., in response to air pinch and right drag gesture 750E) as music media object 729 has gotten closer to the central area of user interface 708.

At FIG. 7K, computer system 700 detects a navigation gesture directed to user interface 708 (e.g., detects gaze 750A of the user directed to user interface 708 (e.g., directed at concert media object 722) and detects air pinch and left drag gesture 750F). In response to detecting the navigation gesture directed to user interface 708 (e.g., in response to detecting gaze 750A and/or air pinch and left drag gesture 750F), computer system 700 scrolls the set of scrollable objects within user interface 708 to the left, as shown in FIGS. 7L-7N. As the objects of the set of scrollable objects scroll, computer system 700 resizes the objects. As described in greater detail with respective to FIG. 7U, as objects get closer to the central area of user interface 708, the objects get bigger and as objects get further from the central area of user interface 708, the objects get smaller.

At FIG. 7L, as computer system 700 continues to detect navigation gesture directed to user interface 708 (e.g., continues to detect air pinch and left drag gesture 750F), music media object 728 has gotten smaller in size based on moving further from the central area of user interface 708, panorama media object 726 has scrolled to the left, and concert media object 722 gotten larger in size based on moving towards the central area of user interface 708. Computer system 700 continues to output audio 710C of panorama media object 726. At FIG. 7L, computer system 700 has also increased the visual prominence of concert media object 722 by playing the visual content (no longer paused), ceasing dimming, and/or ceasing blurring of concert media object 722. At FIG. 7L, computer system 700 has reduced a visual prominence of music media object 728 based on the location and/or size of music media object 728. For example, at FIG. 7L, computer system 700 has paused video playback, dimmed, and/or blurred music media object 728. In some embodiments, computer system 700 reduces the prominence of the visual content of a media object (e.g., music media object 728) when a size of the media object has been reduced in size to less than a threshold size (e.g., reduced in size by 50%, 70%, 75%, or 80% as compared to when the object is within the central area of user interface 708).

At FIG. 7M, as computer system 700 continues to detect navigation gesture directed to user interface 708 (e.g., continues to detect air pinch and left drag gesture 750F), music media object 728 is no longer displayed, panorama media object 726 has scrolled to the left and gotten smaller in size (e.g., based on moving away from the central area of user interface 708), concert media object 722 has scrolled to the left and increased in size, and sports media object 720 has partially scrolled onto the display.

At FIG. 7M, computer system 700 has begun to reduce a prominence of audio 710C of panorama media object 726 based on the location and/or size of panorama media object 726. For example, computer system 700 has begun to reduce the volume of audio 710C of panorama media object 726 based on the location and/or size of panorama media object 726 at FIG. 7M because of the distance of panorama media object 726 to the central area of user interface 708 and/or because panorama media object 726 has sufficiently reduced in size. In some embodiments, computer system 700 reduces the prominence of audio of a media object (e.g., panorama media object 726) when a size of the media object has been reduced in size to less than a threshold size (e.g., the same as or different from the threshold size used for reducing the prominence of the visual content, reduced in size by 20%, 35%, 40%, or 45% as compared to when the object is within the central area of user interface 708). In particular, computer system 700 begins to cross fade between audio 710C of panorama media object 726 and audio 710B of concert media object 722 by reducing the volume of audio 710C and increasing the volume of audio 710B. However, at FIG. 7M, computer system 700 has not reduced a visual prominence of panorama media object 726 based on the location and/or size of panorama media object 726. For example, computer system 700 has not paused, dimmed, and/or blurred panorama media object 726 based on the location and/or size of panorama media object 726 at FIG. 7M. For example, computer system 700 has not paused, dimmed, and/or blurred panorama media object 726 because of the proximity of panorama media object 726 to the central area of user interface 708 and/or because panorama media object 726 has not sufficiently reduced in size. In some embodiments, computer system 700 reduces the prominence of the visual content of a media object (e.g., panorama media object 726) when a size of the media object has been reduced in size to less than a threshold size (e.g., the same as or different from the threshold size used for reducing the prominence of the audio; reduced in size by 50%, 70%, 75%, or 80% as compared to when the object is within the central area of user interface 708). At FIG. 7M, sports media object 720 has a reduced visual prominence, such as by being paused, dimmed, and/or blurred.

At FIG. 7N, panorama media object 726 has gotten even smaller in size (as compared to FIG. 7M) based on moving further from the central area of user interface 708 and sports media object 720 has increased in size based on moving closer to the central area of user interface 708. At FIG. 7N, computer system 700 has finished reducing a prominence of audio 710C of panorama media object 726 (e.g., audio 710C is no longer being output) based on the location and/or size of panorama media object 726. In particular, computer system 700 has finished cross fading between audio 710C of panorama media object 726 and audio 710B of concert media object 722. At FIG. 7N, computer system 700 has also reduced a visual prominence of panorama media object 726 based on the location and/or size of panorama media object 726. For example, computer system 700 has paused, dimmed, and/or blurred panorama media object 726 based on the location and/or size of panorama media object 726 at FIG. 7N. For example, computer system 700 has paused, dimmed, and/or blurred panorama media object 726 because of the increased distance of panorama media object 726 to the central area of user interface 708 and/or because of the reduced size of panorama media object 726. At FIG. 7N, computer system 700 has increased a visual prominence of sports media object 720 based on the location and/or size of sports media object 720 (e.g., while maintaining a reduced prominence (e.g., paused) of audio for sports media object 720). For example, computer system 700 has increased a visual prominence of sports media object 720 based the reduced distance of sports media object 720 to the central area of user interface 708 and/or the increased size of sports media object 720.

At FIG. 7N, computer system 700 detects a selection input directed toward share user interface object 722F (e.g., detects gaze 750A of the user directed to share user interface object 722F and detects air pinch gesture 750G). In response to detecting the selection input directed toward share user interface object 722F (e.g., in response to detecting gaze 750A and/or air pinch gesture 750G), computer system 700 initiates a process to share media of concert media object 722, including displaying share user interface 722G, as shown in FIG. 7O. Share user interface 722G is a modal user interface element that that prevents and/or blocks interaction with other elements of user interface 708 while share user interface 722G is displayed. In some embodiments, in response to detecting air pinch gesture 750G and/or in response to displaying share user interface 722G, computer system 700 pauses and/or stops the audio and/or video playback of the media of concert media object 722, as shown in FIG. 7O. In some embodiments, in response to detecting air pinch gesture 750G and/or in response to displaying share user interface 722G, computer system 700 does not pause or stop the audio and/or video playback of the media of concert media object 722, enabling the user to continue to listen to the media and/or view portions of the media. Computer system 700 optionally receives user inputs directed to share user interface 722G to identify a destination and/or recipient with which to share the media.

At FIG. 7O, computer system 700 detects a selection input directed toward a dismiss object of share user interface 722G (e.g., detects gaze 750A of the user directed to a dismiss object of share user interface 722G and detects air pinch gesture 750H). In response to detecting the selection input directed toward the dismiss object of share user interface 722G (e.g., in response to detecting gaze 750A and/or air pinch gesture 750H), computer system 700 dismisses (e.g., minimizes and/or ceases to display) share user interface 722G, as shown in FIG. 7P, and, optionally, resumes to play the video and output audio 710B of concert media object 722.

In some embodiments, activation of a respective object of the set of scrollable objects causes the respective object to be displayed in a larger, more complete, and/or more immersive configuration. For example, at FIG. 7P, computer system 700 detects an input (e.g., a selection input) directed towards concert media object 722 (e.g., detects gaze 750A of the user directed to a concert media object 722 and detects air pinch gesture 750I). In response to detecting the input (e.g., a selection input) directed towards concert media object 722 (e.g., detecting gaze 750A and/or air pinch gesture 750I), computer system 700 displays the user interface of FIG. 7Q, which includes audio and video playback of the media of concert media object 722 (and optionally does not include other objects of the set of scrollable objects). In this example, warp effect 736 is applied to reduce or cease displaying representations 706A-706D of physical objects of the physical environment. In some embodiments, warp effect 736 is a pixel stretch effect. In some embodiments, applying warp effect 736 includes selecting one or more rows or columns of pixels from each side of a visual component of media and stretching the selected pixels out beyond the image to create a warped appearance. In some embodiments, warp effect 736 includes blurring. As shown in FIG. 7Q, text 722D and text 722H are displayed overlaid on the visual content of the media of concert media object 722. Because the visual content 722A of the media of concert media object 722 is stereoscopic, texts 722D and 722H are overlaid on content 722A with a blur effect applied to content 722A to make text 722D and 722H more legible, as described in further detail with respect to FIGS. 7S and 7T.

In some embodiments, activation of a respective object of the set of scrollable objects causes the respective object to be displayed in a larger, more complete, and/or more immersive configuration, while continuing to show representations of physical objects of the physical environment. For example, at FIG. 7R, in response to computer system 700 having detected an input (e.g., a selection input) directed toward panorama media object 726 (e.g., having detected a gaze of the user directed to panorama media object 726 and detected an air pinch gesture) (e.g., at FIG. 7K), computer system 700 displays the user interface of FIG. 7R, which includes audio and visual content of the media of panorama media object 726 (and optionally does not include other objects of the set of scrollable objects). In this example, warp effect 736 is not applied to reduce or cease displaying representations 706A-706D of physical objects of the physical environment. As shown in FIG. 7R, text 726B and text 726C are displayed overlaid on the visual content of the media of panorama media object 726. Because the visual content 726A of the media of panorama media object 726 is stereoscopic in FIG. 7R, texts 726B and 726C are overlaid on content 726A with a blur effect applied to content 726A to make text 726B and 726C more legible, as described in further detail with respect to FIGS. 7S and 7T.

FIG. 7S shows a detailed view of text 722E and content 722A of FIG. 7M, as presented to a user in the extended reality environment by computer system 700. Content 722A is stereoscopic content. Characters (e.g., text, alphanumeric characters, and/or emojis) 722E1 are overlaid on content 722A. Characters 722E1 are placed in the extended reality environment at a location that is closer to a viewpoint of the user than content 722A. Because content 722A is stereoscopic, computer system 700 has applied a blur effect to content 722A at a location that corresponds to characters 722E1. The blur effect is placed in the extended reality environment at a location that is closer to the viewpoint of the user than content 722A and further from the viewpoint of the user than characters 722E1. Thus, from a viewpoint of the user, the blur effect is placed between characters 722E1 and content 722A. The blur effect (e.g., 722E2-722E4) is applied both behind characters 722E1 (e.g., such as at location 722E2) and extends beyond (e.g., further than, past, outside, and/or around) characters 722E1 (e.g., such as at locations 722E3 and 722E4). As shown in FIG. 7S, a shape of the blur effect (e.g., 722E2-722E4) is based on a shape (e.g., 722E5) of characters 722E1 and/or a size of the blur effect (e.g., 722E2-722E4) is based on a size of characters 722E1. In some embodiments, the shape and/or size of the blur effect is based on outline 722E5 of characters 722E1. In some embodiments, the size of the blur effect is larger than the outline 722E5 of characters 722E1.

In some embodiments (e.g., for the portions of the blur effect that fall outside of outline 722E5), an intensity of the blur effect (e.g., 722E2-722E4) reduces as the distance to characters 722E1 increases. For example, the intensity of the blur effect at outline 722E5 is stronger than the intensity of the blur effect at location 722E3 (e.g., because a distance from a location on 722E5 to characters 722E1 is less than a distance from location 722E3 to characters 722E1). For another example, the intensity of the blur effect at location 722E3 is stronger than the intensity of the blur at location 722E4 (e.g., because a distance from location 722E3 to characters 722E1 is less than a distance from location 722E4 to characters 722E1). A stronger intensity of the blur effect results in more blurring of content 722A.

In some embodiments, the intensity of the blur effect is based on varying blur radius and/or opacity of the blurring. In some examples, the intensity of the blur effect is based on a blur radius. For example, location 722E3 uses a larger blur radius (e.g., to achieve a more intense blur effect) as compared to location 722E4. In some examples, the intensity of blur effect is based on opacity. For example, location 722E3 uses a higher opacity for the blur effect (e.g., to achieve a more intense blur effect) as compared to location 722E4. In some embodiments, the blur effect, when viewed from the viewpoint of the user, provides a feathered blurring that blurs content 722A (e.g., as indicated with dotted lines) without blurring characters 722E1. As content 722A behind the blur effect changes (e.g., the video plays and/or the image shifts), computer system 700 updates the blur to reflect the new content behind the blur effect.

FIG. 7T shows a detailed view of text 722H and content 722A of FIG. 7Q, as presented to a user in the extended reality environment by computer system 700. Content 722A is stereoscopic content. Characters (e.g., text, alphanumeric characters, and/or emojis) 722H1 are overlaid on content 722A. Characters 722H1 are placed in the extended reality environment at a location that is closer to a viewpoint of the user than content 722A. Because content 722A is stereoscopic, computer system 700 has applied a blur effect to content 722A at a location that corresponds to characters 722H1. The blur effect is placed in the extended reality environment at a location that is closer to the viewpoint of the user than content 722A and further from the viewpoint of the user than characters 722H1. Thus, from a viewpoint of the user, the blur effect is placed between characters 722H1 and content 722A. The blur effect (e.g., 722H2-722H4) is applied both behind characters 722H1 (e.g., such as at location 722H2) and extends beyond (e.g., further than, past, outside, and/or around) characters 722H1 (e.g., such as at locations 722H3 and 722H4). As shown in FIG. 7T, a shape of the blur effect (e.g., 722H2-722H4) is based on a shape (e.g., 722H5) of characters 722H1 and/or a size of the blur effect (e.g., 722H2-722H4) is based on a size of characters 722H1. In some embodiments, the shape and/or size of the blur effect is based on outline 722H5 of characters 722H1. In some embodiments, the size of the blur effect is larger than the outline 722H5 of characters 722H1.

In some embodiments (e.g., for the portions of the blur effect that fall outside of outline 722H5), an intensity of the blur effect (e.g., 722H2-722H4) reduces as the distance to characters 722H1 increases. For example, the intensity of the blur effect at outline 722H5 is stronger than the intensity of the blur effect at location 722H3 (e.g., because a distance from a location on 722H5 to characters 722H1 is less than a distance from location 722H3 to characters 722H1). For another example, the intensity of the blur effect at location 722H3 is stronger than the intensity of the blur at location 722H4 (e.g., because a distance from location 722H3 to characters 722H1 is less than a distance from location 722H4 to characters 722H1). A stronger intensity of the blur effect results in more blurring of content 722A.

In some embodiments, the intensity of the blur effect is based on varying blur radius and/or opacity of the blurring. In some examples, the intensity of the blur effect is based on a blur radius. For example, location 722H3 uses a larger blur radius (to achieve a more intense blur effect) as compared to location 722H4. In some examples, the intensity of blur effect is based on opacity. For example, location 722H3 uses a higher opacity for the blur effect (to achieve a more intense blur effect) as compared to location 722H4. In some embodiments, the blur effect, when viewed from the viewpoint of the user, provides a feathered blurring that blurs content 722A (e.g., as indicated with dotted lines) without blurring characters 722H1. As content 722A behind the blur effect changes (e.g., the video plays and/or the image shifts), computer system 700 updates the blur to reflect the new content behind the blur effect.

FIG. 7U illustrates a high-level view of the set of scrollable objects (e.g., 720-732) within user interface 708. The media objects (e.g., 720-732) are scrollable within user interface 708. As the media objects scroll (e.g., left-to-right and/or right-to-left), a size of a respective media objects changes based on the location of respective media object. At FIG. 7U, as the distance of respective media objects from a central area of user interface 708 increases, the size of the respective media objects decreases and a visual prominence of the respective media object is reduced. For example, media object 732 is less visually prominent than media objects 724, 720, and 722 because media object 732 is more dimmed and/or more blurred. Similarly, media object 724 is less visually prominent than media objects 720 and 722 because media object 724 is more dimmed and/or more blurred.

At FIG. 7U, concert media object 722 is positioned at the central area of user interface 708. Scrolling the set of scrollable objects (e.g., 720-732) would cause concert media object 722 to get smaller as it moves away from the central location and to become visually less prominent. In some embodiments, computer system 700 makes a media object less visually prominent by pausing playback of content, dimming the content, and/or blurring the content. In contrast, when the set of scrollable objects are scrolled, the media objects that move toward the central area of user interface 708 increase in size and increase in visual prominence. For example, scrolling set of scrollable objects (e.g., 720-732) shown in FIG. 7U to the left would cause media objects 722, 726, 728, and 730 to get smaller and less visually prominent while media objects 720, 724, and 732 would get larger and more visually prominent. Similarly, scrolling set of scrollable objects (e.g., 720-732) shown in FIG. 7U to the right would cause media objects 726, 728, and 730 to get larger and more visually prominent while media objects 722, 720, 724, and 732 would get smaller and less visually prominent.

Additional descriptions regarding FIGS. 7A-7U are provided below in reference to methods 800 and 900 described with respect to FIGS. 8 and 9.

FIG. 8 is a flow diagram of an exemplary method 800 for applying a blur effect, in some embodiments. In some embodiments, method 800 is performed at a computer system (e.g., computer system 101 in FIG. 1A and/or computer system 700) (e.g., a smartphone, a smartwatch, a tablet computer, a desktop computer, a laptop computer, and/or a head-mounted device (e.g., a head-mounted augmented reality and/or extended reality device)) that is in communication with (e.g., includes and/or is connected to) one or more display generation components (e.g., 702) (e.g., a visual output device, a 3D display, a display having at least a portion that is transparent or translucent on which images can be projected (e.g., a see-through display), a display, a display controller, a monitor, a touch-sensitive display system, a display screen, a projector, a holographic display, and/or a head-mounted display system) and one or more input devices (e.g., a touch-sensitive surface, a keyboard, mouse, trackpad, one or more optical sensors for detecting gestures, and/or one or more capacitive sensors for detecting hover inputs). In some embodiments, method 800 is governed by instructions that are stored in a non-transitory (or transitory) computer-readable storage medium and that are executed by one or more processors of a computer system (e.g., 700), such as the one or more processors 202 of computer system 101 (e.g., control 110 in FIG. 1A). Some operations in method 800 are, optionally, combined and/or the order of some operations is, optionally, changed.

The computer system (e.g., 700) detects (802), via the one or more input devices, a request (e.g., 750B, 750C, 750D, and/or 750I) (e.g., a pinch-and-drag air gesture, a touch-and-drag touch input, a tap gesture, a swipe gesture, a touch gesture, an air gesture, a button press, and/or a voice command) to display text (e.g., 720B-720C. 722C-722D, 722E, and/or 722H) (e.g., alphabetical, numeric, and/or alphanumeric) associated with (e.g., corresponds to and/or part of) content (e.g., 720A and/or 722A) (e.g., content that is or is not being displayed when the request is received and/or content that is displayed concurrently with the text).

In response (804) to detecting the request (e.g., 750B, 750C, 750D, and/or 750I) to display text (e.g., 720B-720C, 722C-722D, 722E, and/or 722H) associated with content (e.g., 720A and/or 722A), the computer system (e.g., 700) displays (806), via the one or more display generation components (e.g., 702), text (e.g., 720B-720C, 722C-722D, 722E, and/or 722H) overlaid on the content (e.g., 720A and/or 722A).

In response (804) to detecting the request (e.g., 750B, 750C, 750D, and/or 750I) to display text (e.g., 720B-720C, 722C-722D, 722E, and/or 722H) associated with content (e.g., 720A and/or 722A), the computer system (e.g., 700) displays (808), via the one or more display generation components (e.g., 702), a portion of the content (e.g., 720A and/or 722A) near (e.g., next to, adjacent to, and/or at least partially surrounding the text, such as when viewed from a viewpoint of a user) the text (e.g., 720B-720C, 722C-722D, 722E, and/or 722H) with a blur effect (e.g., 722H2-722H4 and/or 722H2-722H4) (e.g., a feathered blur, a Gaussian blur, a radial blur, and/or a motion blur) that gradually reduces in intensity as distance from the text increases (e.g., the amount of blur of the blur effect is linearly or exponentially related to the distance from the text), wherein a shape of the blur effect is based on a shape of the text (e.g., as shown in FIGS. 7S and 7T). In some embodiments, the blur effect is based on one or more characteristics (e.g., size, shape, color, and/or brightness) of the text. In some embodiments, the blur effect ends a non-zero distance from the text and/or the blur effect based on the text is not displayed beyond the non-zero distance. Displaying text with a blur effect that gradually reduces in intensity as it gets further from the text when a request is detected enables the computer system to display legible text and to indicate to the user that the request was received, thereby providing improved visual feedback. Automatically adding a blur effect to text when a request to display text is detected also reduces the number of inputs required to display the effect. Displaying text with the blur effect over content with varying degrees of depth improves the legibility of the text and reduces and/or avoids visual discomfort that might be caused by displaying text adjacent to the content with varying degrees of depth, thereby improving the computer system and the man-machine interface.

In some embodiments, displaying (808) the portion of the content near the text with the blur effect includes: displaying, via the one or more display generation components (e.g., 702), a first portion of the content that is a first distance from the text with a first degree of blurring (e.g., blur at 722E5 and/or 722H5); displaying, via the one or more display generation components, a second portion of the content (e.g., different from the first portion of content) that is a second distance from the text with a second degree of blurring (e.g., blur at 722E3 and/or 722H3), where the second distance is greater than the first distance and the second degree of blurring is less than the first degree of blurring; and displaying, via the one or more display generation components, a third portion of the content (e.g., different from the first portion of content and the second portion of content) that is a third distance from the text with a third degree of blurring (e.g., blur at 722E4 and/or 722H4), where the third distance is greater than the second distance and the third degree of blurring is less than the second degree of blurring. In some embodiments, the first distance, second distance, and third distance are distances along a straight line. In some embodiments, the first distance, second distance, and third distance are distances that are not along a straight line. The blur effect reducing in intensity as distance from the text increases enables the computer system to provide more blurring near the text and less blurring away from the text, thereby improving the legibility of the text and indicating the location of the text.

In some embodiments, displaying the portion of the content near the text with the blur effect includes: displaying, via the one or more display generation components, a first portion of the content with blurring that gradually reduces in intensity as distance from the text increases (e.g., at a first rate) in a first direction (e.g., to the right of text 722E1 in FIG. 7S); and displaying, via the one or more display generation components, a second portion of the content (e.g., same as or different from the first portion of content) with blurring that gradually reduces in intensity as distance from the text increases (e.g., at a second rate that is the same as the first rate or is different from the first rate) in a second direction (e.g., below text 722E1 in FIG. 7S) that is different from the first direction. The blur effect reducing in intensity in multiple directions as distance from the text increases enables the computer system to provide more blurring near the text and less blurring away from the text, thereby improving the legibility of the text and indicating the location of the text.

In some embodiments, displaying the blur effect with the shape that is based on the shape of the text includes: in accordance with a determination that the text has a first shape (e.g., 722E5 at FIG. 7S), displaying the blur effect with a first respective shape that is based on (e.g., the same as and/or derived from) the first shape (e.g., based on the first shape and not based on the second shape); and in accordance with a determination that the text has a second shape (e.g., 722H5 at FIG. 7T) that is different from the first shape, displaying the blur effect with a second respective shape that is based on (e.g., the same as and/or derived from) the second shape (e.g., based on the second shape and not based on the first shape). The shape of the blur effect being based on the shape of the text enables the computer system to provide blurring near the text and avoid unnecessarily blurring content that is not near the text, thereby improving the legibility of the text and indicating the location of the text while limiting the blurring of the content behind the text.

In some embodiments, the shape of the text is a shape of an outline (e.g., 722E5 and/or 722H5) of a line that surrounds at least a portion of the text. The shape of the blur effect being based on the outline of the text enables the computer system to provide blurring near the text and avoid unnecessarily blurring content that is not near the text, thereby improving the legibility of the text and indicating the location of the text while limiting the blurring of the content behind the text.

In some embodiments, displaying the blur effect with the shape that is based on the shape of the text includes: in accordance with a determination that the text has a first size (e.g., text 722E1 at FIG. 7T), displaying the blur effect with a first respective size that is based on (e.g., 20% bigger, 40% bigger, or 20% smaller than) the first size (e.g., based on the first size and not based on the second size); and in accordance with a determination that the text has a second size (e.g., text 722H1 at FIG. 7T) that is different from the first size, displaying the blur effect with a second respective size that is based on (e.g., 20% bigger, 40% bigger, or 20% smaller than) the second size (e.g., based on the second size and not based on the first size). The size of the blur effect being based on the size of the text enables the computer system to provide blurring near the text and avoid unnecessarily blurring content that is not near the text, thereby improving the legibility of the text and indicating the location of the text while limiting the blurring of the content behind the text.

In some embodiments, displaying the blur effect gradually reducing in intensity as distance from the text increases includes: displaying the blur effect with a first blur radius (e.g., 3 pixels, 8 pixels, or 1 mm) at a first location (e.g., at 722E2 at FIG. 7S) that is a first distance from the text; and displaying the blur effect with a second blur radius (e.g., 5 pixels, 7 pixels, or 2 mm) at a second location (e.g., at 722E3 at FIG. 7S) that is a second distance from the text, wherein the second distance is different from (e.g., greater than or less than) the first distance and the second blur radius is less than the first blur radius. Using a blur radius as part of the blur effect enables the computer system to provide different amounts of blurring at different distances from the text, thereby improving the legibility of the text and indicating the location of the text while limiting the blurring of the content behind the text.

In some embodiments, displaying the blur effect gradually reducing in intensity as distance from the text increases includes: displaying the blur effect with a first opacity at a first location (e.g., at 722E2 at FIG. 7S) that is a first distance from the text; and displaying the blur effect with a second opacity at a second location (e.g., at 722E3 at FIG. 7S) that is a second distance from the text, wherein the second distance is different from (e.g., greater than or less than) the first distance and the second opacity is less than the first opacity. In some embodiments, an opacity of the blur effect gradually reduces as distance from the text increases. In some embodiments, the difference in the blur effect at different locations (e.g., the first location and/or the second location) is optionally based on both a level of opacity of the blur effect and a blur radius of the blur effect at the different locations. Changing the opacity of the blur effect based on distances from the text enables the computer system to provide blurring near the text and avoid unnecessarily blurring content that is not near the text, thereby improving the legibility of the text and indicating the location of the text while limiting the blurring of the content behind the text. Reducing the blurring by using opacity also reduces the computer resources required to apply the blur effect, as opposed to some other blur feather techniques.

In some embodiments, the text (e.g., 720B-720C, 722C-722D, 722E, and/or 722H) and the content (e.g., 720A and/or 722A) are displayed in a three-dimensional environment (e.g., a virtual or mixed reality environment); and the text (e.g., 720B-720C, 722C-722D, 722E, and/or 722H) is displayed closer to a viewpoint of a user of the computer system (e.g., 700) than the content (e.g., 720A and/or 722A) (e.g., the text is displayed at a location that is in front of a location of the content). In some embodiments, the text occludes at least a portion of the content from the viewpoint of the user. Displaying text with a blur effect when the text displayed closer to the viewpoint of the user than the content enables the computer system to display legible text and to indicate to the user that the request was received, thereby providing improved visual feedback. Automatically adding a blur effect to text when the text is in front of content and when a request to display text is detected also reduces the number of inputs required to display the effect.

In some embodiments, the computer system detects, via the one or more input devices, a second request (e.g., 750B and/or 750E) (e.g., a pinch-and-drag air gesture, a touch-and-drag touch input, a tap gesture, a swipe gesture, a touch gesture, an air gesture, a button press, and/or a voice command) to display second text (e.g., 720B and/or 726B) (e.g., alphabetical, numeric, and/or alphanumeric) associated with (e.g., corresponds to and/or part of) second content (e.g., 720A and/or 726A) (e.g., same as or different from the content, content that is or is not being displayed when the second request is received, and/or content that is displayed concurrently with the second text). In response to detecting the second request (e.g., 750B and/or 750E) to display second text (e.g., 720B and/or 726B) associated with the second content (e.g., 720A and/or 726A): the computer system (e.g., 700) displays, via the one or more display generation components (e.g., 702), second text (e.g., 720B and/or 726B) overlaid on the second content (e.g., 720A and/or 726A). In response to detecting the second request (e.g., 750B and/or 750E) to display second text (e.g., 720B and/or 726B) associated with the second content (e.g., 720A and/or 726A): in accordance with a determination that a set of one or more criteria is met, the computer system (e.g., 700) displays, via the one or more display generation components (e.g., 702), a portion of the second content near (e.g., next to, adjacent to, and/or at least partially surrounding the text, such as when viewed from a viewpoint of a user) the text (e.g., content near text 720B) with a second blur effect (e.g., a feathered blur, a Gaussian blur, a radial blur, and/or a motion blur) that gradually reduces in intensity as distance from the second text increases (e.g., the amount of blur of the second blur effect is linearly or exponentially related to the distance from the second text), wherein a shape of the second blur effect is based on a shape of the second text. In some embodiments, the second blur effect is the same as the blur effect. In some embodiments, the second blur effect is different from the blur effect. In some embodiments, the second blur effect is based on one or more characteristics (e.g., size, shape, color, and/or brightness) of the second text. In some embodiments, the second blur effect ends a non-zero distance from the second text and/or the second blur effect based on the second text is not displayed beyond the non-zero distance. In response to detecting the second request (e.g., 750B and/or 750E) to display second text (e.g., 720B and/or 726B) associated with the second content (e.g., 720A and/or 726A): in accordance with a determination that the set of one or more criteria are not met, forgoing display, via the one or more display generation components (e.g., 702), of the portion of the second content near the second text (e.g., content near text 726B) with the second blur effect (e.g., the portion of the second content is displayed, but without any blur effect). In some embodiments, the blur effect overlaid on the portion of the content near the text is also conditionally applied (e.g., based on the set of one or more criteria and/or based on a different set of one or more criteria), similar to the second blur effect. In some embodiments, the computer system receives the request and, in response: displays the text and, in accordance with a determination that a set of one or more criteria is met (e.g., a determination that the content is stereoscopic content) the blur effect is applied to a portion of the content near the text and in accordance with a determination that the set of one or more criteria is not met (e.g., a determination that the content does not have regions with different depths, is non-stereoscopic content, is a platter, a flat image or video, and/or a monoscopic image or video) the blur effect is not applied to the content near the text. Conditionally displaying the blur effect for text when a request is detected enables the computer system to automatically display legible text, using the blur effect as needed, and to indicate to the user that the request was received, thereby providing improved visual feedback. Automatically conditionally adding a blur effect to text when a request to display text is detected also reduces the number of inputs required to display the effect and performs an operation when a set of conditions is met without requiring further input.

In some embodiments, the set of one or more criteria includes a depth criterion that is met when the second content (e.g., 720A) is displayed using stereoscopic depth (e.g., by displaying two different images, one for each eye of a user, that simulate three-dimensional placement of the second content in a three-dimensional environment). In some embodiments, the set of one or more criteria is not met when the depth criterion is not met (e.g., when the second content is not displayed using stereoscopic depth). Displaying text with a blur effect when content behind the text is displayed using stereoscopic depth enables the computer system to display legible text in a three-dimensional environment, thereby providing improved visual feedback. Automatically adding a blur effect to text when content behind the text is displaying using stereoscopic depth also reduces the number of inputs required to display the effect.

In some embodiments, while the computer system (e.g., 700) is operating in a first stereoscopic mode (e.g., a mode in which the second content and/or the second text are displayed with respective stereoscopic depths) that meets the depth criterion (e.g., as in FIG. 7R), the computer system (e.g., 700) detects, via the one or more input devices, a request (e.g., an input to transition from the UI of FIG. 7R to the UI of FIG. 7I) to change a stereoscopic display mode of the second content (e.g., 726A); and in response to detecting the request to change the stereoscopic display mode of the second content (e.g., 726A), the computer system (e.g., 700) displays, via the one or mode display generation components (e.g., 702), the second content (e.g., 726A) in a manner that does not meet the depth criterion (e.g., as in FIG. 7I) (e.g., displaying the second content in a mode in which the second content and/or the second text are not displayed with respective stereoscopic depths). Transitioning between displaying text with and without the blur effect based on whether content behind the text is displayed using stereoscopic depth enables the computer system to display legible text in both stereoscopic display modes while limiting the amount of blur effect applied and indicates to the user whether the content is displayed with stereoscopic depth, thereby providing improved visual feedback. Automatically adding a blur effect to text when content behind the text is displaying using stereoscopic depth also reduces the number of inputs required to display the effect.

In some embodiments, the set of one or more criteria includes a background criterion that is met when the second text is not displayed in conjunction with (e.g., together with and/or in combination with) a background (e.g., a platter, such as for text 720D in FIG. 7B) (e.g., the second text is displayed in front of a background (or platter), the second text is displayed overlaid on an object that occludes (from a viewpoint of a user) the content near the second text, and/or the second text is surrounded by an object that occludes the content near the second test). In some embodiments, the background criterion is not met (and therefore the set of one or more criteria are not met) when the second text is displayed in front of a background. Displaying text with a blur when there is no background behind the text enables the computer system to display legible text, thereby providing improved visual feedback. Automatically adding a blur effect to text when there is no background being the text also reduces the number of inputs required to display the effect.

In some embodiments, the request to display text associated with content is a request to expand (e.g., enlarge and/or display more of) the content (e.g., transition from FIG. 7I to FIG. 7R). In some embodiments, the second request to display the second text associated with the second content is a request to expand the second content. Displaying text with a blur effect when a request to expand the content is detected enables the computer system to display legible text and to indicate to the user that the request was received, thereby providing improved visual feedback. Automatically adding a blur effect to text when a request to expand content is detected also reduces the number of inputs required to display the effect.

In some embodiments, the request to display text associated with content is a request (e.g., input 750D) to display information (e.g., 722E) about content (e.g., 722A) that is being displayed when the request is detected (e.g., the content is already visible when the computer system detects the request to display text associated with the content). In some embodiments, the second request to display second text associated with the second content is a request to display information about the second content that is already being displayed when the second request is detected. Displaying text with a blur effect when a request to display information about already displayed content is detected enables the computer system to display legible text and to indicate to the user that the request was received, thereby providing improved visual feedback. Automatically adding a blur effect to text when a request to display information about content is detected also reduces the number of inputs required to display the effect.

In some embodiments, the request (e.g., 750F) to display text associated with content includes a request to navigate through content (e.g., scrolling through the content, navigating through a set of content items that includes the content, and/or transitioning between pages or sections of the content). In some embodiments, the second request to display second text associated with the second content includes a request to navigate through the second content. Displaying text with a blur effect when a request to navigate through content is detected enables the computer system to display legible text and to indicate to the user that the request was received, thereby providing improved visual feedback. Automatically adding a blur effect to text when a request to navigate through content is detected also reduces the number of inputs required to display the effect.

In some embodiments, aspects/operations of methods 800, 900, and/or 1100 may be interchanged, substituted, and/or added between these methods. For brevity, these details are not repeated here.

FIG. 9 is a flow diagram of an exemplary method 900 for managing audio output, in some embodiments. In some embodiments, method 900 is performed at a computer system (e.g., 700 and/or computer system 101 in FIG. 1A) (e.g., a smartphone, a smartwatch, a tablet computer, a desktop computer, a laptop computer, and/or a head-mounted device (e.g., a head-mounted augmented reality and/or extended reality device)) that is in communication with (e.g., includes and/or is connected to) one or more display generation components (e.g., 702) (e.g., a visual output device, a 3D display, a display having at least a portion that is transparent or translucent on which images can be projected (e.g., a see-through display), a display, a display controller, a monitor, a touch-sensitive display system, a display screen, a projector, a holographic display, and/or a head-mounted display system), one or more input devices (e.g., a touch-sensitive surface, a keyboard, mouse, trackpad, one or more optical sensors for detecting gestures, and/or one or more capacitive sensors for detecting hover inputs), and one or more audio output devices (e.g., one or more speakers, one or more hardware audio drivers, one or more earphones, and/or one or more headsets). In some embodiments, method 900 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 900 are, optionally, combined and/or the order of some operations is, optionally, changed.

The computer system (e.g., 700) concurrently displays (902), via the one or more display generation components (e.g., 702), a first user interface object (e.g., 720 at FIG. 7B and/or 722 at FIG. 7H) in a user interface (e.g., 708) and outputting, via the one or more audio output devices, first audio (e.g., 710A and/or 710B) that corresponds to the first user interface object (e.g., outputting the first audio while displaying the first user interface object and/or displaying the first user interface object while outputting the first audio).

While concurrently displaying the first user interface object (e.g., 720 and/or 722) in the user interface (e.g., 708) and outputting the first audio (e.g., 710A and/or 710B), the computer system (e.g., 700) detects (904), via the one or more input devices, a request (e.g., 750C at FIG. 7B and/or 750E at FIG. 7H) (e.g., a pinch-and-drag air gesture, a touch-and-drag touch input, a tap gesture, a swipe gesture, a touch gesture, an air gesture, a button press, and/or a voice command) to move (e.g., translate, scroll, and/or reposition) the first user interface object (e.g., 720 and/or 722).

In response (906) to detecting the request (e.g., 750C at FIG. 7B and/or 750E at FIG. 7H) to move the first user interface object (e.g., 720 and/or 722), the computer system (e.g., 700) moves (908) the first user interface object (e.g., 720 in FIG. 7C and/or 722 in FIG. 7I) in accordance with the request (e.g., from the first location of the user interface to a second location of the user interface that is different from the first location).

In response (906) to detecting the request (e.g., 750C at FIG. 7B and/or 750E at FIG. 7H) to move the first user interface object (e.g., 720 and/or 722) and in accordance with a determination that a first set of one or more criteria (e.g., a set of one or more audio ducking criteria, a set of one or more audio modification criteria, and/or a set of one or more movement criteria) is met, the computer system (e.g., 700) reduces (910) a prominence of the first audio (e.g., reducing volume of audio 710A at FIG. 7E and/or reducing volume of audio 710B at FIG. 7I) while continuing to display the first user interface object (e.g., 720 at FIG. 7D and/or 722 at FIG. 7I) in the user interface (e.g., 708). In some embodiments, in response to detecting the request to move the first user interface object and in accordance with a determination that the first set of one or more criteria is not met, continuing to display the first user interface object in the user interface without reducing a prominence of the first audio. Conditionally reducing the prominence of first audio associated with a first user interface object when a request to move the first user interface object is detected and a first set of one or more criteria is met provides the user with feedback that the request was received, and that the first user interface object is moving. Reducing the prominence of the first audio also reduces energy consumption and reduces the degree to which audio associated with other user interface objects overlap, thereby improving the man-machine interface.

In some embodiments, reducing the prominence of the first audio includes reducing a volume (e.g., reducing volume of audio 710A at FIG. 7E and/or reducing volume of audio 710B at FIG. 7I) of the first audio (e.g., pausing the first audio, stopping the first audio, and/or decreasing a volume of the first audio while continuing to play the first audio). Conditionally reducing a volume of first audio associated with a first user interface object when a request to move the first user interface object is detected and a first set of one or more criteria is met provides the user with feedback that the request was received, and that the first user interface object is moving.

In some embodiments, the first set of one or more criteria includes a position criterion that is based on a position of the first user interface object (e.g., 720 and/or 722) within a set of scrollable objects. In some embodiments, the position criterion is met when the first user interface object is part of the set of scrollable objects and as objects of the set of scrollable objects are scrolled, the first user interface object reaches a movement threshold (e.g., reaches a display location within a display area and/or reaches a display position within the set of scrollable objects) and is not met when the object does not reach the movement threshold. Conditionally reducing the prominence of first audio associated with a first user interface object when a request to move the first user interface object is detected and a first set of one or more criteria (based on a position) is met provides the user with feedback that the request was received, and that the first user interface object is moving.

In some embodiments, the first set of one or more criteria includes a size criterion that is based on a size of the first user interface object (e.g., 720 and/or 722) and wherein the size of the first user interface object (e.g., 720 and/or 722) automatically changes as the first user interface object (e.g., 722) moves (e.g., as in FIGS. 7H-7I). In some embodiments, the first user interface object is part of the set of scrollable objects and the computer system designates a display area for displaying objects of the set of scrollable objects, and when a respective object exceeds an edge of the display area (e.g., at least partially moves past an edge of an area designated for displaying objects of the set of scrollable objects (of which the respective object is a part of), at least partially ceases to be displayed based on moving past a limit (e.g., an edge of an application window), and/or partially moves out of view from a viewpoint of a user), the size of the respective object changes (e.g., a portion of the respective object is no longer displayed and therefore the displayed size of the respective object is reduced). In some embodiments, a size of a respective user interface object changes as the respective user interface object is scrolled (e.g., gets smaller after it scrolls past an intermediate point and continues getting smaller as it gets further from the intermediate point). Conditionally reducing the prominence of first audio associated with a first user interface object when a request to move the first user interface object is detected and a first set of one or more criteria (based on a size) is met provides the user with feedback that the request was received, and that the first user interface object is moving.

In some embodiments, a set of scrollable objects includes the first user interface object (e.g., 722). In some embodiments, in response to detecting the request to move the first user interface object, the computer system (e.g., 700) changes (e.g., over time and/or in coordination with movement of the first user interface object) a size of the first user interface object relative to a size of one or more other objects of the set of scrollable objects (e.g., as in FIGS. 7H-7I). In some embodiments, the first user interface object gets smaller while one or more other user interface objects in the same set of scrollable objects maintain their size and/or get larger. In some embodiments, the first user interface object gets smaller faster than one or more other user interface objects in the same set of scrollable objects. In some embodiments, one or more other user interface objects get larger faster than the first user interface object (e.g., the first user interface object does not change in size, gets smaller, and/or gets larger slower than the one or more other user interface objects). Changing the size of the first user interface object when a request to move the first user interface object is detected provides the user with feedback that the request was received, and that the first user interface object is moving.

In some embodiments, the first set of one or more criteria includes a speed criterion that is based on a speed of movement of the first user interface object (e.g., 722). In some embodiments, the speed of movement of the first user interface object is based on the request to move the first user interface object. In some embodiments, the request to move the first user interface object includes movement input (e.g., a swipe and/or a drag input) and the speed of movement of the first user interface object is based on the speed of the movement input. Conditionally reducing the prominence of first audio associated with a first user interface object when a request to move the first user interface object is detected and a first set of one or more criteria (based on speed) is met provides the user with feedback that the request was received, and that the first user interface object is moving.

In some embodiments, the first set of one or more criteria includes a set of one or more gaze criteria that is based on whether a gaze (e.g., 750A at FIGS. 7C-7E) of a user is directed to the first user interface object (e.g., 720). In some embodiments, the set of gaze criteria includes a criterion that is met when a gaze of the user is not directed to the first user interface object (e.g., is directed to a different user interface object) for more than a threshold duration of time. In some embodiments, when a gaze of the user is directed to the first user interface object, the first set of one or more criteria is not met and the computer system does not reduce a prominence of the first audio. In some embodiments, when a gaze of the user is directed to a user interface object that is different from the first user interface object (e.g., for at least a threshold amount of time), the first set of one or more criteria is met and the computer system reduces a prominence of the first audio. Conditionally reducing the prominence of first audio associated with a first user interface object when a request to move the first user interface object is detected and a first set of one or more criteria (based on gaze) is met provides the user with feedback that the request was received, and that the first user interface object is moving.

In some embodiments, the first set of one or more criteria includes a duration criterion that is met when a gaze (e.g., 750A) of the user of the computer system (e.g., 700) is directed away (e.g., as in FIGS. 7D and 7E) from the first user interface object (e.g., 720) for a threshold duration of time (e.g., a non-zero duration of time, 0.05, 0.1, 0.3, 0.5, and/or 0.8 seconds). In some embodiments, the duration criterion is met when a gaze of a user of the computer system is not directed to the first user interface object for more than a threshold duration of time. In some embodiments, the threshold duration of time is a non-zero duration. In some embodiments, when a gaze of the user is directed to the first user interface object or has moved off of the first user interface object for less than the threshold amount of time, the first set of one or more criteria is not met and the computer system does not reduce the prominence of the first audio (e.g., the user is looking at the first user interface object and the computer system outputs the audio of the first user interface object). In some embodiments, when a gaze of the user is directed to a user interface object that is different from the first user interface object for at least the threshold amount of time, the first set of one or more criteria is met and the computer system reduces a prominence of the first audio (e.g., the user looks away from the first user interface object and the computer system pauses the audio of the first user interface object). Thus, in some embodiments, the computer system reduces the prominence of the first audio when the user of the computer system looks away from the first user interface object for more than a threshold amount of time. Conditionally reducing the prominence of first audio associated with a first user interface object when a request to move the first user interface object is detected and a first set of one or more criteria (based on gaze duration) is met provides the user with feedback that the request was received, and that the first user interface object is moving.

In some embodiments, the user interface is a user interface of an application. In some embodiments, while outputting, via the one or more audio output devices, the first audio (e.g., 710B) that corresponds to the first user interface object (e.g., 722), the computer system (e.g., 700) detects that a gaze (e.g., 750A at FIG. 7G) of the user is not directed to interfaces of the application (e.g., the computer system detects that the user has changed their gaze from being directed to the application to not being directed to the application and/or the computer system detects that the gaze of the user is directed to a location that is different from any user interface of the application). While the gaze (e.g., 750A at FIG. 7G) of the user is not directed to interfaces of the application, the computer system (e.g., 700) continues to output, via the one or more audio output devices, the first audio (e.g., 710B at FIG. 7G) that corresponds to the first user interface object (e.g., 722). In some embodiments, the computer system detects that a gaze of the user is not directed to the one or more user interfaces of the application (e.g., detects that the user has changed their gaze from being directed to one or more user interfaces of the application and/or detects that the gaze of the user is directed to a location that is different from the one or more user interfaces of the application) and the computer system continues to output the first audio (e.g., with or without reducing a prominence of the first audio). In some embodiments, the computer system detects that a gaze of the user is directed to a second user interface object of the user interface (e.g., detects that the user has changed their gaze from the being directed to the first user interface object to the second user interface object of the user interface of the application and/or detects that the gaze of the user is directed to the second user interface object) and, in response, the computer system reduces a prominence of the first audio. Continuing to play the first audio when the computer system detects that the gaze of the user has moved off of the application (with the user interface and the first user interface object) enables the computer system to continue providing the first audio to the user when the user is no longer viewing the application, thereby allowing the computer system to avoiding unnecessarily interrupt the first audio.

In some embodiments, while outputting, via the one or more audio output devices, the first audio (e.g., 710B) that corresponds to the first user interface object (e.g., 722), the computer system (e.g., 700) detects that a gaze (e.g., 750A) of the user is directed to a respective user interface object (e.g., 734 at FIG. 7G) that is different from the first user interface object (e.g., 722) (e.g., the computer system detects that the user has changed their gaze from being directed to the first user interface object to being directed to the respective user interface object and/or the computer system detects that the gaze of the user is directed to the respective user interface object). In response to detecting that the gaze (e.g., 750A) of the user is directed to the respective user interface object (e.g., 734 at FIG. 7G) that is different from the first user interface object and in accordance with a determination that the respective user interface object (e.g., 734) does not correspond to respective audio (e.g., no audio is associated with the respective user interface object), the computer system (e.g., 700) continues to output, via the one or more audio output devices, the first audio (e.g., 710B at FIG. 7G) (e.g., with or without reducing a prominence of the first audio). In some embodiments, the respective user interface object is an object of the same application as the first user interface object. In some embodiments, the respective user interface object is an object of an application that is different from the application of the first user interface object. In some embodiments, the set of gaze criteria includes an audio criterion that is met when a gaze of the user is directed to a second user interface object that is not associated with (e.g., the second user interface object does not correspond to audio, there is no audio associated with the second user interface object, and/or the second user interface object does not have audio) respective audio (e.g., a gaze of the user moves from the first user interface object to the second user interface object). In some embodiments, the first user interface object and the second user interface object are user interface objects of the same application. In some embodiments, the first user interface object and the second user interface object are user interface objects of different applications. Continuing to play the first audio when the computer system detects that the gaze of the user has moved off of the first user interface object and onto a user interface object that does not correspond to audio enables the computer system to continue providing the first audio to the user when the user is no longer looking at the first user interface object, thereby allowing the computer system to avoiding unnecessarily interrupt the first audio.

In some embodiments, the computer system (e.g., 700) detects that a gaze (e.g., 750A) of a user of the computer system (e.g., 700) is not directed to (e.g., has moved away from being directed to and/or is directed to something different from) a set of one or more control objects (e.g., 722F at FIGS. 7M and/or 7O) (e.g., a set of one, two, or three controls objects) (e.g., user-selectable objects that, when activated, cause the computer system to perform a respective operation) that are associated with (e.g., that control playback, volume, and/or sharing of) the first user interface object (e.g., 722). In response to detecting that the gaze (e.g., 750A) of the user of the computer system is not directed to the set of one or more control objects (e.g., 722F at FIGS. 7M and/or 7O), the computer system (e.g., 700) reduces a prominence (e.g., decreasing opacity, unbolding, and/or reducing in size) of the one or more control objects (e.g., 722F). In some embodiments, reducing the prominence of the one or more control objects includes reducing the opacity of the one or more control objects (e.g., to 30%, 20%, or 10% opacity). In some embodiments, reducing a prominence of the one or more control objects includes decreasing a brightness and/or size of the one or more control objects.

In some embodiments, the computer system (e.g., 700) detects that a gaze (e.g., 750A at FIG. 7N) of a user of the computer system (e.g., 700) is directed to a set of one or more control objects (e.g., 722F at FIG. 7N) (e.g., a set of one, two, or three controls objects) (e.g., user-selectable objects that, when activated, cause the computer system to perform a respective operation) that are associated with (e.g., that control playback, that control volume, that share information about, that correspond to, that control, and/or that are part of) the first user interface object (e.g., 722). In response to detecting that the gaze (e.g., 750A) of the user of the computer system (e.g., 700) is directed to the set of one or more control objects (e.g., 722F at FIG. 7N), the computer system (e.g., 700) increases a prominence (e.g., increasing opacity, bolding, and/or enlarging) of the one or more control objects (e.g., 722F at FIG. 7N). In some embodiments, increasing the prominence of the one or more control objects includes increasing the opacity of the one or more control objects (e.g., to 80%, 90%, or 100% opacity). In some embodiments, increasing a prominence of the one or more control objects includes increasing a brightness and/or size of the one or more control objects. Changing the prominence of controls associated with the first user interface object based on the user gazing at or away from the controls and/or the first user interface object enables the computer system to provide the user with feedback about the direction of the user's gaze and to provide controls that are relevant to the object that the user is gazing at, thereby providing an improved man-machine interface.

In some embodiments, while displaying the first user interface object (e.g., 722 in FIGS. 7L-7M) in the user interface (e.g., 708) (and, optionally, while outputting the first audio with a reduced prominence or not outputting the first audio as described above with reference to FIG. 7L), the computer system (e.g., 700) detects, via the one or more input devices, a second request (e.g., 750F) (e.g., a pinch-and-drag air gesture, a touch-and-drag touch input, a tap gesture, a swipe gesture, a touch gesture, an air gesture, a button press, and/or a voice command) to move (e.g., translate, scroll, and/or reposition) the first user interface object (e.g., 722). In response to detecting the second request (e.g., 750F) to move the first user interface object (e.g., 722): the computer system (e.g., 700) moves the first user interface object (e.g., 722 at FIGS. 7L-7M) in accordance with the second request (e.g., from the second location of the user interface to the first location of the user interface that is different from the second location or to a third location of the user interface that is different from the first location and the second location); and in accordance with a determination that a second set of one or more criteria (e.g., a set of one or more audio play criteria, a set of one or more audio output criteria, and/or a second set of one or more movement criteria) is met, the computer system (e.g., 700) increases a prominence of the first audio (e.g., 710B at FIG. 7M) while continuing to display the first user interface object (e.g., 722 at FIG. 7M) in the user interface (e.g., 708). In some embodiments, increasing the prominence of the first audio includes outputting (e.g., resuming or starting) the first audio and/or increasing a volume of the first audio. In some embodiments, the second set of one or more criteria includes a location criterion that is met when the first user interface object moves back to a central region (e.g., of the user interface and/or of a display). In some embodiments, the second set of one or more criteria includes a size criterion that is met when the first user interface object increases in size to above a threshold size. In some embodiments, the second set of one or more criteria includes a low-speed criterion that is met when a speed of the first user interface object reduces to below a threshold speed. Conditionally increasing a prominence of the first audio based on the second request provides the user with feedback that the second request was received and allows the first audio to be output more prominently, thereby improving the man-machine interface.

In some embodiments, the first set of one or more criteria includes a first threshold of a first type (e.g., a speed threshold, a duration threshold, and/or a location threshold) (e.g., in relation to 722 and/or 710B at FIG. 7G), the second set of one or more criteria includes a second threshold of the first type (e.g., a speed threshold, a duration threshold, and/or a location threshold) (e.g., in relation to 722 and/or 710B at FIG. 7M), and the first threshold is different from (e.g., is more than or is less than) the second threshold. In some embodiments, the computer system uses different values for thresholds for reducing the prominence of the first audio as compared to the values for thresholds for increasing the prominence of the first audio. Including different thresholds for the same criteria for reducing the prominence of the first audio and increasing the prominence of the first audio provides the user with audio feedback about what conditions have been met, thereby providing improved feedback.

In some embodiments, reducing the prominence of the first audio includes gradually changing a prominence of the first audio over time (e.g., over a 1 second duration, a 1.5 second duration, a 2 second duration, or a 5 second duration) (e.g., as in FIGS. 7E and/or 7M). Changing the prominence of the first audio over time enables the computer system to provide the user with feedback that the audio is changing and optionally give the user an opportunity to provide input to revert the change.

In some embodiments, the user interface includes a plurality of user interface objects (e.g., 720-732), including the first user interface object (e.g., 720 and/or 722) and a second user interface object (e.g., 722 and/or 720) that is different from the first user interface object; the first user interface object corresponds to the first audio (e.g., 710A and/or 710B) and the second user interface object corresponds to second audio (e.g., 710B and/or 710A) that is different from the first audio; and the computer system (e.g., 700) outputs, via the one or more audio output devices, one primary audio from among audio corresponding to the user interface objects of the plurality of user interface objects. In some embodiments, the computer system outputs, via the one or more audio output devices, audio that corresponds to a respective user interface object, including: in accordance with a determination that audio corresponding to a first respective user interface object meets a priority criteria and audio corresponding to a second respective user interface object does not meet the priority criteria, outputting audio corresponding to the first respective user interface object (e.g., without outputting audio corresponding to the second respective user interface object); and in accordance with a determination that audio corresponding to the second respective user interface object meets the priority criteria and audio corresponding to the first respective user interface object does not meet the priority criteria, outputting audio corresponding to the second respective user interface object (e.g., without outputting audio corresponding to the first respective user interface object). In some embodiments, the priority criteria is based on a location, speed, and/or position of the respective user interface object. In some embodiments, the priority is based on a type of audio corresponding to the respective user interface object. Having only a single primary audio source when multiple objects are each associated with respective audio enables the computer system to output audio to the user that is more easily discernable than mixing multiple audio at the same volume.

In some embodiments, the computer system (e.g., 700) transitions the primary audio from the first audio to the second audio by crossfading the first audio and the second audio, including concurrently (e.g., as described with respect to FIGS. 7E and/or 7M): reducing a volume of the first audio (e.g., by reducing a prominence of the first audio) and increasing a volume of the second audio (e.g., by increasing a prominence of the second audio). In some embodiments, the computer system crossfades between different audio of the user interface objects to change the primary audio. Crossfading the first audio and the second audio when transitioning between the two different audio provides the user with feedback that the first audio is being reduced in prominence and that the second audio is being increased in prominence, thereby providing the user with improved feedback.

In some embodiments, the first user interface object (e.g., 722) includes a first video (e.g., 722A) and the first video (e.g., 722A) is playing when the computer system detects the request (e.g., 750E) to move the first user interface object. In some embodiments, in response to detecting the request (e.g., 750E) to move the first user interface object (e.g., 722) and in accordance with a determination that a third set of one or more criteria (e.g., a set of one or more video criteria, a set of one or more video modification criteria, and/or a third set of one or more movement criteria) is met, the computer system (e.g., 700) reduces a prominence of the first video (e.g., 722A at FIG. 7J) while continuing to display the first user interface object (e.g., 722) (and, optionally, the first video) in the user interface. In some embodiments, reducing the prominence of the first video includes pausing the first video, fading the first video, and/or reducing a brightness of the first video. Reducing a prominence of the first video when the third set of one or more criteria is met provides the user with visual feedback that the request was detected and that the set of one or more criteria is met, thereby providing improved visual feedback.

In some embodiments, the first set of one or more criteria is different from the third set of one or more criteria. In some embodiments, the first set of one or more criteria includes a first threshold of a first type (e.g., a speed threshold, a duration threshold, and/or a location threshold) and the third set of one or more criteria includes a second threshold of the first type (e.g., a speed threshold, a duration threshold, and/or a location threshold) that is different from (e.g., is more than or is less than) the first threshold. In some embodiments, the computer system uses different values for thresholds for reducing the prominence of the first audio as compared to the values for thresholds for reducing the prominence of the first video. In some embodiments, when more than a first amount (e.g., 40% or 60%) of the first video moves out of the display area, the first audio reduces in prominence (e.g., but the video continues to play) and when more than a second amount (e.g., 25% or 75%) of the first video moves out of the display area, the first video reduces in prominence. In some embodiments, when a size of the first video has been reduced by a first amount (e.g., by 35%, by 40%, or by 45%) (e.g., as compared to a size of the first video when the first video is displayed at a central location in a display area) as the first video moves, the first audio reduces in prominence (e.g., but the video continues to play) and when the first video has been reduced by a second amount (e.g., by 70%, by 75%, or by 80%) (e.g., as compared to a size of the first video when the first video is displayed at a central location in a display area) as the first video moves, the video reduces in prominence. Reducing the prominence of the audio and the video when different amounts of the first user interface object move out of the display area and/or when a size of the first user interface object is reduced by different amounts provides the user with feedback about how much of the first user interface has moved out of the display area and/or by how much the size of the first user interface object has been reduced, thereby providing improved visual feedback.

In some embodiments, the third set of one or more criteria includes a content-based criterion that is met when the computer system displays a respective type of content (e.g., 722G) that corresponds to the user interface (e.g., 722); and reducing a prominence of the first video (e.g., 722A) includes pausing the first video (e.g., 722A as in FIG. 7O). In some embodiments, the third set of one or more criteria includes the content-based criterion and the computer system reduces a prominence of the first video without pausing the first video. In some embodiments, the respective type of content is a modal user interface element. In some embodiments, a modal user interface element is a user interface element that prevents and/or blocks interaction with other elements of the user interface while the modal user interface element is displayed. In some embodiments, the content-based criterion (that is optionally part of the third set of one or more criteria) is met when the computer system displays a modal user interface element, enabling the third set of one or more criteria to be met and for the computer system to reduce the prominence of the first video. In some embodiments, displaying the modal user interface element causes playback of video to stop and/or be paused. In some embodiments, the content-based criterion is not met when the computer system is not displaying a modal user interface element. Pausing the first video when a respective type of user interface object is displayed provides visual feedback that the respective type of user interface object is available and can be interacted with, thereby providing improved visual feedback.

In some embodiments, the third set of one or more criteria includes a first display criterion that is met when more than a first display threshold amount (e.g., 5%, 10%, 30%, 50%, 80%, or 90%) of the first user interface object (e.g., 722 at FIGS. 7I-7K) (e.g., and/or of the first video) moves out of (e.g., ceases to be displayed) a display area (e.g., a display area designated for displaying objects of the set of scrollable objects, of which the first user interface object is a part of). In some embodiments, different amounts of the first user interface object moving out of the display area causes different amounts, different reductions, and/or different types of reductions in the prominence of the first video, such as fading the video, blurring the video, and/or pausing the video. In some embodiments, the first display criterion (that is optionally part of the third set of one or more criteria) is met when different amounts of the first user interface object move out of the display area, enabling the third set of one or more criteria to be met and for the computer system to reduce the prominence of the first video. In some embodiments, reducing a prominence of the first video (e.g., 722A at FIGS. 7I-7K) includes reducing a visual prominence of (e.g., blurring and/or fading) the first video. In some embodiments, the computer system begins to reduce the prominence of the first video when an initial threshold amount of the first video moves out of the display area and continues to gradually further reduce the prominence of the first video as more of the first video moves out of the display area. In some embodiments, the computer system begins to blur and/or fade the first video when 50% of the first video has moved out of the display area and increases the amount of blur and/or fade as more of the first video moves out of the display area. In some embodiments, the computer system applies an amount of blurring and/or fading to the first video when more than 80% of the first video has moved out of the display area (and optionally does not increase the blurring and/or fading as more of the first video moves out of the display area). In some embodiments, the first display criterion is met when the first user interface object is part of the set of scrollable objects and as objects of the set of scrollable objects are scrolled, the first user interface object reaches an end and/or exceeds an end (e.g., by 5%, 10% or 30% of a size of the first user interface object) of a display area designated for displaying objects of the set of scrollable objects. In some embodiments, the first display criterion is met when more than a threshold amount of the first user interface object moves out of a central area (e.g., a center display area and/or a central area of a display region designated for displaying the set of scrollable objects). Blurring and/or fading the first video when the first video is more than a threshold amount out of the display area provides the user with visual feedback that the first video has partially moved out of the display area, thereby providing improved visual feedback.

In some embodiments, reducing the prominence of the first video includes pausing the first video (e.g., 722A at FIG. 7J) when more than a third display threshold amount (e.g., 35%, 55%, 80%, 90%) of the first user interface object (e.g., 722) (e.g., and/or of the first video) moves out of (e.g., ceases to be displayed) the display area; reducing the prominence of the first audio (e.g., 710B at FIG. 7I) includes pausing the first audio (e.g., 710B) when more than a fourth display threshold amount (e.g., 30%, 40%, 50%, 60%, or 70%) of the first user interface object (e.g., and/or of the first video) moves out of (e.g., ceases to be displayed) the display area; and the third display threshold amount is different from (e.g., less than or more than) the fourth display threshold amount. In some embodiments, the first audio stops and/or pauses when 40%, 50%, or 60% of the first video moves out of the display area and the first video stops and/or pauses when 50%, 80%, or 95% of the first video moves out of the display area. In some embodiments, the display area is a center display area and/or a central area of a display region designated for displaying the set of scrollable objects. Reducing the prominence of the audio and the video when different amounts of the first user interface object move out of the display area provides the user with feedback about how much of the first user interface has moved out of the display area, thereby providing improved visual feedback.

In some embodiments, reducing the prominence of the first video (e.g., 722) includes slowing down a rate of playback of the first video (e.g., 722). In some embodiments, to reduce the prominence of the first video, the computer system slows down the playback of the first video instead of or in addition to blurring and/or fading the first video. In some embodiments, reducing the prominence of the first audio includes slowing down a rate of playback of the first audio. Reducing the speed of the first audio and/or the first video provides the user with feedback that the first user interface has moved out of the display area, thereby providing improved feedback.

In some embodiments, aspects/operations of methods 800, 900, and/or 1100 may be interchanged, substituted, and/or added between these methods. For brevity, these details are not repeated here.

FIGS. 10A-10V illustrate example techniques for automatically switching between display of representations of different content items, in accordance with some embodiments. FIGS. 11A-11B are a flow diagram of methods of automatically switching between display of representations of different content items, in accordance with some embodiments. The user interfaces in FIGS. 10A-10V are used to illustrate the processes in FIGS. 11A-11B. Throughout the description of FIGS. 10A-10V, some elements of the illustrated example techniques are referred to using descriptors (e.g., “wildlife” descriptor used as part of “wildlife media object 732”, “zebra” descriptor used as part of “zebra media content 732A1”, and “lion” descriptor used as part of “lion thumbnail 732B3”). These descriptors are merely for illustration and for the reader to more easily differentiate between the elements. Other terms can be used in place of the descriptors. For example, “first,” “second,” “third”, or other terms can optionally be used in place of the descriptors to differentiate between the different elements. More generally, it should be understood that in any situation where a specific descriptor is used before a user interface element (and in particular a user interface element that is followed by a reference number), that specific descriptor is merely one example of a general class of user interface elements with similar properties.

At FIG. 10A, computer system 700 displays an extended reality environment that includes representations 706A-706D of physical objects of the physical environment and virtual objects, such as selectable user interface objects 704A-704D. Display 702 of computer system 700 optionally has a transparent or translucent display through which a person may directly view the physical environment. Computer system 700 optionally presents virtual objects on the transparent or translucent display, so that a person, using the system, perceives the virtual objects superimposed over the physical environment. Alternatively, computer system 700 has an opaque display 702 and one or more imaging sensors capture images or video of the physical environment, which are representations of the physical environment, for display. As described above, computer system 700 optionally includes at least two displays, one display for each eye of the user to provide the user with a stereoscopic view of the extended reality environment.

At FIG. 10A, selectable user interface object 704A corresponds to a TV application, selectable user interface object 704B corresponds to a music application, selectable user interface object 704C corresponds to a system settings application, and selectable user interface object 704D corresponds to a media application. In response to detecting activation of a respective selectable user interface object 704A-704D, computer system 700 displays a user interface of the application corresponding to the activated respective selectable user interface object 704A-704D. At FIG. 10A, computer system 700 detects a selection input directed toward selectable user interface object 704D (e.g., detects gaze 1050A of a user of computer system 700 directed at selectable user interface object 704D and pinch air gesture 1050B) and, in response, computer system 700 displays user interface 708, as shown in FIG. 10B.

At FIG. 10B, user interface 708 includes a plurality of media objects (e.g., 720-724) that are part of a set of scrollable objects (e.g., 720-732, as shown in FIG. 7U). In some embodiments, the set of scrollable objects is an ordered set and the objects of the set of scrollable objects maintain their order while being scrolled. At FIG. 10B, computer system 700 is displaying sports media object 720 at a center position of user interface 708 and/or within a central area of user interface 708. Concert media object 722 is positioned to the left of sports media object 720 and television media object 724 is positioned to the right of sports media object 720. In some embodiments, computer system 700 displays objects of the set of scrollable objects with varying levels of visual prominence based on a location and/or size of the respective object, as described in greater detail with respect to FIGS. 7A-7U and FIG. 9. Thus, at FIG. 10B, concert media object 722 and television media object 724 are visually less prominent than sports media object 720.

At FIG. 10B, sports media object 720 is at a central area of user interface 708 and gaze 1050A of the user is directed to sports media object 720 and, as a result, computer system 700 displays visual content 720A and outputs audio 710A of a media of sports media object 720. The media of sports media object 720 includes audio and video of a baseball game. Audio 710A and visual content 720A correspond to each other and to sports media object 720. In some embodiments, visual content 720A includes stereoscopic content (e.g., content with a three-dimensional effect that is generated using different images for different eyes that produces a stereoscopic depth effect). In some embodiments, audio 710A is spatial audio that the user perceives as coming from a location of sports media object 720. Throughout FIGS. 10A-10V, audio (e.g., 710A-710H) is visually illustrated for ease of understanding, but the audio is optionally not visually included in the user interfaces of computer system 700.

Sports media object 720 also includes text. Text 720B is overlaid on visual content 720A and is displayed with a blur effect applied to visual content 720A to make text 720B more legible, as described in greater detail with respect to FIGS. 7A-7U and 8. In some embodiments, the blur effect is a feathered blur effect that reduces in intensity as a distance from text 720B increases. In some embodiments, a shape and/or size of the blur effect of text 720B is based on a shape and/or size of text 720B.

At FIG. 10B, sports media object 720 corresponds to a single media content (e.g., 720A) and, as a result, playback of the media content of sports media object 720 is looped, restarting when an end of the playback of the media content is reached. At FIG. 10B, computer system 700 detects a navigation gesture directed towards user interface 708 (e.g., detects gaze 1050A of the user directed to user interface 708 (e.g., directed at sports media object 720) and detects air pinch and left drag gesture 1050C). In response to detecting the navigation gesture directed towards user interface 708 (e.g., detecting gaze 1050A and/or air pinch and left drag gesture 1050C), computer system 700 navigates by scrolling the set of scrollable objects within user interface 708 to the left, as shown in FIG. 10C. As the objects of the set of scrollable objects scroll, computer system 700 resizes the objects. As described in greater detail with respective to FIGS. 7A-7U, as objects get closer to the central area of user interface 708, the objects get bigger and as objects get further from the central area of user interface 708, the objects get smaller.

At FIG. 10C, computer system 700 increases a visual prominence of television media object 724 based on the location of television media object 724 and/or a size of television media object 724 and outputs audio 710D of television media object 724. At FIG. 10C, television media object 724 corresponds to a single media content (e.g., 724A) and, as a result, playback of the media content of television media object 724 is looped, restarting when an end of the playback of the media content is reached (e.g., as shown in FIGS. 10C-10D), rather than switching between display and/or playback of different media contents.

At FIG. 10D, computer system 700 detects a navigation gesture directed to user interface 708 (e.g., detects gaze 1050A of the user directed to user interface 708 (e.g., directed at television media object 724) and detects air pinch and left drag gesture 1050D). In response to detecting the navigation gesture directed to user interface 708 (e.g., in response to detecting gaze 1050A and/or air pinch and left drag gesture 1050D), computer system 700 navigates by scrolling the set of scrollable objects within user interface 708 to the left, as shown in FIG. 10E, resizing and/or otherwise changing the prominence of the objects.

At FIG. 10E, computer system 700 increases a visual prominence of wildlife media object 732 based on the location of wildlife media object 732 and/or a size of wildlife media object 732. Wildlife media object 732 corresponds to multiple different media contents (e.g., 732A1-732A4, corresponding to thumbnails 732B1-732B4) and, as a result, computer system 700 automatically switches between display of the multiple different media contents of television media object 724. In some embodiments, computer system 700 determines and/or specifies the aspect ratio of wildlife media object 732 by using the aspect ratio of the initial media content of the multiple different media contents of wildlife media object 732. As shown in FIG. 10E, zebra media content 732A1 is a still image (e.g., a panoramic image and/or a stereoscopic image) and the aspect ratio of wildlife media object 732 is based on (e.g., matches and/or is derived from) the aspect ratio of zebra media content 732A1. In some embodiments, computer system 700 maintains the aspect ratio of wildlife media object 732 throughout FIGS. 10E-10N (e.g., even when the aspect ratio of media contents 732A2-732A4 are different from the aspect ratio of zebra media content 732A1).

At FIG. 10E, wildlife media object 732 includes text 732D with corresponding feathered blur for legibility, share user interface object 732E, zebra media content 732A1, thumbnails 732B1-732B4, and progress bars 732C1-732C4. The thumbnails include zebra thumbnail 732B1 corresponding to zebra media content 732A1, elephant thumbnail 732B2 corresponding to elephant media content 732A2, lion thumbnail 732B3 corresponding to lion media content 732A3, and monkey thumbnail 732B4 corresponding to monkey media content 732A4. The progress bars include zebra progress bar 732C1 corresponding to zebra media content 732A1, elephant progress bar 732C2 corresponding to elephant media content 732A2, lion progress bar 732C3 corresponding to lion media content 732A3, and monkey progress bar 732C4 corresponding to monkey media content 732A4.

Because zebra media content 732A1 is a still image, computer system 700 displays zebra media content 732A1 as part of wildlife media object 732 for a fixed amount of time (e.g., still images are displayed for the same fixed amount of time) before computer system 700 automatically switches to displaying the next media content item (e.g., elephant media content 732A2). As shown in FIGS. 10E-10G, zebra progress bar 732C1 visually updates as time progresses to indicate how long zebra media content 732A1 has been shown and for how much longer zebra media content 732A1 will be shown before automatically switching to the next media content. In some embodiments, computer system 700 detects an input (e.g., a selection input) directed toward elephant thumbnail 732B2 (e.g., detects gaze 1050A of the user directed to elephant thumbnail 732B2, as shown in FIG. 10F, and before the fixed amount of time has elapsed, detects air pinch gesture 1050E). In response to detecting the input (e.g., a selection input) directed toward elephant thumbnail 732B2 (e.g., in response to detecting gaze 1050A and/or air pinch gesture 1050E), computer system 700 switches to displaying elephant media content 732A2 (e.g., as shown in FIG. 10H) before the fixed amount of time for displaying the zebra media has elapsed. In some embodiments, the user does not provide the input (e.g., a selection input) directed toward elephant thumbnail 732B2 (e.g., does not provide air pinch gesture 1050E) and computer system 700 continues displaying zebra media content 732A1 for the fixed amount of time before automatically switching to displaying elephant media content 732A2, as shown in FIGS. 10E-10H.

At FIG. 10H, computer system 700 has switched to displaying elephant media content 732A2 (e.g., in the same location in wildlife media object 732 where zebra media content 732A1 was previously displayed) and outputting corresponding audio 710E. As shown in FIGS. 10H-10I, elephant progress bar 732C2 visually updates as time progresses to indicate how long elephant media content 732A2 has been shown and for how much longer elephant media content 732A2 will be shown before automatically switching to the next media content. In some embodiments, because elephant media content 732A2 is a video with a first length (e.g., time duration), computer system 700 displays the video of elephant media content 732A2 for the first length of time (e.g., different from the fixed amount of time) before automatically switching to the next media content (e.g., lion media content 732A3). At FIGS. 10H-10I, computer system plays back elephant media content 732A2.

At FIG. 10I, in some embodiments, before playback of elephant media content 732A2 is completed (e.g., before the first length of time has elapsed), computer system 700 detects an input (e.g., a selection input) directed toward lion thumbnail 732B3 (e.g., detects gaze 1050A1 of the user directed to lion thumbnail 732B3 and detects air pinch gesture 1050F). In response to detecting the input (e.g., a selection input) directed toward lion thumbnail 732B3 (e.g., in response to detecting gaze 1050A1 and/or air pinch gesture 1050F), computer system 700 switches to displaying lion media content 732A3 (as shown in FIGS. 10J-10N and before the first length of time has elapsed). At FIG. 10I, in some embodiments, during playback of elephant media content 732A2 (e.g., before the first length of time has elapsed), computer system 700 detects an input (e.g., a selection input) directed toward elephant media content 732A2 (e.g., detects gaze 1050A2 (e.g., alternative to gaze 1050A1) of the user directed to elephant media content 732A2 and detects air pinch gesture 1050F). In response to detecting the input (e.g., a selection input) directed toward elephant media content 732A2 (e.g., in response to detecting gaze 1050A2 and/or air pinch gesture 1050F), computer system 700 switches to displaying elephant media content 732A2 in a larger, more complete, and/or more immersive configuration (e.g., as shown in FIG. 10O, but for elephant media content 732A2, rather than for lion media content 732A3).

At FIG. 10J, in response to detecting the input (e.g., a selection input) directed toward lion thumbnail 732B3 (e.g., in response to detecting gaze 1050A1 and/or air pinch gesture 1050F), computer system 700 initiates playback of lion media content 732A3 and dims thumbnails 732B1, 732B2, and 732B4 and/or progress bars 732C1, 732C2, and 732C4, thereby indicating that the input has been received. Because computer system 700 detects selection of lion thumbnail 732B3 at FIG. 10I, the playback of lion media content 732A3 and audio 710F is looped (e.g., the video will repeatedly play without automatically switching to the next media content). For example, as shown in FIGS. 10J-10N, after playback of lion media content 732A3 is complete, computer system 700 automatically initiates playback of lion media content 732A3 again without receiving and/or requiring additional user input and without switching to monkey media content 732A4.

At FIG. 10N, computer system 700 detects an input (e.g., a selection input) directed toward lion media content 732A3 (e.g., detects gaze 1050A of the user directed to lion media content 732A3 and detects air pinch gesture 1050G). As shown in FIG. 10O, in response to detecting the input (e.g., a selection input) directed toward lion media content 732A3 (e.g., detecting gaze 1050A and/or air pinch gesture 1050G), computer system 700 switches to displaying lion media content 732A3 in a larger, more complete, and/or more immersive configuration and outputting audio 710F, while displaying thumbnails 732B1-732B4 (e.g., with thumbnails 732B1, 732B2, and 732B4 dimmed). In some embodiments, computer system 700 also displays additional text 732F with the feathered blur effect, which is described in more detail above. In some embodiments, the playback of lion media content 732A3 in the more immersive configuration shown in FIG. 10O is looped (e.g., the video repeatedly plays without automatically switching to the next media content), as shown in FIGS. 10O-10Q. At FIG. 10Q, computer system 700 detects a navigation gesture directed towards lion media content 732A3 (e.g., detects gaze 1050A of the user directed to lion media content 732A3 and detects air pinch and left drag gesture 1050H). In response to detecting the navigation gesture directed towards lion media content 732A3 (e.g., detecting gaze 1050A and/or air pinch and left drag gesture 1050H), computer system 700 navigates to the next media content of wildlife media object 732 (e.g., monkey media content 732A4), such as by performing a cross fade of the videos (e.g., 732A3 and 732A4) and/or audios (e.g., 710F and 710G) (e.g., with no or a little translation of the videos), as shown in FIG. 10R.

At FIGS. 10S-10T, computer system 700 displays monkey media content 732A4 in the larger, more complete, and/or more immersive configuration, while continuing to show thumbnails 732B1-732B4 (e.g., with thumbnails 732B1-732B3 dimmed). In some embodiments, activation of a thumbnail (e.g., 732B1-732B3) causes display of the corresponding media content (e.g., 732A1-732A3) in the larger, more complete, and/or more immersive configuration. In some embodiments, the playback of monkey media content 732A4 in the more immersive configuration shown in FIGS. 10S-10T is looped (e.g., the video repeatedly plays without automatically switching to the next media content). At FIG. 10T, computer system 700 detects a navigation gesture directed to monkey media content 732A (e.g., detects gaze 1050A of the user directed to monkey media content 732A4 and detects air pinch and left drag gesture 1050I). In response to detecting the navigation gesture directed to monkey media content 732A (e.g., detecting gaze 1050A and/or air pinch and left drag gesture 1050I), computer system 700 navigates to the next media content (e.g., a media content of interview media object 738). Because the next media content is a media content of a different media object (e.g., of interview media object 738 and not of wildlife media object 732), computer system 700 performs a translation of the videos (e.g., 732A4 and 738A) (e.g., with no or a little cross fade) and/or audios (e.g., 710G and 710H moving in space and/or cross fading), as shown in FIGS. 10U-10V, thereby indicating to the user that content of a different media object is now being displayed. At FIG. 10V, because interview media object 738 corresponds to a single media content (e.g., media content 738A and audio 710H), playback of the media content of interview media object 738 is looped and thumbnails are not displayed for other media content of interview media object 738. At FIG. 10V, computer system 700 concurrently displays text 738B and 738C with the feathered blur effect and text 738D without the feathered blur effect, using the techniques (e.g., for the reasons) described above.

In some embodiments, at FIG. 10V, computer system 700 detects a navigation gesture (e.g., detects a gaze and/or air pinch and right drag gesture), and in response, computer system 700 navigates to the previous media content, such as by translating media content 738A and 732A4 (e.g., as shown in FIG. 10U) to display monkey media content 732A4, as shown in FIG. 10T.

FIGS. 11A-11B are a flow diagram of an exemplary method 1100 for automatically switching between display of representations of different content items, in accordance with some embodiments. In some embodiments, method 1100 is performed at a computer system (e.g., 700 and/or computer system 101 in FIG. 1A) (e.g., a smartphone, a smartwatch, a tablet computer, a desktop computer, a laptop computer, and/or a head-mounted device (e.g., a head-mounted augmented reality and/or extended reality device)) that is in communication with (e.g., includes and/or is connected to) one or more display generation components (e.g., 702) (e.g., a visual output device, a 3D display, a display having at least a portion that is transparent or translucent on which images can be projected (e.g., a see-through display), a display, a display controller, a monitor, a touch-sensitive display system, a display screen, a projector, a holographic display, and/or a head-mounted display system), one or more input devices (e.g., a touch-sensitive surface, a keyboard, mouse, trackpad, one or more optical sensors for detecting gestures, and/or one or more capacitive sensors for detecting hover inputs), and, optionally, one or more audio output devices (e.g., one or more speakers, one or more hardware audio drivers, one or more earphones, and/or one or more headsets). In some embodiments, method 1100 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1100 are, optionally, combined and/or the order of some operations is, optionally, changed.

The computer system (e.g., 700) displays (1102) (e.g., in a user interface (e.g., 708)), via the one or more display generation components (e.g., 702), one or more user interface objects (e.g., 724 and/or 732) of a plurality of user interface objects (e.g., 720-732, as shown in FIG. 7U).

While displaying the one or more user interface objects (e.g., 724 and/or 732), the computer system (e.g., 700) detects (1104), via the one or more input devices, a request (e.g., 1050C and/or 1050D) to navigate the plurality of user interface objects (e.g., a touch gesture corresponding to one or more of the plurality of user interface objects, a swipe touch gesture directed to one or more of the plurality of user interface objects, an air gesture while an input and/or attention is directed to one or more of the plurality of user interface objects, a mouse and/or trackpad input while a cursor is directed to one or more of the plurality of user interface objects, and/or a next object input directed to a region that contains one or more of the plurality of user interface objects).

In response to detecting the request (e.g., 1050C and/or 1050D) to navigate the plurality of user interface objects, the computer system (e.g., 700) navigates (1106) (e.g., scrolling through, paging through, and/or rotating through one or more user interface objects) the plurality of user interface objects to display (e.g., in a central area of the user interface), via the one or more display generation components (e.g., 702), a respective user interface object (e.g., 732 at FIG. 10E), wherein displaying the respective user interface object includes: in accordance with a determination (1108) that the respective user interface object (e.g., 732 at FIG. 10E) corresponds to a plurality of different content items (e.g., 732A1-732A4) (e.g., multiple videos, multiple images, and/or one or more videos and one or more images) (e.g., content items are optionally also referred to as content, such as in the descriptions corresponding to FIGS. 7-9): automatically switching (1110) (e.g., transitioning, cross fading between, and/or replacing) between display of content items (e.g., as shown in the transition between 732A1 to 732A2 in FIGS. 10E-10I) in the plurality of different content items as part of the respective user interface object; and concurrently displaying (1112), via the one or more display generation components (e.g., 702) (e.g., as part of the respective user interface object): a representation (e.g., 732A1 at FIG. 10E and/or 732A2 at FIG. 10I) of a respective content item of the plurality of different content items, and one or more options (e.g., 732B2-732B4 at FIG. 10E) to select a different content item of the plurality of different content items (e.g., one option per content item of the plurality of different content items) to display. In some embodiments, the computer system continues to display the one or more options to select a particular content item while the computer system automatically switches between display of content items of the plurality of different content items.

The computer system (e.g., 700) detects (1116) (e.g., while the respective user interface object includes display of the content item), via the one or more input devices, selection of (e.g., a touch gesture corresponding to an option of the one or more options of the respective user interface object, tap input on an option of the one or more options of the respective user interface object, an air gesture directed to an option of the one or more options of the respective user interface object, a pinch air gesture while an input, attention, and/or gaze is directed to an option of the one or more options of the respective user interface object, a mouse and/or trackpad input while a cursor is directed to an option of the one or more options of the respective user interface object, and/or activation of a region that corresponds to an option of the one or more options of the respective user interface object) a respective option (e.g., 732B2 via 1050A and/or 1050E at FIG. 10F; and/or 732B3 via 1050A1 and/or 1050F at FIG. 10I) of the one or more options of the respective user interface object that corresponds to the plurality of different content items (e.g., wherein the respective option corresponds to a different content item of the plurality of different content items that is different from the respective content item).

In response to detecting selection of the respective option (e.g., 732B2 and/or 732B3) of the one or more options, the computer system (e.g., 700) switches (1118) (e.g., from another content item and/or by replacing another content item) from displaying the representation of the respective content item of the plurality of different content items to displaying a representation of a different content item (e.g., different from the respective content item) of the plurality of different content items (e.g., 732A2 in FIG. 10H and/or 732A3 in FIG. 10J) (e.g., a next content item in the plurality of different content items, and/or a particular content item that corresponds to the respective option). In some embodiments, in response to detecting selection of the respective option: in accordance with a determination that the respective option is a first respective option of the one or more options, the computer system switches from displaying the respective content item to displaying a first different content item (e.g., that corresponds to the first respective option and/or is a next content item) and in accordance with a determination that the respective option is a second respective option, different from the first respective option, of the one or more options, the computer system switches from displaying the respective content item to displaying a second different content item, different from the first different content item (e.g., that corresponds to the second respective option and/or is a previous content item). Automatically switching between display of content items in the plurality of different content items as part of the respective user interface object enables the computer system to output the different content items without requiring user input, thereby reducing the number of user inputs required to perform the operation. Switching from displaying the representation of the respective content item of the plurality of different content items to displaying a representation of a different content item in response to a user input enables the computer system to navigate among the different content items in response to user inputs, thereby allowing the user to select and view specific content items, which improves the man-machine interface.

In some embodiments, displaying the respective user interface object includes: in accordance with a determination that the respective user interface object corresponds to a single content item (e.g., a single video or a single image), displaying (1114), via the one or more display generation components (e.g., 702) (e.g., as part of the respective user interface object), a representation (e.g., 724 at FIG. 10C) of the single content item without automatically switching (e.g., transitioning, cross fading between, and/or replacing) between display of content items as part of the respective user interface object. In some embodiments, in accordance with the determination that the respective user interface object corresponds to a single content item (e.g., a single video or a single image), the computer system does not display one or more options to select a different content item to display as part of the respective user interface object. In some embodiments, displaying the representation of the single content item without automatically switching between display content items includes, in accordance with a determination that the single content item is a video, playing through different frames of the video (e.g., playing through the entire video and then stopping playback and/or repeatedly playing through the entire video or a portion of the video) without switching to a next content item and/or in accordance with a determination that the single content item is a still image, displaying the still image without switching to a next content item. Displaying a representation of the single content item without automatically switching between display of content items as part of the respective user interface object when the respective user interface corresponds to a single content item enables the computer system to display the selected content item to the user without switching away to other content items, thereby enabling the user to view the content item for a longer duration of time and improving the man-machine interface.

In some embodiments, the plurality of different content items includes a video content item (e.g., 732A2-732A4) (e.g., a 10 second video, a 30 second video, and/or a 60 second video). In some embodiments, automatically switching (e.g., transitioning, cross fading between, and/or replacing) between display of content items in the plurality of different content items as part of the respective user interface object includes displaying playback of at least a portion of (e.g., playing through less than the full duration of or through the full duration of) the video content item (e.g., as shown in FIGS. 10H-10N). In some embodiments, displaying playback of at least a portion of the video content item includes displaying a video representation (e.g., playing and/or progressing through different visual frames of the video) of the video content item. Playing through at least a portion of the video content item before switching to another content item provides the user with visual feedback about the contents of the video content item (e.g., that it is a video item and what imagery the video item includes), thereby providing improved visual feedback.

In some embodiments, displaying the respective user interface object includes: in accordance with the determination (1108) that the respective user interface object corresponds to a plurality of different content items: the computer system (e.g., 700) displays, via the one or more display generation components (e.g., concurrently with the representation of a respective content item and the one or more options to select a different content item), an indication of display progress (e.g., 732C1-732C4) (e.g., a progress bar and/or a timer) that indicates a duration (e.g., for how long) for which the representation of the respective content item of the plurality of different content items will be displayed (e.g., before switching to a subsequent content item of the plurality of different content items). In some embodiments, the indication of display progress indicates progress towards completion of displaying the respective content item. In some embodiments, the indication of display progress also indicates for how long the representation of the respective content item has been displayed. In some embodiments, the indication of display progress visually updates over time to reflect the updated remaining duration for which the representation of the respective content item will be and/or has been displayed. In some embodiments, the indication of display progress is part of the respective user interface object and/or is displayed as part of the respective user interface object. In some embodiments, the indication of display progress is not part of the respective user interface object and/or is displayed separate from and/or outside of the respective user interface object. Displaying an indication of display progress provides the user with visual feedback about for how much longer the current content item will be displayed before switching to another content item, thereby providing improved visual feedback.

In some embodiments, displaying the indication of display progress (e.g., 732C1-732C4) that indicates a duration for which the representation of the respective content item of the plurality of different content items will be displayed includes: in accordance with a determination that the respective content item of the plurality of different content items is a still content item (e.g., a static image and/or a non-video item), the indication of display progress (e.g., 732C1) takes a fixed (e.g., non-variable, the same for all still content, and/or independent of the visuals of the still content item) amount of time to elapse (e.g., 0.5 seconds, 1 second, 3 seconds, 5 seconds, and/or 10 seconds); and in accordance with a determination that the respective content item of the plurality of different content items is a video content item (e.g., not a static image, and/or a video with a non-zero playback duration), the indication of display progress (e.g., 732C2-732C4) takes a variable amount of time (e.g., an amount of time that is based on a duration of the video content item) to elapse. The indications of display progress taking a fixed amount of time to elapse based on being a still content item or a variable amount of time to elapse based on being a video content item enables the computer system to accommodate different types of media that take different amounts of time to be viewed, thereby providing the used with improved visual feedback about the contents of the different types of media items.

In some embodiments, the computer system (e.g., 700) displays, via the one or more display generation components (e.g., 702) and concurrently with the indication of display progress (e.g., 732C1-732C4) that indicates the duration for which the representation of the respective content item of the plurality of different content items will be displayed, a second indication of display progress (e.g., 732C1-732C4) corresponding to the different content item (e.g., different from the respective content item) of the plurality of different content items. In some embodiments, the various indications of display progress for the different content items are lined up adjacent to one another so that display progress of the different content items visually progresses through (e.g., transitions through) the various indications of display progress, and optionally giving the appearance that the various indications of display progress are aggregated into a single indication of display progress (e.g., a single linear progress bar). Lining up the various indications of display progress for different content items provides the user with visual feedback about the progress made toward the computer system outputting the different media items of the respective user interface object, thereby providing improved visual feedback. The various indications of display progress also provide the user with feedback about the total number and/or the remaining number of content items in the plurality of different content items.

In some embodiments, the respective option of the one or more options (e.g., 732B1-732B4) includes a thumbnail (e.g., thumbnail image, thumbnail video, and/or reduced resolution and/or size image) of the different content item (e.g., different from the respective content item) of the plurality of different content items. In some embodiments, a first option of the one or more options includes a first thumbnail of a first different content item and activation of the first option causes display of the representation of the first different content item and a second option of the one or more options includes a second thumbnail of a second different content item and activation of the second option causes display of the representation of the second different content item. Including a thumbnail of the different content items provides the user with visual feedback about the contents of the different content items, thereby enabling the user to more quickly and accurately select a desired content item for display, thereby providing improved visual feedback and improving the man-machine interface.

In some embodiments, in response to detecting selection of the respective option of the one or more options (e.g., selection of 732B3 at FIG. 10I), the computer system (e.g., 700) ceases automatically switching (e.g., transitioning, cross fading between, and/or replacing) between display of content items in the plurality of different content items as part of the respective user interface object (e.g., as in FIGS. 10J-10N). Ceasing to automatically switch between the plurality of different content items when the computer system detects selection of a particular option enables the computer system to display the representation corresponding to the selected respective option for longer, thereby providing the user an extended opportunity to view the content and improving the man-machine interface.

In some embodiments, switching (e.g., from another content item and/or by replacing another content item) from displaying the representation of the respective content item of the plurality of different content items to displaying the representation of the different content item (e.g., different from the respective content item) of the plurality of different content items includes looping (e.g., repeatedly, such as twice or thrice) through the different content item (e.g., when the different content item is a video content item) (e.g., as shown in FIGS. 10E-10I). Automatically looping through playback of the representation of the different content item (without automatically switching to another content item) enables the computer system to display the representation corresponding to the selected respective option for longer, thereby providing the user an extended opportunity to view the content and improving the man-machine interface.

In some embodiments, in response to detecting selection of the respective option of the one or more options (e.g., selection of 732B3 at FIG. 10I), the computer system (e.g., 700) reduces a visual prominence (e.g., dimming and/or reducing a size) of one or more other options (e.g., a plurality of options) (e.g., 732B1, 732B2, and/or 732B4) that are different from the respective option (e.g., 732B3) of the one or more options. In some embodiments, in response to detecting selection of the respective option, the computer system dims the other options of the one or more options. Reducing a visual prominence, such as dimming, of other options provides the user with visual feedback about which option has been selected and which option the currently displayed representation corresponds to, thereby providing improved visual feedback.

In some embodiments, while displaying the representation (e.g., 732A3 at FIG. 10N) of the different content item (e.g., at a first level of displayed immersion) of the plurality of different content items, the computer system (e.g., 700) detects, via the one or more input devices, an input (e.g., 1050A and/or 1050G) directed to the representation (e.g., 732A3 at FIG. 10N) of the different content item (e.g., a touch gesture corresponding to the representation of the different content item, a tap touch gesture directed to the representation of the different content item, an air gesture while an input and/or attention is directed to the representation of the different content item, a mouse and/or trackpad input while a cursor is directed to the representation of the different content item, and/or an expand object input directed to a region that contains the representation of the different content item). In response to detecting the input (e.g., 1050A and/or 1050G) directed to the representation of the different content item, the computer system (e.g., 700) updates display of the representation (e.g., 732A3) of the different content item (e.g., to a second level of displayed immersion that is more than the first level of displayed immersion) to a more immersive view of the representation of the different content item (e.g., as in FIGS. 10O-10P) (e.g., with additional depth effect and/or by extending the representation of the different content item (e.g., via a warp effect and/or a pixel stretch effect) to occupy additional portions of a field of view of a user of the computer system). Displaying the content item in a more immersive view based on user input enables the computer system to provide the user with visual feedback about the content item and the more immersive view, allowing the user to experience the content item with a higher level of immersion, thereby providing improved visual feedback and improving the man-machine interface.

In some embodiments, while displaying the more immersive view of the representation (e.g., 732A3) of the different content item (e.g., as in FIGS. 10O-10P), the computer system (e.g., 700) forgoes automatically switching (e.g., transitioning, cross fading between, and/or replacing) between display of content items in the plurality of different content items. In some embodiments, in response to detecting the input directed to the representation of the different content item, the computer system ceases automatically switching (e.g., transitioning, cross fading between, and/or replacing) between display of content items in the plurality of different content items as part of the respective user interface object. In some embodiments, forgoing automatically switching (e.g., transitioning, cross fading between, and/or replacing) between display of content items in the plurality of different content items includes forgoing automatically switching to a different content item for at least a duration of time (e.g., the variable amount of time and/or the duration of the video when the different content item is a video and/or the fixed amount of time when the different content item is a still image) that would otherwise be sufficient (e.g., when not in the more immersive view) to automatically switch to a next content item. Forgoing automatically switching between content items enables the computer system to display the selected content item to the user without switching away to other content items, thereby enabling the user to view the content item for a longer duration of time and improving the man-machine interface.

In some embodiments, while displaying the more immersive view of the representation (e.g., 732A3) of the different content item, the computer system (e.g., 700) displays, via the one or more display generation components, one or more second options (e.g., 732B1, 732B2, and/or 732B4 at FIGS. 10O-10P) to select another different content item (e.g., the same as or different from the one or more options to select a different content item) of the plurality of different content items (e.g., one option per content item of the plurality of different content items) to display. In some embodiments, in response to detecting the input directed to the representation of the different content item, the computer system displays, via the one or more display generation components, one or more second options to select another different content item (e.g., the same as or different from the one or more options to select a different content item) of the plurality of different content items (e.g., one option per content item of the plurality of different content items) to display. Including options to select another content item provides the user with visual feedback about the availability of the other content items and enables to user to quickly and directly select another content item, thereby providing improved visual feedback and improving the man-machine interface.

In some embodiments, displaying the one or more second options (e.g., 732B1, 732B2, and/or 732B4 at FIGS. 10O-10P) to select another different content item of the plurality of different content items to display includes displaying options of the one or more second options that are different from the respective option (e.g., 723B3 at FIGS. 10O-10P) with a reduced visual prominence (e.g., dimmed and/or reduced a size) as compared to the respective option (e.g., 723B3 at FIGS. 10O-10P), of the one or more second options, that corresponds to the different content item. In some embodiments, in response to detecting the input directed to the representation of the different content item, the computer system displays the options corresponding to other content items with a reduced visual prominence (e.g., dimmed and/or blurred) as compared to an option corresponding to the different content item currently being displayed in the more immersive view. Reducing a visual prominence, such as dimming, of other options provides the user with visual feedback about which option has been selected and which option the currently displayed representation corresponds to, thereby providing improved visual feedback.

In some embodiments, while displaying the more immersive view of the representation of the different content item, the computer system (e.g., 700) detects, via the one or more input devices, a request (e.g., 1050H at FIG. 10Q and/or 1050I at FIG. 10T) to display a next content item (e.g., a touch gesture corresponding to the representation of the different content item, a swipe touch gesture directed to the representation of the different content item, an air gesture while an input and/or attention is directed to the representation of the different content item, a mouse and/or trackpad input while a cursor is directed to the representation of the different content item, and/or a next object input directed to a region that contains the representation of the different content item). In response to detecting the request to display a next content item and while continuing to operation in the more immersive view, the computer system (e.g., 700) switches (e.g., transitioning, cross fading between, and/or replacing) from displaying the representation of the different content item to displaying a representation of a next content item (e.g., as in FIGS. 10S and/or 10V) that is different from the different content item. Switching to a next content item in response to a user request provides the user with feedback that the request has been received and enables the user to navigate through the various content items, thereby providing improved visual feedback and improving the man-machine interface.

In some embodiments, displaying the representation of the next content item includes: in accordance with a determination that request to display the next content item is a request to navigate beyond the end of the plurality of different content items (e.g., the different content item is the last, final, or end content item in the plurality of different content items), displaying, via the one or more display generation components, a representation (e.g., 738A at FIG. 10V) of a content item that corresponds to a second respective user interface object of the plurality of user interface objects (e.g., without displaying any content item of the respective user interface object). In some embodiments, the second respective user interface object is a next user interface object of the plurality of user interface objects after the respective user interface object. In some embodiments, displaying the representation of the next content item includes: in accordance with a determination that request to display the next content item is a request to navigate within the plurality of different content items (e.g., the different content item is not the last, final, or end content item in the plurality of different content items), displaying, via the one or more display generation components, a representation (e.g., 732A4 at FIG. 10S) of another content item (e.g., different from the different content item) that corresponds to the respective user interface object of the plurality of user interface objects (e.g., without displaying any content item of the second respective user interface object). Displaying a representation of a next content item that corresponds to the respective user interface object or a representation of a next content item that corresponds to a second respective user interface object based on whether additional content items are available in the respective user interface object enables the computer system to automatically progress the user through different content items, thereby reducing the need for the user to provide additional inputs to select the second respective user interface object.

In some embodiments, displaying the representation of the next content item includes: in accordance with a determination that request to display the next content item is a request to navigate beyond the end of the plurality of different content items (e.g., the different content item is the last, final, or end content item in the plurality of different content items), displaying, via the one or more display generation components (e.g., 702), a first animated transition (e.g., as in FIG. 10U) (e.g., a transition that includes a first amount of translation animation and/or a sliding animation) to display the representation of the next content item; and in accordance with a determination that request to display the next content item is a request to navigate within the plurality of different content items (e.g., the different content item is not the last, final, or end content item in the plurality of different content items), displaying, via the one or more display generation components, a second animated transition (e.g., as in FIG. 10R) (e.g., transition that includes a cross-fade animation and a second amount of translation animation and/or sliding animation that is less than the first amount) that is different from the first animated transition. In some embodiments, the first animated transition includes more translation (e.g., of the different content item and/or the next content item) than the second animated transition. In some embodiments, the first animated transition includes less cross-fade animation (e.g., for a shorter duration) than the second animated transition. Displaying different animations when transitioning to a content item of the respective user interface object and when transitioning to a content item of the second respective user interface object provides the user with visual feedback about whether the displayed representation corresponds to the respective user interface object or to a different user interface object, thereby providing improved visual feedback. Providing the different animation when the displayed representation corresponds to a different user interface object also provides the user with feedback that the user has navigated away from the respective user interface object, thereby also providing improved feedback.

In some embodiments, the plurality of different content items includes one or more spatial content items (e.g., 732A1-732A4 and/or 710E-710G) (e.g., one or more spatial stills (e.g., images) and/or one or more spatial videos). In some embodiments, the content item includes spatial visual media (e.g., a spatial image and/or a spatial video). In some embodiments, the respective content item includes spatial visual media (e.g., a spatial image and/or a spatial video). In some embodiments, the content item of the second respective user interface object includes spatial visual media. Including spatial content items, such as stills and/or videos, provides the user with a more realistic view of the content, thereby improving the man-machine interface.

In some embodiments, the plurality of different content items includes one or more panorama content items (e.g., 732A1). Including panorama content items provides the user with a wider view of the environment represented in the content, thereby improving the man-machine interface.

In some embodiments, the computer system (e.g., 700) applies a visual parallax effect that changes a display of one or more user interface objects (e.g., 732A1-732A4) based on (e.g., using and/or based on a change of) a viewing angle of a viewpoint of a user of the computer system (e.g., 700). In some embodiments, the computer system applies a visual parallax effect to change a display of one or more representations of content items based on (e.g., using and/or based on a change of) a viewing angle of a viewpoint of a user of the computer system. Applying a visual parallax effect that enables the computer system to provide the user with different views of the user interface objects and/or content items provides the user with visual feedback that the viewpoint of the user is changing, and that the user interface objects and/or content items have stereoscopic depth, thereby providing improved visual feedback.

In some embodiments (e.g., in response to detecting the request to navigate the plurality of user interface objects), the computer system (e.g., 700) displays, via the one or more display generation components, text (e.g., 732D and/or 732F) overlaid on a representation (e.g., 732A1-732A4) of a content item of the respective user interface object and displays, via the one or more display generation components, a portion of the representation of content near (e.g., next to, adjacent to, and/or at least partially surrounding the text, such as when viewed from a viewpoint of a user) the text with a blur effect (e.g., a feathered blur, a Gaussian blur, a radial blur, and/or a motion blur) that gradually reduces in intensity as distance from the text increases (e.g., the amount of blur of the blur effect is linearly or exponentially related to the distance from the text), wherein a shape of the blur effect is based on a shape of the text (e.g., as shown in FIG. 10O). In some embodiments, the blur effect is based on one or more characteristics (e.g., size, shape, color, and/or brightness) of the text, as described in further detail with respect to FIGS. 7A-7U and 8. In some embodiments, the blur effect ends a non-zero distance from the text and/or the blur effect based on the text is not displayed beyond the non-zero distance, as described in further detail with respect to FIGS. 7A-7U and 8. Displaying text with a blur effect that gradually reduces in intensity as it gets further from the text when a request is detected enables the computer system to display legible text and to indicate to the user that the request was received, thereby providing improved visual feedback. Automatically adding a blur effect to text when a request to display text is detected also reduces the number of inputs required to display the effect. Displaying text with the blur effect over content with varying degrees of depth improves the legibility of the text and reduces and/or avoids visual discomfort that might be caused by displaying text adjacent to the content with varying degrees of depth, thereby improving the computer system and the man-machine interface.

In some embodiments, an aspect ratio of the respective user interface object (e.g., 732) is determined based on (e.g., matches, is determining using, uses a height of, and/or uses a width of) an aspect ratio of a particular content item (e.g., 732A1) of the respective user interface object. In some embodiments, an aspect ratio of the respective user interface object that corresponds to the plurality of different content items is based on an aspect ratio of the respective content item (e.g., a primary content item or a content item that is first in an ordered set of the plurality of different content items). In some embodiments, in accordance with a determination that an aspect ratio of a particular content item of the respective user interface object is a first aspect ratio, the aspect ratio of the respective user interface object is based on the first aspect ratio (and, optionally, not based on the second aspect ratio) and in accordance with a determination that the aspect ratio of the particular content item of the respective user interface object is a second aspect ratio that is different from the first aspect ratio, the aspect ratio of the respective user interface object is based on the second aspect ratio (and, optionally, not based on the first aspect ratio). In some embodiments, the aspect ratio of the respective user interface object is maintained even when displaying other content items of the plurality of different content items corresponding to the respective user interface object that have different aspect ratios (e.g., a third aspect ratio and/or a fourth aspect ratio that are different from the first aspect ratio and the second aspect ratio). The aspect ratio of the respective user interface object being determined based on the aspect ratio of a particular content item of the respective user interface object enables the respective user interface object to take a shape that aligns with the content that will be displayed as part of the respective user interface object, thereby reducing wasted display space (e.g., reducing black top/bottom and/or left/right bars) and improving the man-machine interface.

In some embodiments, aspects/operations of methods 800, 900, and/or 1100 may be interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-85. (canceled)

86. A computer system configured to communicate with one or more display generation components, one or more input devices, and one or more audio output devices, the computer system comprising:
one or more processors; and
memory storing one or more programs configured to be executed by the one or more processors, the one or more programs including instructions for:
concurrently displaying, via the one or more display generation components, a first user interface object in a user interface and outputting, via the one or more audio output devices, first audio that corresponds to the first user interface object;
while concurrently displaying the first user interface object in the user interface and outputting the first audio, detecting, via the one or more input devices, a request to move the first user interface object; and
in response to detecting the request to move the first user interface object:
moving the first user interface object in accordance with the request; and
in accordance with a determination that a first set of one or more criteria is met, reducing a prominence of the first audio while continuing to display the first user interface object in the user interface.

87. The computer system of claim 86, wherein reducing the prominence of the first audio includes reducing a volume of the first audio.

88. The computer system of claim 86, wherein the first set of one or more criteria includes a position criterion that is based on a position of the first user interface object within a set of scrollable objects.

89. The computer system of claim 86, wherein the first set of one or more criteria includes a size criterion that is based on a size of the first user interface object and wherein the size of the first user interface object automatically changes as the first user interface object moves.

90. The computer system of claim 89, wherein a set of scrollable objects includes the first user interface object, the one or more programs further including instructions for:
in response to detecting the request to move the first user interface object, changing a size of the first user interface object relative to a size of one or more other objects of the set of scrollable objects.

91. The computer system of claim 86, wherein the first set of one or more criteria includes a speed criterion that is based on a speed of movement of the first user interface object.

92. The computer system of claim 86, wherein the first set of one or more criteria includes a set of one or more gaze criteria that is based on whether a gaze of a user is directed to the first user interface object.

93. The computer system of claim 86, wherein the first set of one or more criteria includes a duration criterion that is met when a gaze of a user of the computer system is directed away from the first user interface object for a threshold duration of time.

94. The computer system of claim 86, wherein the user interface is a user interface of an application, the one or more programs further including instructions for:
while outputting, via the one or more audio output devices, the first audio that corresponds to the first user interface object, detecting that a gaze of a user is not directed to interfaces of the application; and
while the gaze of the user is not directed to interfaces of the application, continuing to output, via the one or more audio output devices, the first audio that corresponds to the first user interface object.

95. The computer system of claim 86, the one or more programs further including instructions for:
while outputting, via the one or more audio output devices, the first audio that corresponds to the first user interface object, detecting that a gaze of a user is directed to a respective user interface object that is different from the first user interface object; and
in response to detecting that the gaze of the user is directed to the respective user interface object that is different from the first user interface object and in accordance with a determination that the respective user interface object does not correspond to respective audio, continuing to output, via the one or more audio output devices, the first audio.

96. The computer system of claim 86, the one or more programs further including instructions for:
detecting that a gaze of a user of the computer system is not directed to a set of one or more control objects that are associated with the first user interface object; and
in response to detecting that the gaze of the user of the computer system is not directed to the set of one or more control objects, reducing a prominence of the one or more control objects.

97. The computer system of claim 86, the one or more programs further including instructions for:
detecting that a gaze of a user of the computer system is directed to a set of one or more control objects that are associated with the first user interface object; and
in response to detecting that the gaze of the user of the computer system is directed to the set of one or more control objects, increasing a prominence of the one or more control objects.

98. The computer system of claim 86, the one or more programs further including instructions for:
while displaying the first user interface object in the user interface, detecting, via the one or more input devices, a second request to move the first user interface object; and
in response to detecting the second request to move the first user interface object:
moving the first user interface object in accordance with the second request; and
in accordance with a determination that a second set of one or more criteria is met, increasing a prominence of the first audio while continuing to display the first user interface object in the user interface.

99. The computer system of claim 98, wherein:
the first set of one or more criteria includes a first threshold of a first type;
the second set of one or more criteria includes a second threshold of the first type; and
the first threshold is different from the second threshold.

100. The computer system of claim 86, wherein reducing the prominence of the first audio includes gradually changing a prominence of the first audio over time.

101. The computer system of claim 86, wherein:
the user interface includes a plurality of user interface objects, including the first user interface object and a second user interface object that is different from the first user interface object;
the first user interface object corresponds to the first audio and the second user interface object corresponds to second audio that is different from the first audio; and
the computer system outputs, via the one or more audio output devices, one primary audio from among audio corresponding to the user interface objects of the plurality of user interface objects.

102. The computer system of claim 101, the one or more programs further including instructions for:
transitioning the primary audio from the first audio to the second audio by crossfading the first audio and the second audio, including concurrently:
reducing a volume of the first audio; and
increasing a volume of the second audio.

103. The computer system of claim 86, wherein the first user interface object includes a first video and the first video is playing when the computer system detects the request to move the first user interface object, the one or more programs further including instructions for:
in response to detecting the request to move the first user interface object:
in accordance with a determination that a third set of one or more criteria is met, reducing a prominence of the first video while continuing to display the first user interface object in the user interface.

104. The computer system of claim 103, wherein the first set of one or more criteria is different from the third set of one or more criteria.

105. The computer system of claim 103, wherein:
the third set of one or more criteria includes a content-based criterion that is met when the computer system displays a respective type of content that corresponds to the user interface; and
reducing a prominence of the first video includes pausing the first video.

106. The computer system of claim 103, wherein:
the third set of one or more criteria includes a first display criterion that is met when more than a first display threshold amount of the first user interface object moves out of a display area; and
reducing a prominence of the first video includes reducing a visual prominence of the first video.

107. The computer system of claim 106, wherein:
reducing the prominence of the first video includes pausing the first video when more than a third display threshold amount of the first user interface object moves out of the display area;
reducing the prominence of the first audio includes pausing the first audio when more than a fourth display threshold amount of the first user interface object moves out of the display area; and
the third display threshold amount is different from the fourth display threshold amount.

108. The computer system of claim 106, wherein reducing the prominence of the first video includes slowing down a rate of playback of the first video.

109. A non-transitory computer-readable storage medium storing one or more programs configured to be executed by one or more processors of a computer system that is in communication with one or more display generation components, one or more input devices, and one or more audio output devices, the one or more programs including instructions for:
concurrently displaying, via the one or more display generation components, a first user interface object in a user interface and outputting, via the one or more audio output devices, first audio that corresponds to the first user interface object;
while concurrently displaying the first user interface object in the user interface and outputting the first audio, detecting, via the one or more input devices, a request to move the first user interface object; and
in response to detecting the request to move the first user interface object:
moving the first user interface object in accordance with the request; and
in accordance with a determination that a first set of one or more criteria is met, reducing a prominence of the first audio while continuing to display the first user interface object in the user interface.

110. A method, comprising:
at a computer system that is in communication with one or more display generation components, one or more input devices, and one or more audio output devices:
concurrently displaying, via the one or more display generation components, a first user interface object in a user interface and outputting, via the one or more audio output devices, first audio that corresponds to the first user interface object;
while concurrently displaying the first user interface object in the user interface and outputting the first audio, detecting, via the one or more input devices, a request to move the first user interface object; and
in response to detecting the request to move the first user interface object:
moving the first user interface object in accordance with the request; and
in accordance with a determination that a first set of one or more criteria is met, reducing a prominence of the first audio while continuing to display the first user interface object in the user interface.
